(19) United States
(12) Patent Application Publication
(10) Pub. No.: US 2008/0109093 A1
(43) Pub. Date: May 8, 2008

(54) Control Device, Device Control System, Device Control Program, Computer-Readable Recording Medium Containing the Device Control Program, and Setting Check Data Creation Method

(76) Inventors: Yasutaka Maeda, Osaka (JP); Toshiaki Katano, Hyogo (JP); Akira Shoda, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/885,966

(22) PCT Filed: Feb. 27, 2006
(86) PCT No.: PCT/JP06/03630

§ 371 Date: Sep. 10, 2007

(51) Int. Cl. G06F 17/00

(52) U.S. Cl. 700/90

(57) ABSTRACT

An object of the invention is to automatically acquire function information of electric devices whose manufacturers, models, and model numbers are different one from another. A specifications information storage (21) stores specifications information, in which function information including at least setting items for controlling a home electric appliance (1) is predefined, in association with identification information. A setting check data creation processor (25) acquires the identification information of the home electric appliance (1), and creates setting check data for checking a setting concerning the home electric appliance (1) with respect to each of the setting items, based on the specifications information matching with model information and version information included in the identification information. A setting check processor (26) executes the setting concerning the home electric appliance (1) by using the setting check data, and updates the function information based on the setting result. A home electric appliance controller (29) controls the home electric appliance (1) based on the function information.

### TECHNICAL FIELD

The present invention relates to a method for creating setting check data to be sent to an electric device in collecting function information such as setting items or setting values used in controlling the electric device connected to a network, a control device for collecting the function information of the electric device, using the setting check data, a device control system, a device control program, and a computer-readable recording medium recorded with the device control program.

### BACKGROUND ART

In recent years, not only a network requiring high-speed, large-capacity data transfer such as video transfer, but also a relatively low-speed, low-capacity, and less costly facility-related network which is adaptable to so-called home electric appliances used in houses (e.g. air-conditioners, refrigerators, microwave ovens, and washing machines), or household equipment have been constructed as in-house communication infrastructure, and various services related to the infrastructure have been provided. With the provision of the networks and the services, central control of the home electric appliances or the like by a control device has been provided. In order to allow the control device to control the home electric appliances on the network, it is required to acquire and store function information such as setting items or setting values necessary for controlling the home electric appliances. Heretofore, there has been proposed a method for acquiring identification information for identifying home electric appliances from the home electric appliances and downloading function information matching with the acquired identification information from a server, as a method for acquiring the function information of the home electric appliances (e.g. see Japanese Patent No. 3402953).

Generally, a variety of kinds of home electric appliances are used in houses, and there may be no case that the home electric appliances are identical to each other in manufacturers or model numbers. In the conventional method recited in the publication, the function information relating to all the models and model numbers of the manufacturers is required to be administered by the server. However, it is not always the case that the function information relating to all the models and model numbers of the manufacturers is disclosed. Also, it is not always the case that the function information relating to the latest models is promptly registered in the server. In such a case, acquisition of the function information from the server is impossible, which makes it impossible to control the relevant home electric appliance(s). Also, administration of the function information is very cumbersome and costly regardless of a condition that the function information is centrally controlled by a single server or a condition that the function information is controlled by individual servers. There is proposed a control device in which function information is stored in advance.

However, it is necessary to load a large-capacity memory in the control device so that function information relating to all the possible manufacturers, models, and model numbers is stored. Further, if the user has purchased a home electric appliance of a latest model whose function information has not been loaded in the server, the control device is incapable of controlling the home electric appliance.

### DISCLOSURE OF THE INVENTION

In view of the above conventional disadvantages, it is an object of the present invention to provide a control device that enables to automatically acquire function information of electric devices whose manufacturers, models, and model numbers are different one from another, a device control system, a device control program, a computer-readable recording medium recorded with the device control program, and a setting check data creating method.

A control device according to an aspect of the invention is communicatively connected with at least one electric device for controlling the electric device. The control device comprises: a specifications information storing means for storing specifications information, in which function information including at least setting items for controlling the electric device is predefined, in association with model information representing a model of the electric device; an identification information acquiring means for acquiring, from the electric device, identification information including the model information of the electric device; a setting check data creating means for reading, from the specifications information storing means, the specifications information corresponding to the model information matching with the model information included in the identification information acquired by the identification information acquiring means, and for creating setting check data for checking a setting concerning the electric device with respect to each of the setting items, based on the readout specifications information; a setting executing means for executing the setting concerning the electric device, using the setting check data created by the setting check data creating means; a setting result checking means for acquiring, from the electric device, a result on the setting executed by the setting executing means, and for checking the setting result; a function information storing means for storing the function information of the electric device; a function information updating means for updating the function information stored in the function information storing means, based on the setting result checked by the setting result checking means; and an electric device controlling means for controlling the electric device, based on the function information updated by the function information updating means.

A device control program according to another aspect of the invention is adapted for use in a control device communicatively connected with at least one electric device for controlling the electric device. The device control program causes a computer to function as: a specifications information storing means for storing specifications information, in which function information including at least setting items for controlling the electric device is predefined, in association with model information representing a model of the electric device; an identification information acquiring means for acquiring, from the electric device, identification information including the model information of the electric device; a setting check data creating means for reading, from the specifications information storing means, the specifications information corresponding to the model information matching with the model information included in the identification information acquired by the identification information acquiring means, and for creating setting check data for checking a setting concerning the electric device with respect to each of the setting items, based on the readout specifications information; a setting executing means for executing the setting concerning the electric device, using the setting check data created by the setting check data creating means; a setting result checking means for acquiring, from the electric device, a result on the setting executed by the setting executing means, and for checking the setting result; a function information storing means for storing the function information of the electric device; a function information updating means for updating the function information stored in the function information storing means, based on the setting result checked by the setting result checking means; and an electric device controlling means for controlling the electric device, based on the function information updated by the function information updating means.

A computer-readable recording medium recorded with a device control program according to yet another aspect of the invention is adapted for use in a control device communicatively connected with at least one electric device for controlling the electric device. The device control program causes a computer to function as: a specifications information storing means for storing specifications information, in which function information including at least setting items for controlling the electric device is predefined, in association with model information representing a model of the electric device; an identification information acquiring means for acquiring, from the electric device, identification information including the model information of the electric device; a setting check data creating means for reading, from the specifications information storing means, the specifications information corresponding to the model information matching with the model information included in the identification information acquired by the identification information acquiring means, and for creating setting check data for checking a setting concerning the electric device with respect to each of the setting items, based on the readout specifications information; a setting executing means for executing the setting concerning the electric device, using the setting check data created by the setting check data creating means; a setting result checking means for acquiring, from the electric device, a result on the setting executed by the setting executing means, and for checking the setting result; a function information storing means for storing the function information of the electric device; a function information updating means for updating the function information stored in the function information storing means, based on the setting result checked by the setting result checking means; and an electric device controlling means for controlling the electric device, based on the function information updated by the function information updating means.

In the above arrangements, the specifications information storing means is operative to store the specifications information, in which the function information including at least setting items for controlling the electric device is predefined, in association with the model information representing the model of the electric device. The identification information acquiring means is operative to acquire, from the electric device, the identification information including the model information of the electric device. Then, the setting check data creating means is operative to read, from the specifications information storing means, the specifications information corresponding to the model information matching with the model information included in the identification information acquired by the identification information acquiring means, and create the setting check data for checking the setting concerning the electric device with respect to the each of the setting items, based on the readout specifications information. Then, the setting executing means is operative to execute the setting concerning the electric device, using the setting check data created by the setting check data creating means. The setting result checking means is operative to acquire, from the electric device, the result on the setting executed by the setting executing means, and check the setting result. The function information storing means is operative to store the function information of the electric device. The function information updating means is operative to update the function information stored in the function information storing means, based on the setting result checked by the setting result checking means. The electric device controlling means is operative to control the electric device, based on the function information updated by the function information updating means.

As mentioned above, the setting check data with respect to the each of the setting items is created based on the specifications information, in which the function information is predefined, the setting concerning the electric device is executed, using the created setting check data, and the function information is updated based on the setting result. This enables to automatically acquire the function information of the electric devices whose manufacturers, models, and model numbers are different one from another.

A device control system according to a further aspect of the invention is provided with at least one electric device, and a control device communicatively connected with the electric device for controlling the electric device. The electric device includes an identification information storing means for storing identification information for identifying the electric device. The control device includes: a specifications information storing means for storing specifications information, in which function information including at least setting items for controlling the electric device is predefined, in association with model information representing a model of the electric device; an identification information acquiring means for acquiring, from the electric device, the identification information including the model information of the electric device; a setting check data creating means for reading, from the specifications information storing means, the specifications information corresponding to the model information matching with the model information included in the identification information acquired by the identification information acquiring means, and for creating setting check data for checking a setting concerning the electric device with respect to each of the setting items, based on the readout specifications information; a setting executing means for executing the setting concerning the electric device, using the setting check data created by the setting check data creating means; a setting result checking means for acquiring, from the electric device, a result on the setting executed by the setting executing means, and for checking the setting result; a function information storing means for storing the function information of the electric device; a function information updating means for updating the function information stored in the function information storing means, based on the setting result checked by the setting result checking means; and an electric device controlling means for controlling the electric device, based on the function information updated by the function information updating means.

In the above arrangement, the identification information storing means of the electric device is operative to store the identification information for identifying the electric device. The specifications information storing means of the control device is operative to store the specifications information, in which the function information including at least setting items for controlling the electric device is predefined, in association with the model information representing the model of the electric device. The identification information acquiring means of the control device is operative to acquire, from the electric device, the identification information including the model information of the electric device. The setting check data creating means is operative to read, from the specifications information storing means, the specifications information corresponding to the model information matching with the model information included in the identification information acquired by the identification information acquiring means, and create the setting check data for checking the setting concerning the electric device with respect to the each of the setting items, based on the readout specifications information. The setting executing means is operative to execute the setting concerning the electric device, using the setting check data created by the setting check data creating means. The setting result checking means is operative to acquire, from the electric device, the result on the setting executed by the setting executing means, and check the setting result. The function information storing means is operative to store the function information of the electric device. The function information updating means is operative to update the function information stored in the function information storing means, based on the setting result checked by the setting result checking means. The electric device controlling means is operative to control the electric device, based on the function information updated by the function information updating means.

As mentioned above, the setting check data with respect to the each of the setting items is created based on the specifications information, in which the function information is predefined, the setting concerning the electric device is executed, using the created setting check data, and the function information is updated based on the setting result. This enables to automatically acquire the function information of the electric devices whose manufacturers, models, and model numbers are different one from another.

A setting check data creating method according to a yet further aspect of the invention is adapted for use in a control device communicatively connected with at least one electric device stored with identification information for identifying the electric device. The control device is provided with: a specifications information storing means for storing specifications information, in which function information including at least setting items for controlling the electric device is predefined, in association with model information representing a model of the electric device; and a combination information storing means for storing combination information describing a dependency between the setting items included in the specifications information in association with the model information for controlling the electric device. The method comprises: an identification information acquiring step of acquiring, from the electric device, the identification information including the model information of the electric device; a specifications information reading step of reading, from the specifications information storing means, the specifications information corresponding to the model information matching with the model information included in the identification information acquired in the identification information acquiring step; a combination information reading step of reading, from the combination information storing means, the combination information corresponding to the model information matching with the model information included in the identification information acquired in the identification information acquiring step; an integration information creating step of creating integration information by integrating the specifications information read in the specifications information reading step, and the combination information read in the combination information reading step, using the combination information as core data; and a setting check data creating step of creating setting check data for checking a setting concerning the electric device with respect to each of the setting items, based on the integration information created in the integration information creating step.

In the above arrangement, the control device for controlling the electric device is communicatively connected with the at least one electric device stored with the identification information for identifying the electric device. The control device is provided with: the specifications information storing means for storing the specifications information, in which the function information including at least setting items for controlling the electric device is predefined, in association with the model information representing the model of the electric device; and the combination information storing means for storing the combination information describing the dependency between the setting items included in the specifications information in association with the model information for controlling the electric device. In the identification information acquiring step, the identification information including the model information of the electric device is acquired from the electric device. In the specifications information reading step, the specifications information corresponding to the model information matching with the model information included in the identification information acquired in the identification information acquiring step is read from the specifications information storing means. In the combination information reading step, the combination information corresponding to the model information matching with the model information included in the identification information acquired in the identification information acquiring step is read from the combination information storing means. Then, in the integration information creating step, the integration information is created by integrating the specifications information read in the specifications information reading step, and the combination information read in the combination information reading step, using the combination information as the core data. In the setting check data creating step, the setting check data for checking the setting concerning the electric device with respect to the each of the setting items is created, based on the integration information created in the integration information creating step.

As mentioned above, the setting check data with respect to the each of the setting items is created, based on the specifications information, in which the function information is predefined, and the combination information describing the dependency between the setting items included in the specifications information. This enables to execute the setting concerning the electric device, using the created setting check data, create the function information in accordance with the executed setting result, and automatically acquire the function information of the electric devices whose manufacturers, models, and model numbers are different one from another.

Also, the setting check data to be used in the setting check is created, considering the dependency between the setting items. This enables to avoid execution of the setting check concerning the setting item whose setting check has already been executed, enhance the efficiency concerning controllable combinations on setting items, and suppress unwanted communication.

According to the invention, the setting check data with respect to the each of the setting items is created based on the specifications information, in which the function information is predefined, the setting concerning the electric device is executed, using the created setting check data, and the function information is updated based on the setting result. This enables to automatically acquire the function information of the electric devices whose manufacturers, models, and model numbers are different one from another.

These and other objects, features and advantages of the present invention will become more apparent upon reading of the following detailed description along with the accompanying drawings.

### BRIEF DESCRIPTION OF THE DRAWINGS

FIG. 1 is a diagram showing a configuration of a home electric appliance control system according to a first embodiment of the invention.

FIG. 2A is a chart showing an example of contents of identification information to be stored in a home electric appliance.

FIGS. 2B and 2C are charts each showing an example of contents of a property map to be stored in the home electric appliance.

FIGS. 3A and 3B are a chart showing an example of contents of specifications information to be stored in a control device in the case where the home electric appliance is an air conditioner.

FIG. 4 is a chart showing an example of contents of specifications information to be stored in the control device in the case where the home electric appliance is an electric pot.

FIGS. 5A and 5B are a chart showing an example of contents of function information to be stored in the control device in the case where the home electric appliance is an air conditioner.

FIGS. 6A and 6B are a chart showing an example of contents of function information to be stored in the control device in the case where the home electric appliance is an electric pot.

FIG. 7 is a chart showing an example of contents of combination information to be stored in the control device.

FIG. 8 is a flowchart showing an example of an operation of the control system according to the first embodiment of the invention.

FIGS. 9A and 9B are a chart showing an example of contents of integration information to be created by a setting check data creation processor in the case where the home electric appliance is an air conditioner.

FIGS. 10A and 10B are a chart showing an example of contents of integration information to be created by the setting check data creation processor in the case where the home electric appliance is an electric pot.

FIGS. 11A and 11B are charts each showing an example of contents of device status information to be created by the setting check data creation processor.

FIG. 12 is a diagram showing a configuration of the setting check data creation processor shown in FIG. 1.

FIG. 13 is a flowchart for describing a process of creating integration information and device status information in Step S105 of FIG. 8.

FIG. 14 is a flowchart for describing a process of creating setting check data in Step S106 in FIG. 8.

FIGS. 15A and 15B are a flowchart for describing a process of creating setting check data in the case where the data is a setting item whose setting value is a specific value.

FIG. 16 is a flowchart for describing a process of creating the setting check data in the case where the data is a setting item whose setting value has a predetermined range.

FIGS. 17A and 17B are charts each showing an example of contents of the setting check data.

FIG. 17C is a chart showing an example of contents of the setting check data concerning an operating status of the home electric appliance.

FIG. 18 is a diagram showing a configuration of a setting check processor shown in FIG. 1.

FIGS. 19A and 19B are a flowchart for describing a setting check execution process in Step S107 of FIG. 8.

FIG. 20 is a diagram showing a configuration of a reset processor shown in FIG. 1.

FIGS. 21A and 21B are charts each showing an example of contents of reset data.

FIGS. 22A and 22B are a flowchart for describing a reset process in Step S108 of FIG. 8.

FIG. 23 is a diagram showing a configuration of a home electric appliance control system according to a second embodiment of the invention.

FIGS. 24A and 24B are a flowchart showing an example of an operation of the control system according to the second embodiment of the invention.

FIG. 25 is a diagram showing a configuration of a home electric appliance control system according to a third embodiment of the invention.

FIG. 26 is a chart showing an example of a protocol information administration list to be stored in a protocol information administrator.

FIG. 27 is a chart showing an example of a protocol conversion rule to be stored in the protocol information administrator.

FIGS. 28A and 28B are flowcharts for describing a process of acquiring protocol information of a home electric appliance.

FIG. 29 is a flowchart for describing a setting check execution process in the third embodiment.

FIG. 30 is a flowchart for describing a process of creating integration information and device status information in the third embodiment.

FIG. 31 is a diagram showing a configuration of a home electric appliance control system according to a fourth embodiment of the invention.

FIG. 32 is a chart showing an example of judgment criteria data to be stored in a judgment information storage.

FIG. 33 is a flowchart for describing a setting check execution process in the fourth embodiment.

FIG. 34 is a diagram showing a configuration of a home electric appliance control system according to a modification of the fourth embodiment of the invention.

FIG. 35 is a flowchart for describing a setting check execution process in the modification of the fourth embodiment.

FIG. 36 is a chart showing an example of a group list to be stored in the judgment information storage.

FIG. 37 is a chart showing an example of the judgment criteria data to be stored in the judgment information storage.

FIGS. 38A and 38B are charts each showing an example of installation site data to be stored in the judgment information storage.

FIG. 39 is a chart showing an example of the judgment criteria data to be stored in the judgment information storage.

FIGS. 40A and 40B are charts each showing an example of the installation site data and the judgment criteria data to be stored in the judgment information storage.

FIG. 41 is a diagram showing a configuration of a home electric appliance control system according to a fifth embodiment of the invention.

FIG. 42 is a flowchart for describing a process of creating integration information and device status information in the fifth embodiment.

FIG. 43 is a diagram showing a configuration of a home electric appliance control system according to a sixth embodiment of the invention.

FIG. 44 is a flowchart for describing a process of creating integration information and device status information in the sixth embodiment.

FIG. 45 is a diagram showing a configuration of a home electric appliance control system according to a seventh embodiment of the invention.

FIG. 46 is a flowchart for describing an example of an operation of the control system according to the seventh embodiment.

### BEST MODE FOR CARRYING OUT THE INVENTION

In the following, embodiments of the present invention will be described referring to the drawings.

### First Embodiment

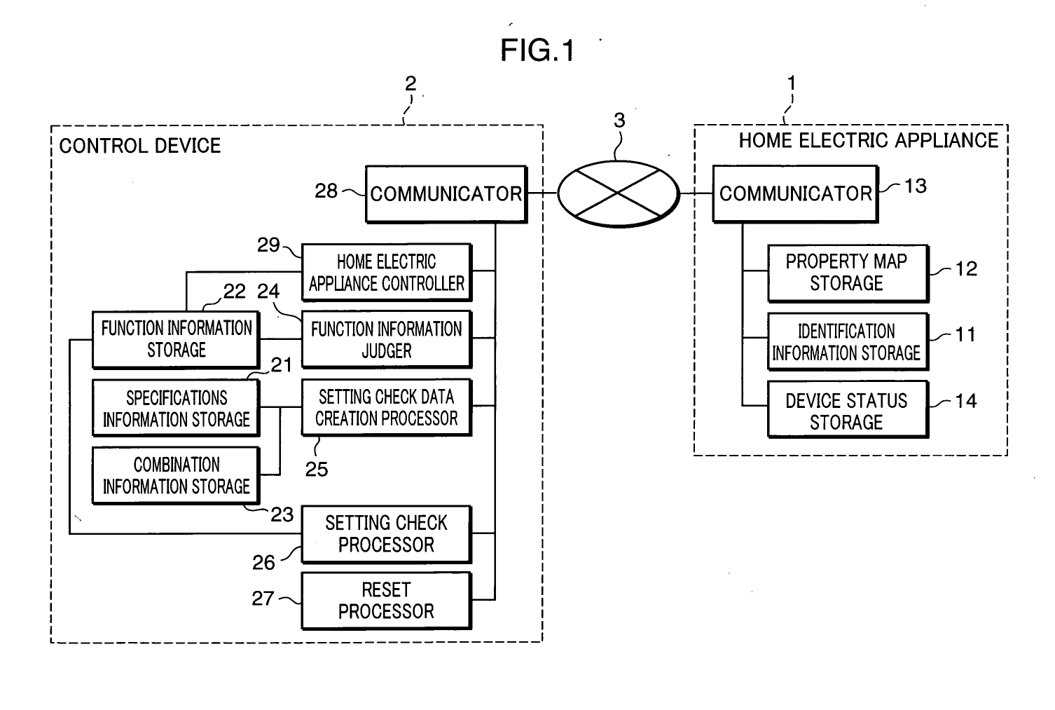

FIG. 1 is a diagram showing a configuration of a home electric appliance control system according to the first embodiment of the invention. Referring to FIG. 1, the home electric appliance control system in the first embodiment includes a home electric appliance 1, a control device 2, and a network 3. The network 3 is an in-house network, and may be a wired or wireless network.

The home electric appliance 1 includes an identification information storage 11 for storing identification information for identifying the home electric appliance 1, a property map storage 12 for storing a property map, a communicator 13 for communicating data with the control device 2 via the network 3, and a device status storage 14 for storing a current status (setting value of a setting item) of the home electric appliance 1.

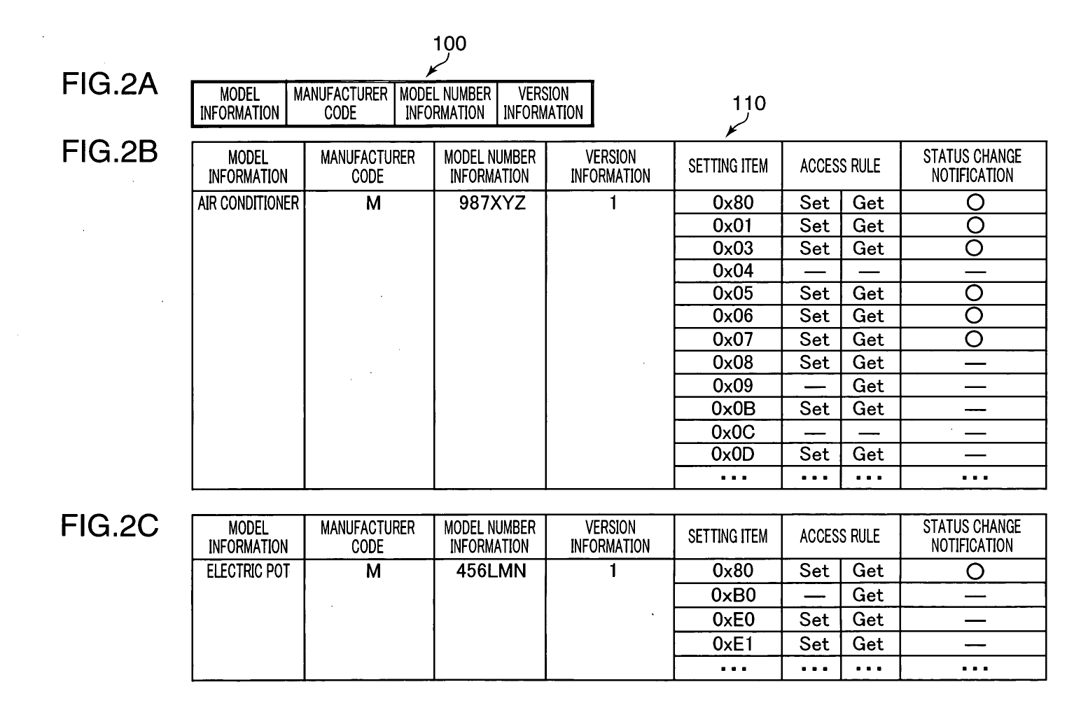

The identification information at least includes model information representing the model of the home electric appliance 1, a manufacturer code representing the manufacturer of the home electric appliance 1, model number information representing the model number of the home electric appliance 1, and version information representing the version of specifications information, in which function information such as setting items or setting values for controlling the home electric appliance 1 is predefined. FIG. 2A is a chart showing an example of contents of the identification information. As shown in FIG. 2A, the identification information 100 which is stored in advance in the identification information storage 11 includes the model information, the manufacturer code, the model number information, and the version information.

The property map includes access rules each describing whether a value is settable (SET) concerning the setting item in response to a request from the control device 2, or a setting value of the setting item is gettable (GET) in response to a request from the control device 2; and information such as status change notifications each representing whether changed contents is to be sent from the home electric appliance 1 to the control device 2 when the setting value of the setting item of the home electric appliance 1 is changed. FIGS. 2B and 2C are charts each showing an example of contents of the property map. FIG. 2B is a chart showing an example of the contents of the property map of the home electric appliance in the case where the home electric appliance is an air conditioner. FIG. 2C is a chart showing an example of the contents of the property map of the home electric appliance in the case where the home electric appliance is an electric pot.

As shown in FIGS. 2B and 2C, the property map 110 stored in the property map storage 12 includes model information, a manufacturer code, model number information, version information, setting items, access rules, and status change notifications. The property map 110 includes a certain number of setting items, and the access rules and the status change notifications are correlated to each other with respect to each of the setting items. In the access rules shown in FIGS. 2B and 2C, “Set” indicates that a value is settable concerning the setting item in response to a request from the control device 2, and “-” indicates that a value is not settable concerning the setting item in response to a request from the control device 2, whereas “Get” indicates that a value of the setting item is acquirable in response to a request from the control device 2, and “-” indicates that a value of the setting item is not acquirable in response to a request from the control device 2. Also, in the status change notifications, “◯” indicates that changed contents is sent from the home electric appliance 1 to the control device 2 when the setting value of the setting item of the home electric appliance 1 is changed, and “-” indicates that changed contents is not sent from the home electric appliance 1 to the control device 2 when the setting value of the setting item of the home electric appliance 1 is changed.

The control device 2 includes a specifications information storage 21, a function information storage 22, a combination information storage 23, a function information judger 24, a setting check data creation processor 25, a setting check processor 26, a reset processor 27, a communicator 28, and a home electric appliance controller 29.

The specifications information storage 21 stores specifications information therein. The specifications information is information, in which the function information such as setting items or setting values for controlling the home electric appliance 1 is predefined. The specifications information is defined with respect to each of the kinds of home electric appliances 1 and each of the version information.

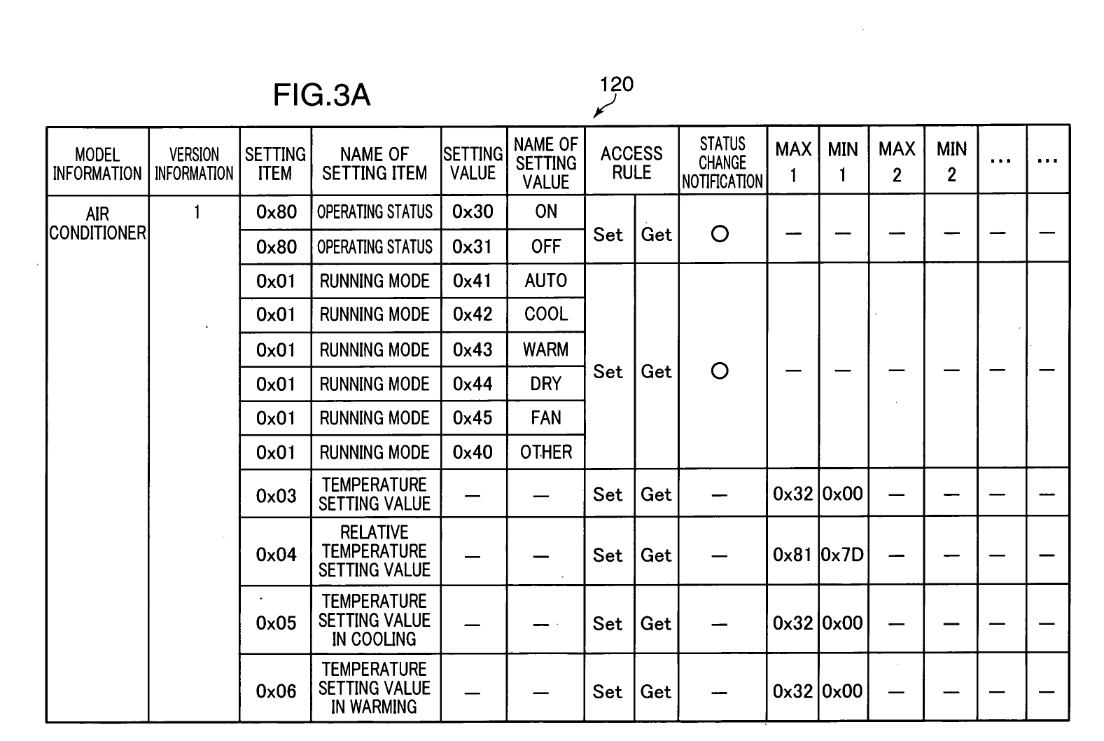

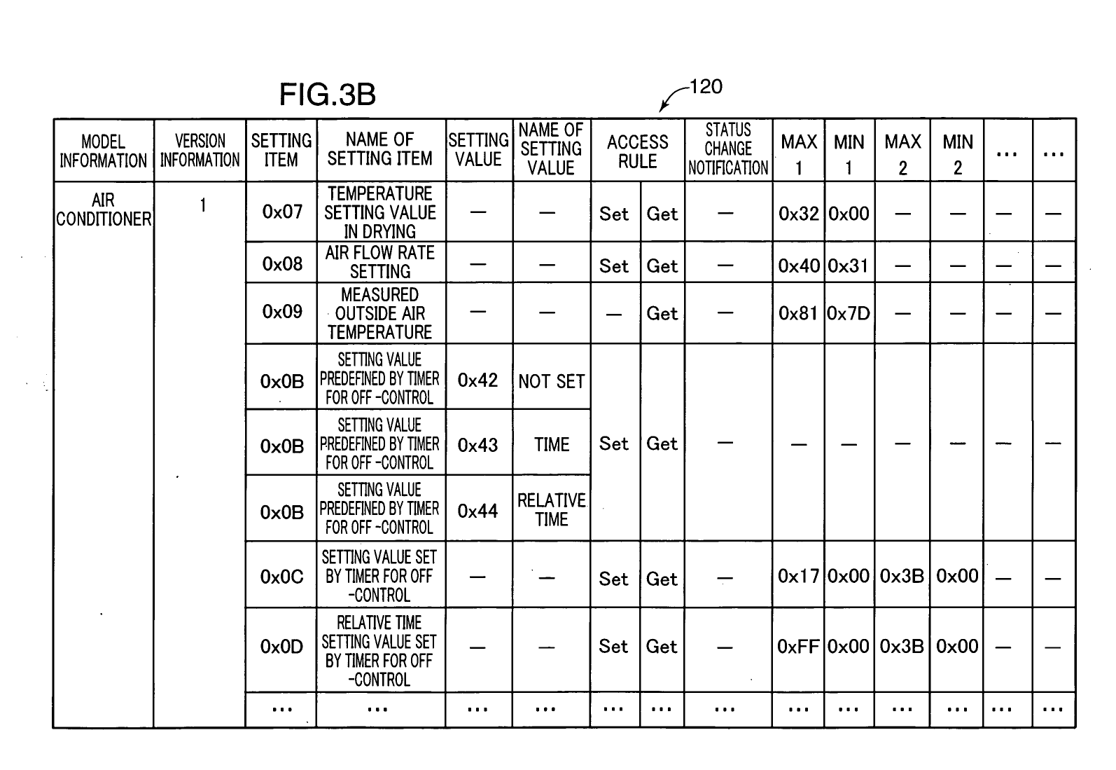

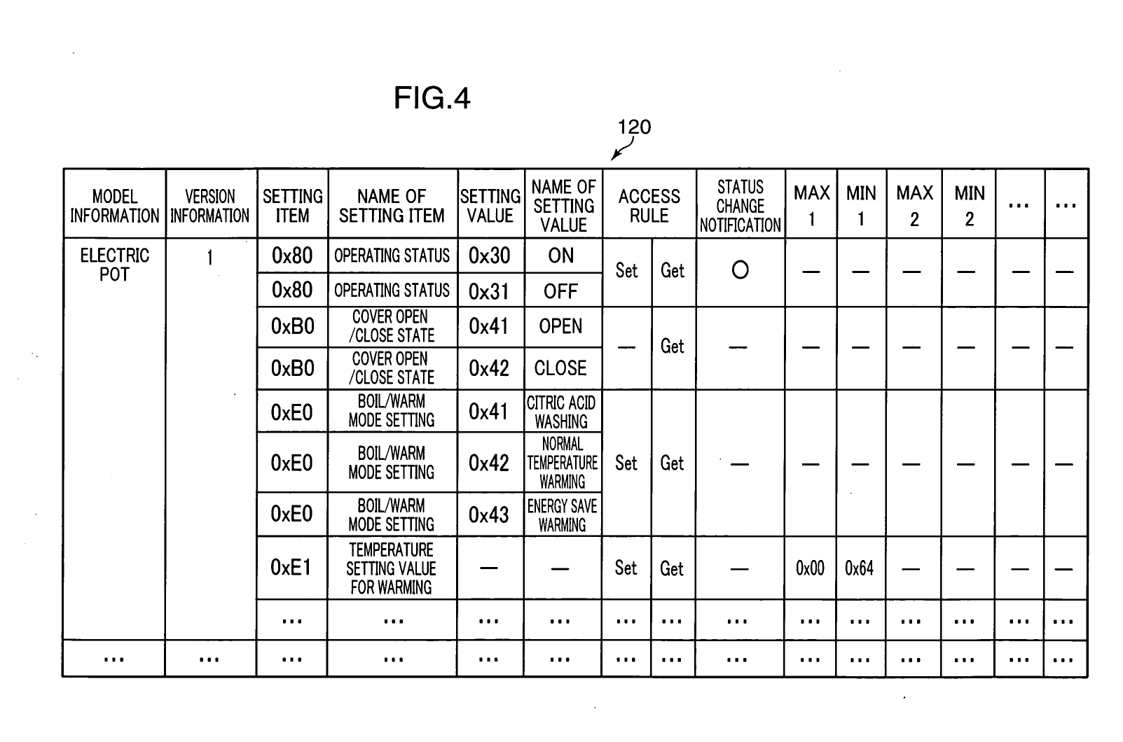

FIGS. 3 and 4 are charts each showing an example of contents of the specifications information to be stored in the control device 2. FIGS. 3A and 3B are a chart showing an example of the contents of the specifications information in the case where the home electric appliance 1 is an air conditioner. FIG. 4 is a chart showing an example of the contents of the specifications information in the case where the home electric appliance 1 is an electric pot. As shown in FIGS. 3A through 4, the specifications information 120 includes model information, version information, setting items, names of the setting items, setting values, names of the setting values, access rules concerning the setting items, status change notifications, and minimal (MIN) and maximal (MAX) values concerning a range of the respective setting values if the setting values have the ranges.

In the case where plural setting values are settable concerning one setting item of the specifications information, the access rules, the status change notifications, the minimal (MIN) and maximal (MAX) values concerning the ranges of the setting values may be correlated with respect to each of the setting items of which the respective setting values are set. In other words, the setting item in the present specification not only represents a setting item itself having no relevancy to setting values, but also represents a setting item corresponding to a specific setting value.

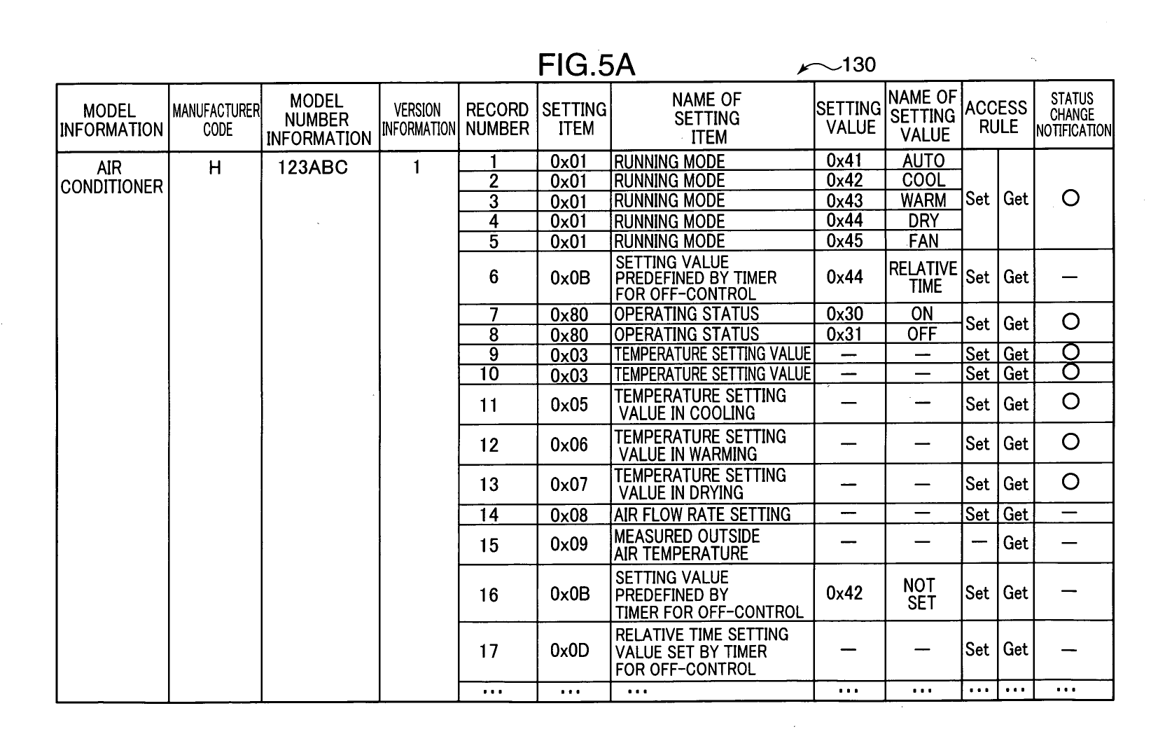

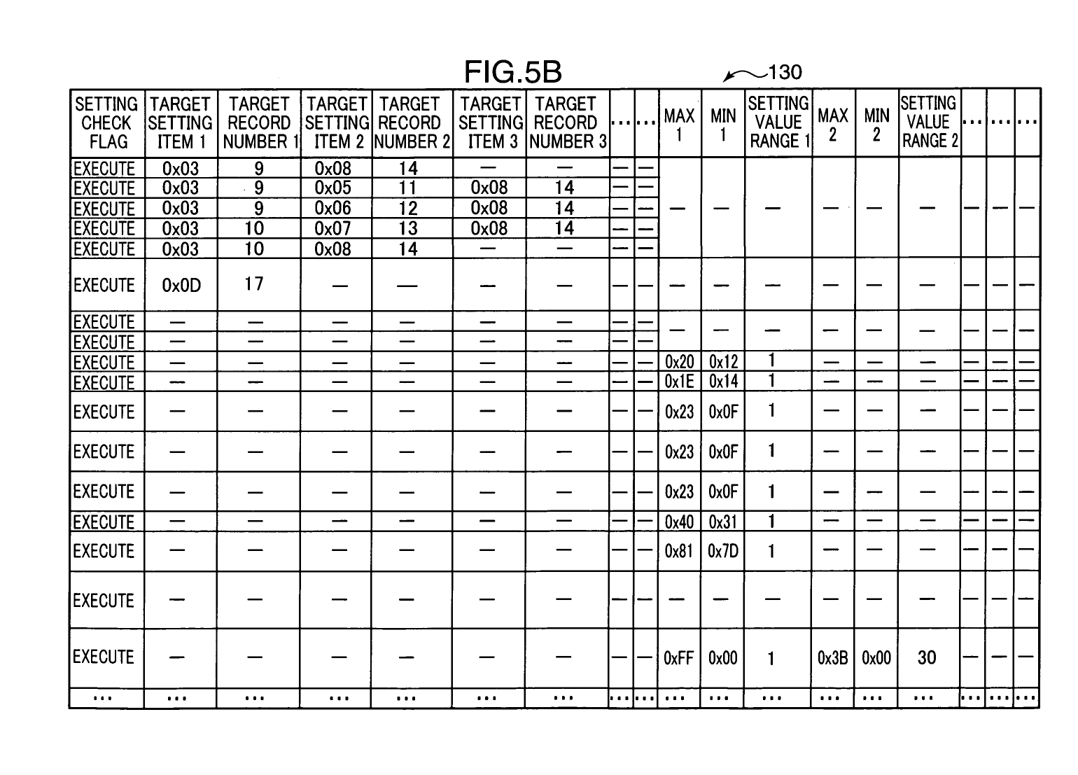

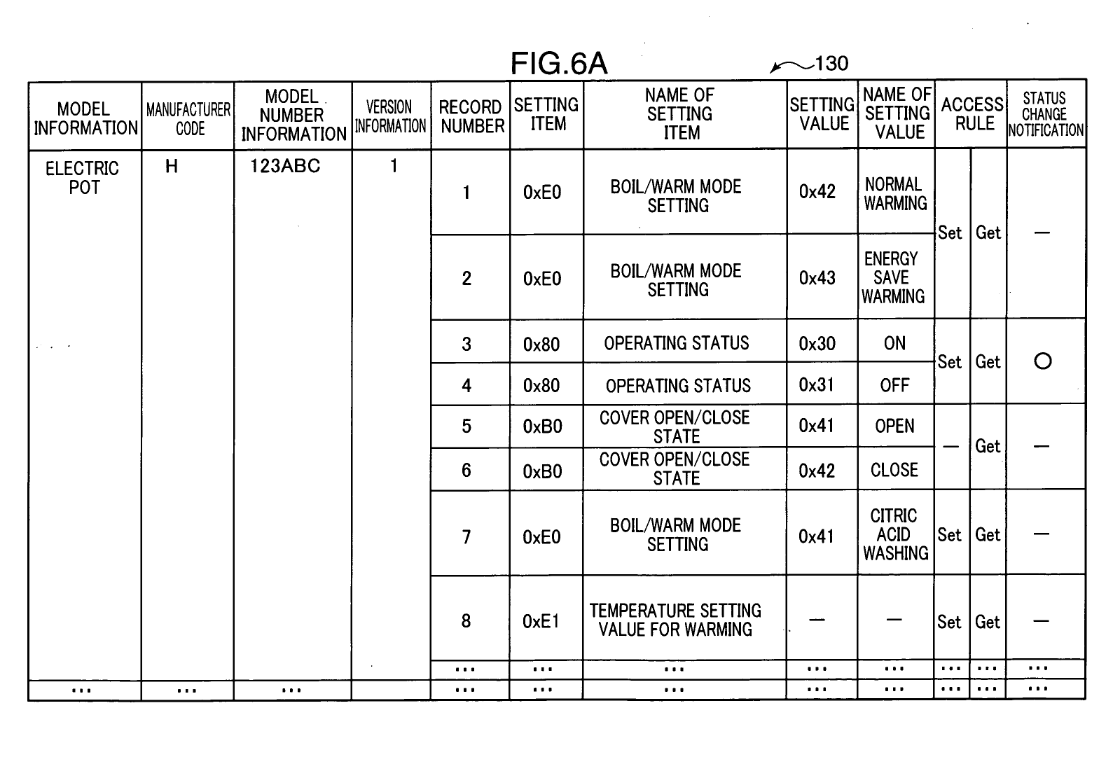

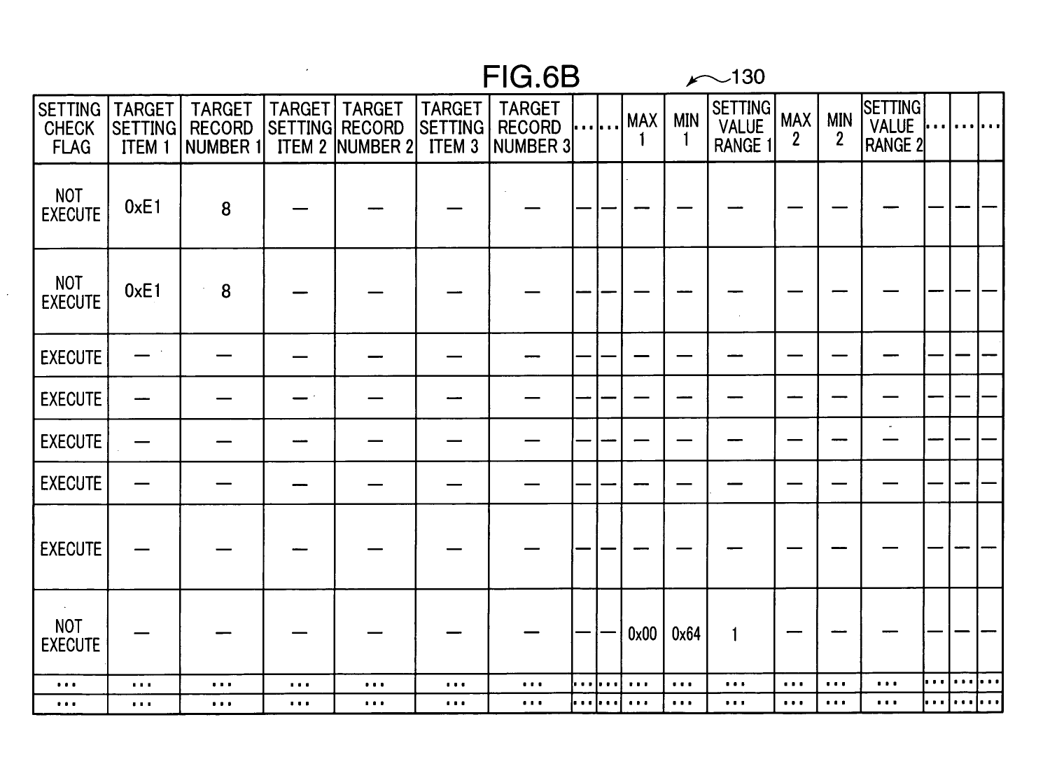

The function information storage 22 stores therein the function information such as the setting items or the setting values, based on which the home electric appliance 1 is actually controllable. The function information is information such as the setting items or the setting values among the specifications information, based on which the home electric appliance 1 is actually controllable. FIGS. 5A through 6B are charts each showing an example of contents of the function information to be stored in the control device 2. FIGS. 5A and 5B are a chart showing an example of the contents of the function information in the case where the home electric appliance 1 is an air conditioner. FIGS. 6A and 6B are a chart showing an example of the contents of the function information in the case where the home electric appliance 1 is an electric pot.

The function information 130 shown in FIGS. 5A through 6B includes model information, a manufacturer code, model number information, version information, record numbers, setting items, names of the setting items, setting values, names of the setting values, access rules, status change notifications, setting check flags, target setting items, target record numbers, maximal setting values (MAX), minimal setting values (MIN), and setting value ranges. Since the contents of the function information 130 having the same indications as the indications of the specifications information 120 are identical to the corresponding contents of the specifications information 120, description thereof will be omitted herein. The record numbers are numbers that are uniquely assigned to corresponding records of the function information with respect to each of the kinds of the home electric appliance 1 and with respect to each of the version information. The setting check flag is information indicating whether a setting check is to be executed. The target setting items and the target record numbers are information representing a dependency between the setting items. The dependency in the specification and claims of the application means that a settable setting item or a setting value of a setting item is changed when the setting value of a certain setting item is changed. The setting value range is information representing the range of the setting value if the setting value has the range. There are a plurality of target setting items, target record numbers, maximal setting values, minimal setting values, and setting value ranges with respect to one setting item, depending on a condition.

In the case where plural setting values are settable concerning one setting item of the function information, other information (e.g. the access rules, the setting check flags, or the target setting items) may be correlated with respect to each of the setting items of which the respective setting values are set.

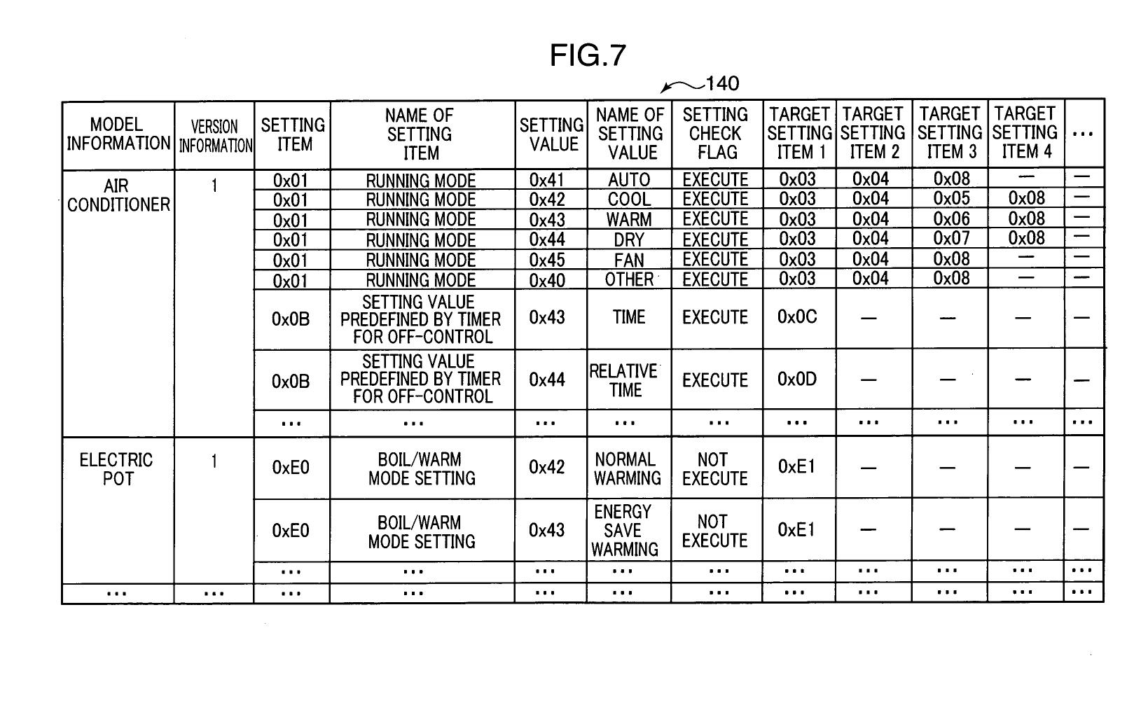

The combination information storage 23 stores combination information describing the dependency between the setting items defined in the specifications information. The combination information is information describing the dependency between the setting items described in the specifications information. FIG. 7 is a chart showing an example of contents of the combination information to be stored in the control device 2. The combination information 140 shown in FIG. 7 includes model information, version information, setting items, names of the setting items, setting values, names of the setting values, setting check flags, and target setting items. Since the contents of the combination information 140 having the same indications as the indications of the specifications information 120 and of the function information 130 are identical to the corresponding contents of the specifications information 120 and of the function information 130, description thereof will be omitted herein. The case that a setting check is not executed by way of the setting check flag is a case that a setting check execution is improper in a condition that, for instance, setting the boiling/warming mode as the setting item in FIG. 7 involves a hazardous condition of boiling/warming without water depending on an environment concerning the setting check.

In the case where plural setting values are settable concerning one setting item of the combination information, the target setting item may be correlated with respect to each of the setting items of which the respective setting values are set. For instance, referring to FIG. 7, setting values “0x41” (automatic running), “0x42” (cooling), “0x43” (warming), “0x44” (drying), “0x45” (fanning), and “0x40” (other operation) are settable concerning the setting item “1x01” (running mode). In view of this, different target setting items are correlated with respect to the setting item “0x01” having the setting value “0x41”, and the setting item “0x01” having the setting value “0x42”, respectively.

In this embodiment, the specifications information and the combination information are stored with respect to each of the kinds (model information) and each of the version information of the home electric appliances. The invention is not specifically limited to the above. Alternatively, the specifications information and the combination information may be stored solely with respect to each of the kinds of the home electric appliances, or at least with respect to each of the model information.

The function information judger 24 judges whether the function information storage 22 stores the function information of the home electric appliance 1. The setting check data creation processor 25 creates setting check data to be sent to the home electric appliance 1 in collecting the function information of the home electric appliance 1. The setting check processor 26 checks a setting with respect to the home electric appliance 1 under the control of the control device 2, using the setting check data created by the setting check data creation processor 25. The reset processor 27 resets the status of the home electric appliance 1 to a status before the setting check after completion of the setting check by the setting check processor 26. The communicator 28 communicates data with the home electric appliance 1 via the network 3. The home electric appliance controller 29 controls the home electric appliance 1, using the function information stored in the function information storage 22.

In this embodiment, the home electric appliance 1 corresponds to an example of an electric device, the specifications information storage 21 corresponds to an example of a specifications information storing means, the combination information storage 23 corresponds to an example of a combination information storing means, the function information storage 22 corresponds to an example of a function information storing means, the home electric appliance controller 29 corresponds to an example of an electric device controlling means, the identification information storage 11 corresponds to an example of an identification information storing means, and the property map storage 12 corresponds to an example of a property map storing means.

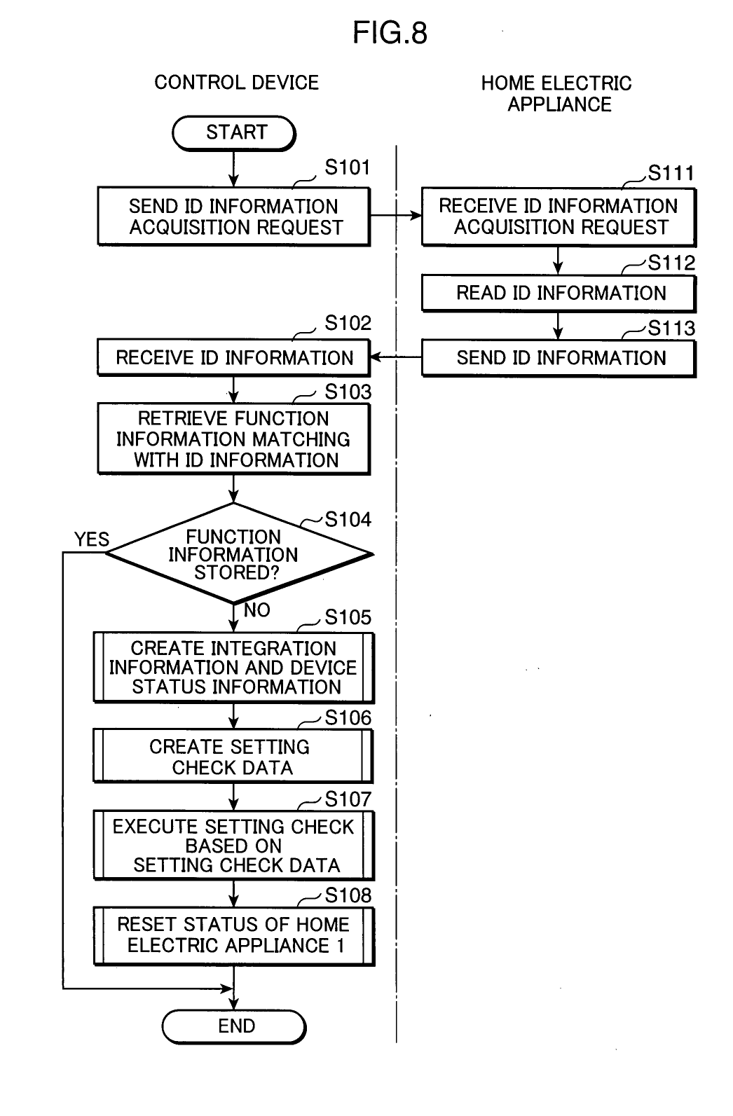

FIG. 8 is a flowchart showing an example of an operation of the control system according to the first embodiment of the invention. The following describes a case that the home electric appliance 1 is connected to the network 3 for the first time.

First, the communicator 28 of the control device 2 sends, to the home electric appliance 1, an identification information acquisition request to acquire the identification information for identifying the home electric appliance 1 (Step S101). Then, the communicator 13 of the home electric appliance 1 receives the identification information acquisition request sent from the control device 2 (Step S111). Then, the communicator 13 reads the identification information of the home electric appliance 1 from the identification information storage 11 (Step S112). Then, the communicator 13 sends the identification information read from the identification information storage 11 to the control device 2 (Step S113).

The identification information acquisition request may be simultaneously sent to all the home electric appliances (1 through N) connected to the network 3 at a predetermined time interval e.g. every one hour. The home electric appliances 2 through N store in their internal memories that their function information have already been registered in the control device 2. Therefore, the home electric appliances 2 through N whose function information have already been registered in the control device 2 do not send their identification information to the control device 2 even if they have received the simultaneously transmitted identification information acquisition request. The home electric appliances 2 through N may send, to the control device 2, reply information indicating that their function information have already been registered in response to receiving the identification information acquisition request. Thus, the home electric appliance 1, which is connected to the network 3 for the first time, and whose registration of its function information is not memorized in an internal memory thereof, is exclusively operative to send its identification information to the control device 2.

Then, the communicator 28 of the control device 2 receives the identification information sent by the home electric appliance 1, and outputs the received identification information to the function information judger 24 (Step S102). In this way, the communicator 28 acquires the identification information of the home electric appliance 1.

Then, the function information judger 24 checks whether the functional information storage 22 stores function information matching with the acquired identification information (Step S103). The checking result in Step S103 determines the process that follows Specifically, the function information judger 24 judges whether the function information storage 22 stores function information matching with the acquired identification information (Step S104). If it is judged that the function information matching with the acquired identification information is stored (YES in Step S104), the routine ends. If, on the other hand, it is judged that the function information matching with the acquired identification information is not stored (NO in Step S104), the routine proceeds to Step S105.

Then, the setting check data creation processor 25 creates integration information for creating setting check data to be used in checking a setting of collecting the function information, and device status information for creating reset data to be used in resetting the status of the home electric appliance 1 after completion of the setting check (Step S105).

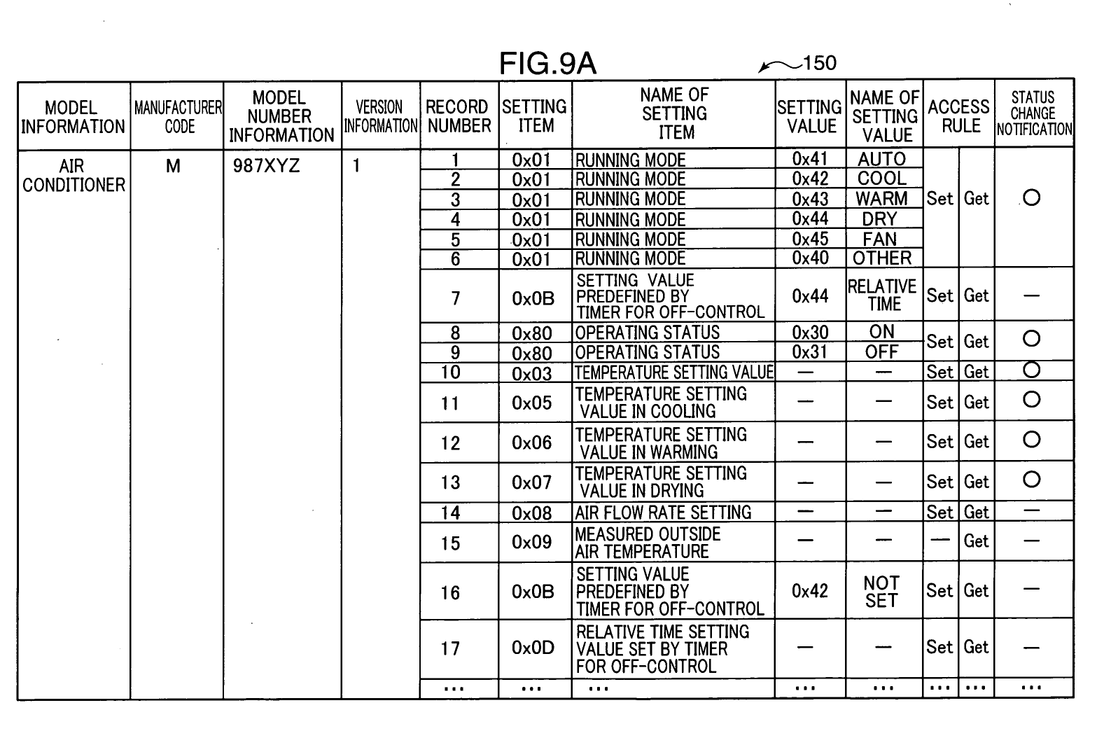

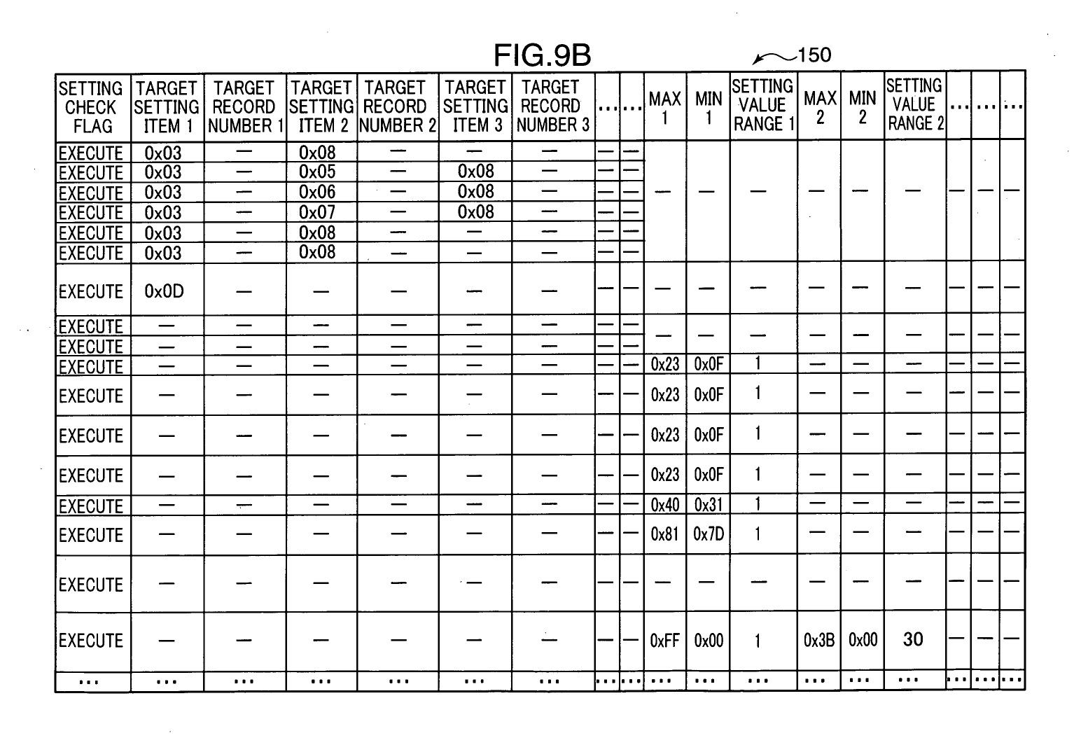

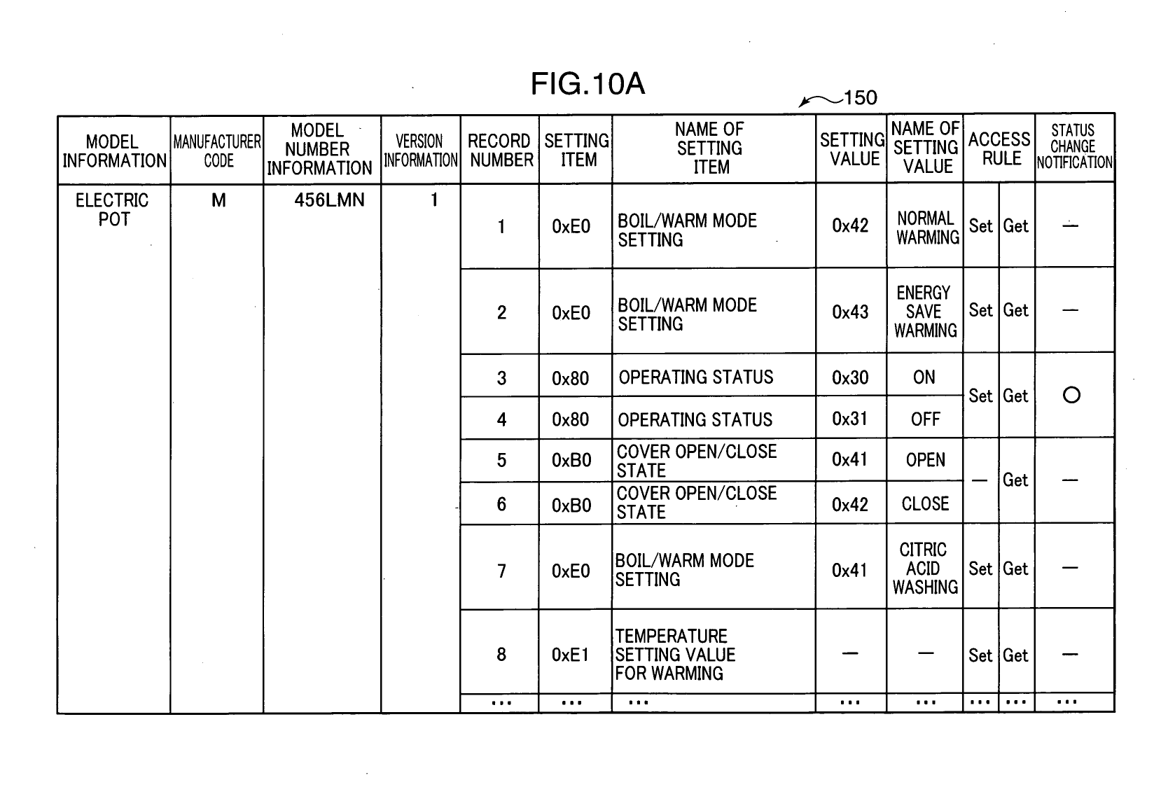

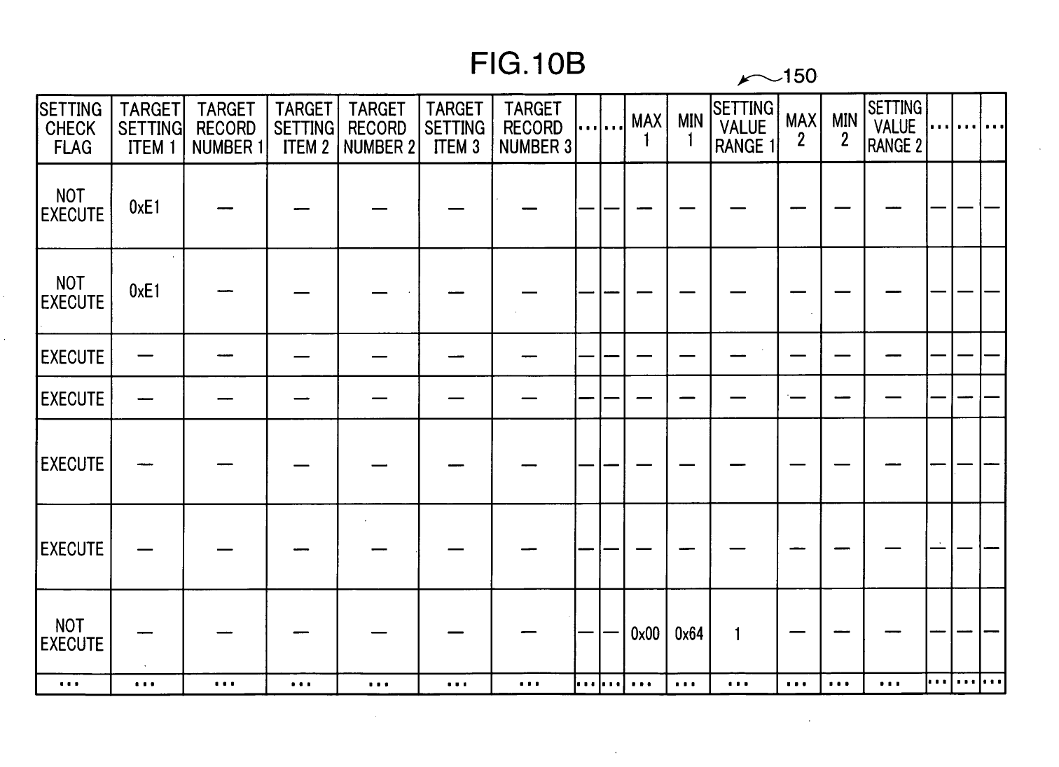

The integration information is information for creating setting check data to be used in checking a setting of collecting the function information. The setting check data creation processor 25 creates the integration information by integrating the acquired specifications information, combination information, and property map, based on the setting item and the setting value, using the combination information as core data. FIGS. 9 and 10 are charts each showing an example of contents of the integration information to be created by the setting check data creation processor 25. FIG. 9 is a chart showing an example of the contents of the integration information in the case where the home electric appliance 1 is an air conditioner. FIG. 10 is a chart showing an example of the contents of the integration information in the case where the home electric appliance 1 is an electric pot. Since the formats of the integration information 150 shown in FIGS. 9A through 10B are identical to the format of the function information, description thereof will be omitted herein.

In the case where plural setting values are settable concerning one setting item of the integration information, other information (e.g. access rules, setting check flags, or target setting items) may be correlated with respect to each of the setting items of which the respective setting values are set.

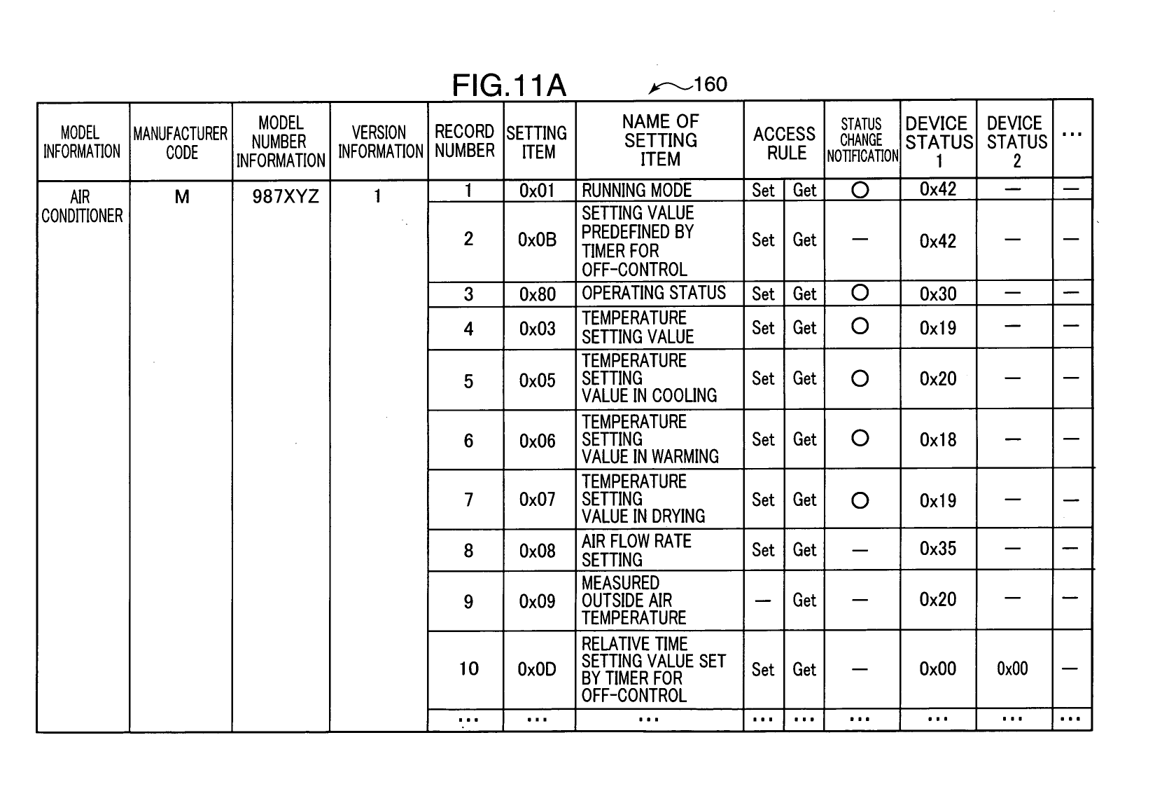

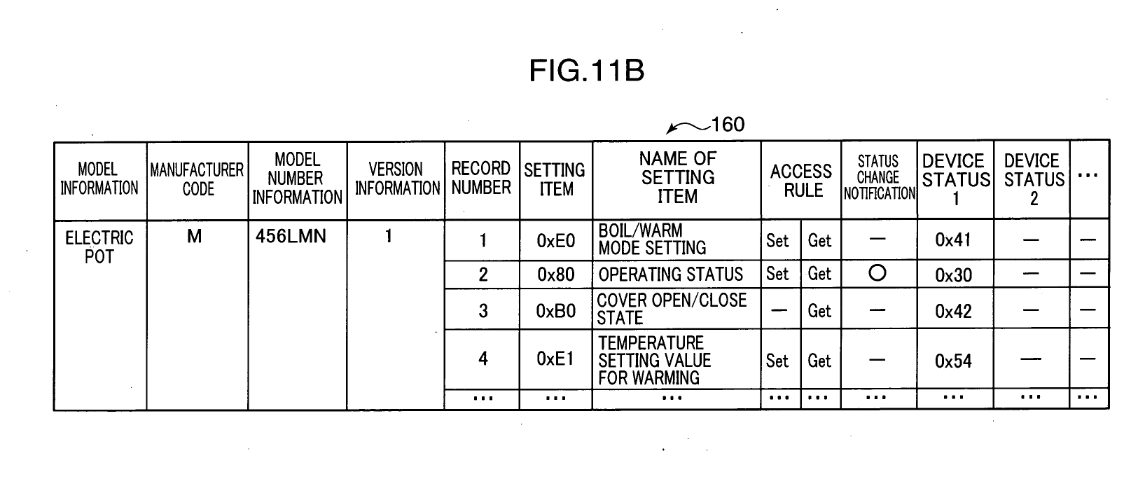

Device status information is information for administering the status of the home electric appliance 1, and is used in creating reset data for executing a reset process after completion of the setting check. FIGS. 11A and 11B are charts each showing an example of contents of the device status information to be created by the setting check data creation processor 25. FIG. 11A is a chart showing an example of the contents of the device status information in the case where the home electric appliance is an air conditioner. FIG. 11B is a chart showing an example of the contents of the device status information in the case where the home electric appliance is an electric pot. Since the contents of the device status information 160 shown in FIGS. 11A and 11B having the same indications as the indications of the integration information 150 are identical to the corresponding contents of the integration information 150, description thereof will be omitted herein.

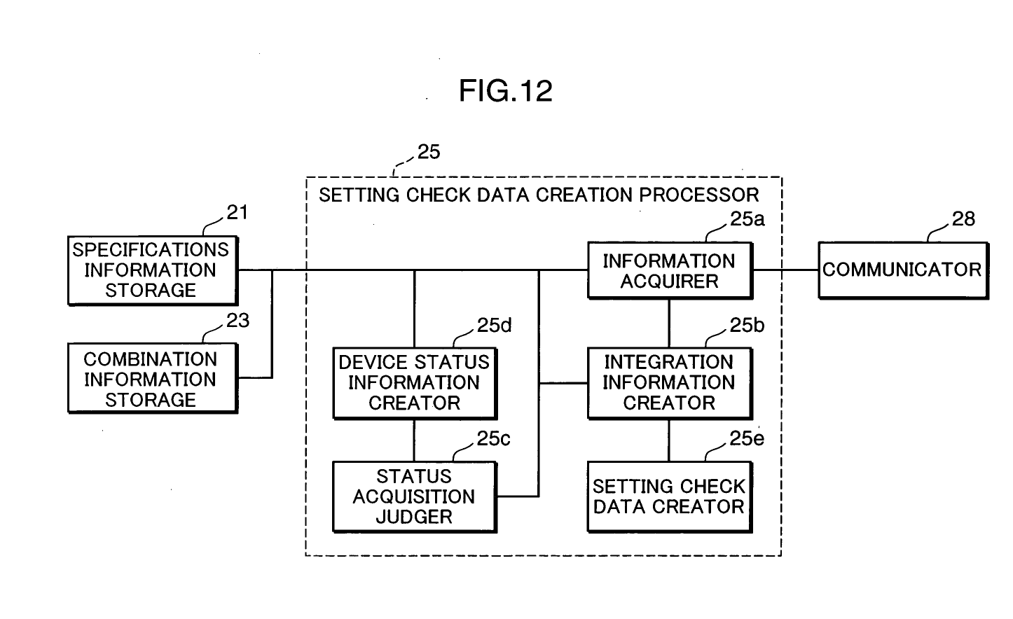

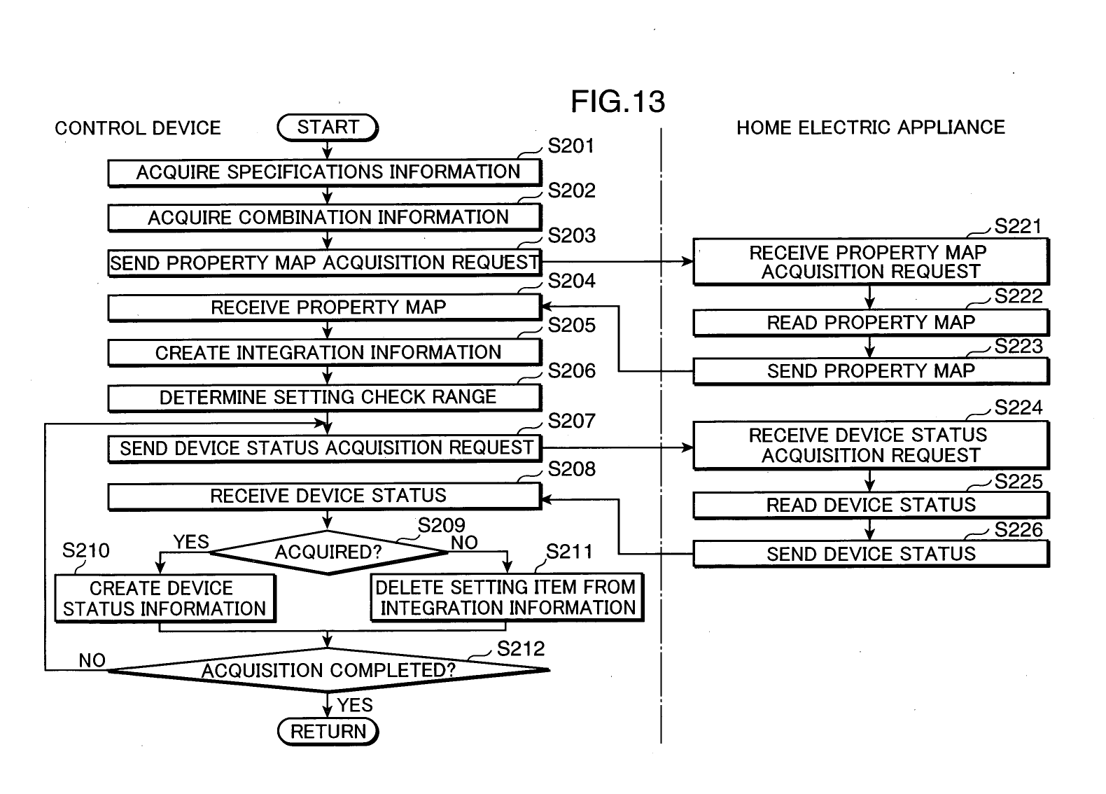

The process of creating the integration information and the device status information in Step S105 will be described later referring to FIGS. 12 and 13.

After Step S105, the setting check data creation processor 25 creates setting check data based on the integration information (Step S106). The process of creating the setting check data in Step S106 will be described later referring to FIGS. 12, and 14 through 16.

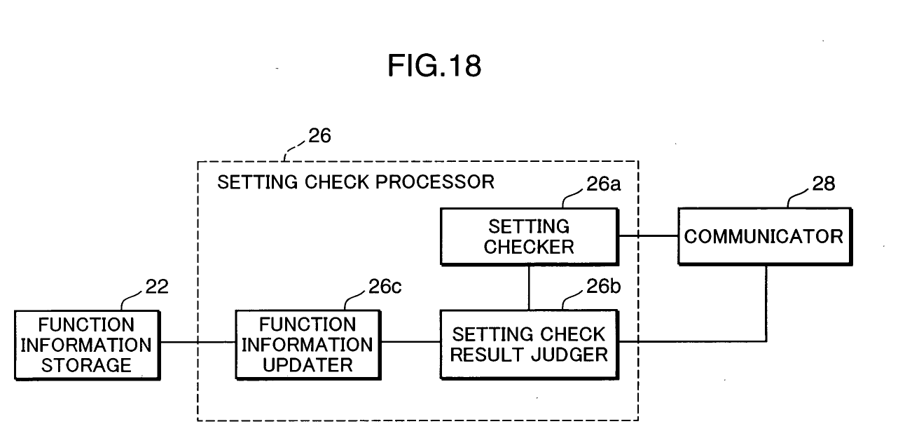

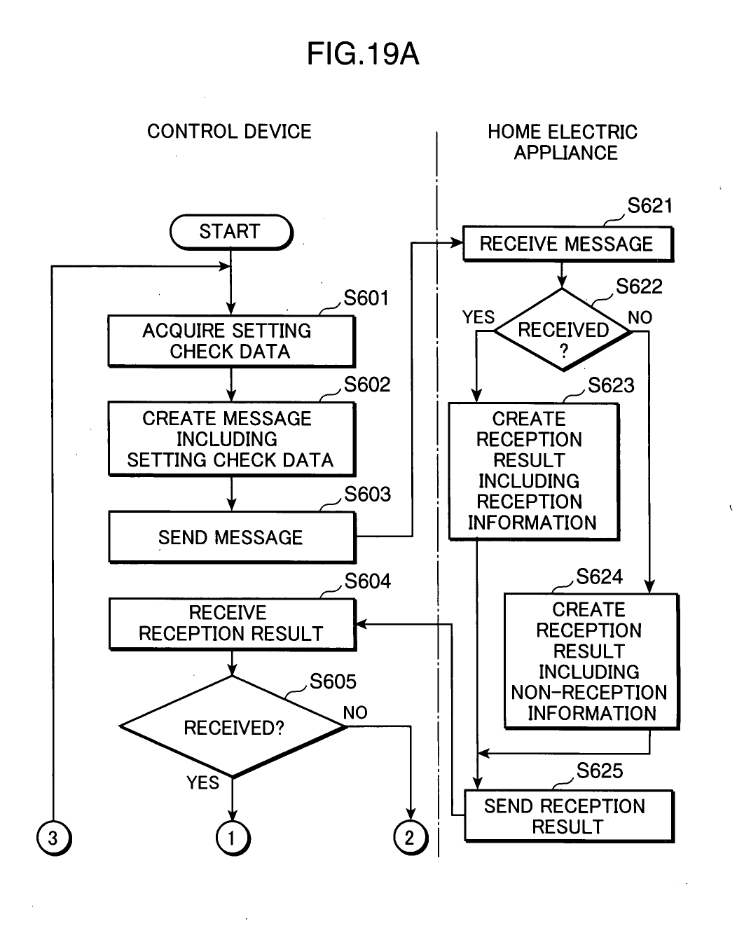

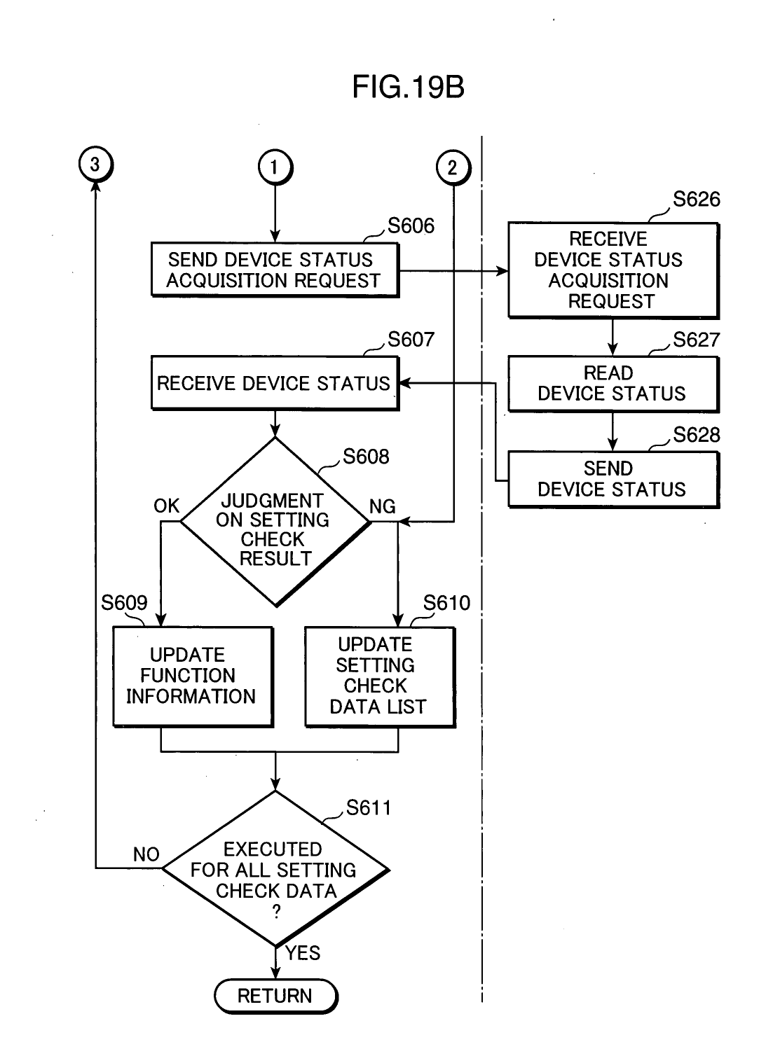

After creation of the setting check data, the setting check processor 26 executes a setting check based on the setting check data created by the setting check data creation processor 25, and collects the function information (Step S107). The process of executing the setting check in Step S107 will be described later referring to FIGS. 18 through 19B.

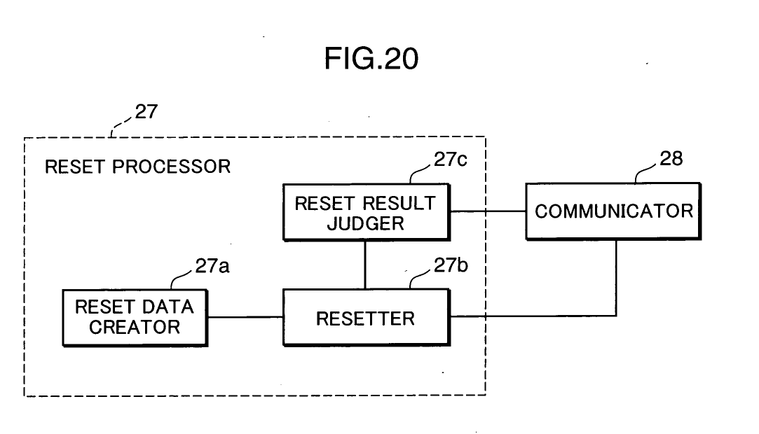

After completion of the setting check, the reset processor 27 creates reset data for executing a reset process, and executes the reset process based on the reset data (Step S108). The process of executing the reset process in Step S108 will be described later referring to FIGS. 20 through 22B.

The process of creating the integration information and the device status information is described in detail. FIG. 12 is a diagram showing a configuration of the setting check data creation processor 25. The setting check data creation processor 25 includes an information acquirer 25a, an integration information creator 25b, a status acquisition judger 25c, a device status information creator 25d, and a setting check data creator 25e.

The information acquirer 25a acquires, from the specifications information storage 21, the specifications information matching with the model information and the version information included in the identification information (identification information acquired from the home electric appliance 1) stored in the internal memory; acquires, from the combination information storage 23, the combination information matching with the model information and the version information included in the identification information stored in the internal memory; acquires the property map from the home electric appliance 1, using the communicator 28; and acquires the status of the home electric appliance 1 from the home electric appliance 1, using the communicator 28. The integration information creator 25b creates integration information based on the acquired specifications information, combination information and property map, and stores the integration information into the internal memory. The status acquisition judger 25c judges whether the information acquirer 25a has acquired the status of the home electric appliance 1. If the status acquisition judger 25c judges that the status of the home electric appliance 1 has been acquired, the device status information creator 25d creates device status information based on the status of the home electric appliance 1, and stores the created device status information into the internal memory. The setting check data creator 25e creates setting check data based on the integration information.

In this embodiment, the information acquirer 25a corresponds to an example of an identification information acquiring means, the setting check data creator 25e corresponds to an example of a setting check data creating means, and the device status information creator 25d corresponds to an example of a device status information creating means.

FIG. 13 is a flowchart for describing a process of creating the integration information and the device status information in Step S105 of FIG. 8. The process of creating the integration information and the device status information in FIG. 13 is a process to be executed by the setting check data creation processor 25 in FIG. 12 and by the home electric appliance 1 in FIG. 1.

Referring to FIG. 13, first, the information acquirer 25a acquires, from the specifications information storage 21, the specifications information corresponding to the model information and the version information matching with the model information and the version information included in the identification information stored in the internal memory (Step S201). Then, the information acquirer 25a acquires, from the combination information storage 23, the combination information matching with the model information and the version information included in the identification information stored in the internal memory (Step S202).

Then, the information acquirer 25a acquires the property map from the home electric appliance 1, using the communicator 28. Specifically, the information acquirer 25a creates a property map acquisition request, and the communicator 28 sends the property map acquisition request created by the information acquirer 25a to the home electric appliance 1 (Step S203). Then, the communicator 13 of the home electric appliance 1 receives the property map acquisition request sent by the control device 2 (Step S221). Then, the communicator 13 reads the property map from the property map storage 12 (Step S222). Then, the communicator 13 sends, to the control device 2, the property map read out from the property map storage 12 (Step S223). Then, the communicator 28 of the control device 2 receives the property map sent by the home electric appliance 1, and outputs the received property map to the information acquirer 25a (Step S204). Then, the information acquirer 25a stores the specifications information, the combination information, and the property map into the internal memory.

Then, the integration information creator 25b creates integration information based on the specifications information, the combination information, and the property map stored in the internal memory (Step S205). The integration information creator 25b integrates the specifications information, the combination information, and the property map based on the setting item and the setting value, using the combination information as core data. By integrating the information, creation of setting check data having a dependency can be prioritized, which makes it possible to efficiently check the setting.

In integration, a certain setting item whose setting and acquisition concerning a setting value thereof are disabled (neither SETTABLE nor GETTABLE) according to the access rule of the property map is not included in the integration information based on a judgment that the certain setting item is not loaded in the home electric appliance 1. Also, in the case where there is a setting item which is neither SETTABLE nor GETTABLE, as a target setting item concerning the combination information, the target setting item is not included in the integration information. Also, it is desirable not to include the setting item having no target setting item (i.e. the dependency has disappeared), as a result of excluding the target setting item as mentioned above, in the aspect of efficiency on the setting check. Further, in a case that a target setting item is set in a certain setting item of the combination information, which is neither SETTABLE nor GETTABLE, and that a dependency is established solely between the target setting item and the certain setting item, it is conceived that the dependency has disappeared. Accordingly, it is desirable not to include the target setting item in the integration information.

The property map information is prioritized concerning the access rules and the status change notifications. In the case where a setting check flag and a target setting item are not described in the combination information, it is determined that the target setting item does not exist, based on an assumption that a setting check concerning the setting check flag and the target setting item can be executed properly. In integration, record numbers are uniquely assigned to the records with respect to each of the model information and each of the version information. Since the target record numbers and the setting value ranges are not information that are included in the specifications information, the combination information, and the property map, the target record number and the setting value range are not specifically designated in Step S205.

In creating the integration information, a setting check may not be executed concerning a setting check flag of a target setting item in a certain setting item, which is so set as not to execute a setting check by way of a setting check flag of the combination information, and which has a dependency solely with the certain setting item. Also, a setting item (or a specific setting value of a setting item) in the combination information, which is so set or settable as not to execute a setting check may be excluded from the integration information.

Then, the integration information creator 25b sets the minimal setting value, the maximal setting value, and the setting value range of the setting item whose setting value has a certain range, and determines the range for executing the setting check (Step S206). For instance, the minimal setting value and the maximal setting value are set to 80% relative to the respective values defined in the specifications information, and the setting value range is set to 1. With this arrangement, the setting check range is limited. This enables to efficiently check the setting, and to suppress unwanted communication. The values defined in the specifications information may be used as the minimal setting value and the maximal setting value.

Then, the information acquirer 25a acquires the status (the setting values of the respective setting items) of the home electric appliance 1, using the communicator 28, concerning the setting item whose setting value is acquirable (GETTABLE) according to the access rule of the integration information. Specifically, the information acquirer 25a creates a device status acquisition request, and the communicator 28 sends, to the home electric appliance 1, the device status acquisition request created by the information acquirer 25a (Step S207). The information acquirer 25a creates the device status acquisition request with respect to each of the setting items whose setting value is acquirable.

Then, the communicator 13 of the home electric appliance 1 receives the device status acquisition request sent by the control device 2 (Step S224). Then, the communicator 13 reads the current device status (the setting values of the respective setting items) of the home electric appliance 1 from the device status storage 14 (Step S225). In this embodiment, merely the setting values acquirable by the control device 2 are read. Then, the communicator 13 sends, to the control device 2, the device status read out from the device status storage 14 (Step S226). Next, the communicator 28 of the control device 2 receives the device status sent by the home electric appliance 1, and outputs the received device status to the information acquirer 25a (Step S208). The acquisition result in Step S208 determines the process that follows.

Specifically, the status acquisition judger 25c judges whether the information acquirer 25a has acquired the device status (Step S209). If the status acquisition judger 25c judges that the device status (the setting values of the respective setting items) of the home electric appliance 1 has been acquired (YES in Step S209), the device status information creator 25d stores the device status (the setting values of the respective setting items) of the home electric appliance 1 acquired by the information acquirer 25a into the internal memory, as device status information (Step S210).

If, on the other hand, the status acquisition judger 25c judges that the status of the home electric appliance 1 has not been acquired, because reply information indicates an error, or because the status (the setting values of the respective setting items) of the home electric appliance 1 is deviated from the information defined in the specifications information, or a like reason (NO in Step S209), the integration information creator 25b judges that the received setting item is a setting item that is not loaded in the home electric appliance 1, and erases the received setting item from the integration information (Step S211). Alternatively, the acquisition step may be repeated a certain number of times if the judgment result indicates acquisition failure. Further alternatively, an integration information updating, resulting from disappearance of the dependency, as mentioned above, or a like reason may be executed when the judgment result indicates acquisition failure.

Then, the information acquirer 25a judges whether the acquisition of the device status has been completed with respect to all the setting items whose setting value is acquirable (Step S212). If the information acquirer 25a judges that the device status acquisition has not been completed with respect to all the setting items (NO in Step S212), the routine returns to Step S207, and repeats the process until the device status acquisition concerning the home electric appliance 1 has been completed with respect to all the setting items. If the information acquirer 25a judges that the device status acquisition has been completed with respect to all the setting items (YES in Step S212), the routine ends.

As mentioned above, by acquiring the status of the home electric appliance 1, information for a reset process can be collected, and a judgment as to whether the setting items are loaded in the home electric appliance 1 can be executed. Alternatively, the setting item which is judged to be loaded in the home electric appliance 1 may be written in the function information storage 22 as function information, so that data concerning the function information may not be created in creating setting check data by the setting check data creation processor 25. The altered arrangement enables to collect the information concerning the setting item for which a setting check is not executed. Further alternatively, acquisition of the device status (the setting values of the respective setting items) of the home electric appliance 1 may be used solely for the judgment as to whether the respective setting items are loaded in the home electric appliance 1. Also, the device status acquisition concerning the home electric appliance 1 may be omitted, which enables to enhance the efficiency on the setting check because a time required for the setting check is eliminated or shortened.

In this embodiment, the property map is acquired from the home electric appliance 1. Alternatively, the property map acquisition from the home electric appliance 1 may be omitted. Further alternatively, the property map may not be loaded in the home electric appliance 1. In the latter alteration, the information described in the specifications information may be used as the access rules or the status change notifications.

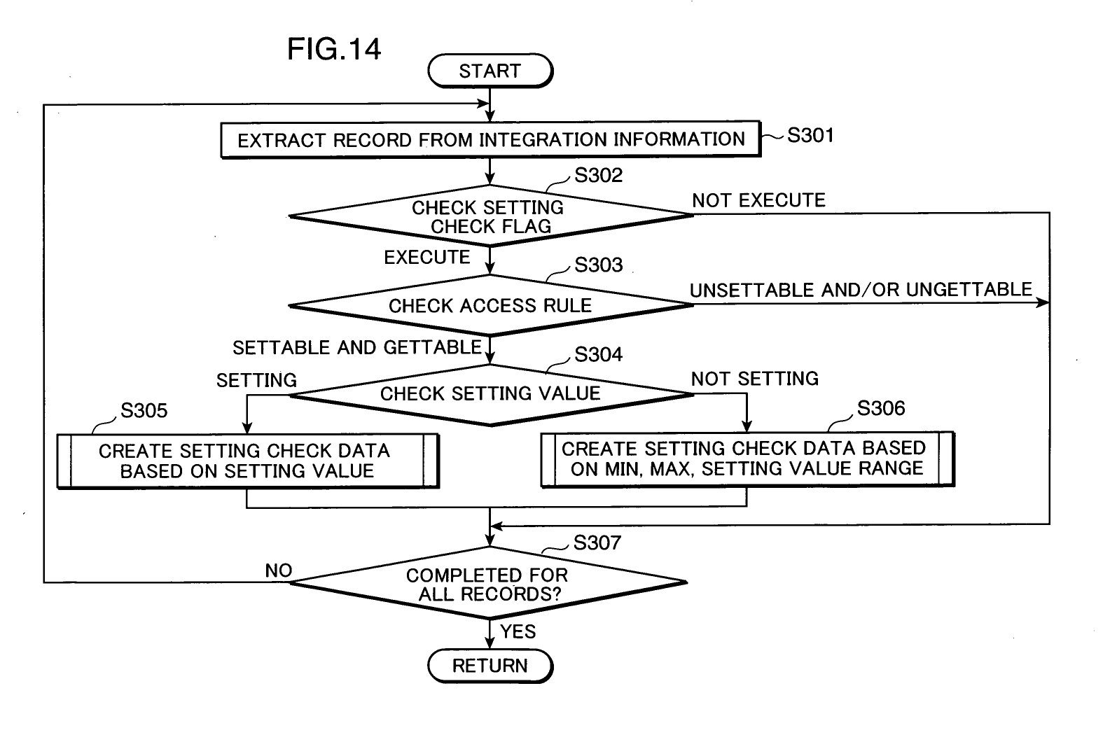

Now, the process of creating the setting check data is described in detail. FIG. 14 is a flowchart for describing the process of creating the setting check data in Step S106 of FIG. 8. A setting check data creation process in FIG. 14 is a process to be executed by the setting check data creation processor 25 in FIG. 12. The setting check data creator 25e shown in FIG. 12 creates setting check data based on the integration information.

Referring to FIG. 14, first, the setting check data creator 25e extracts the records from the integration information created by the integration information creator 25b one by one (Step S301). Then, the setting check data creator 25e judges whether a setting check is to be executed, referring to the setting check flag of the extracted record (Step S302). If the setting check flag indicates “NOT EXECUTE”, and the setting check data creator 25e judges that the setting check is not executed (“NOT EXECUTE” in Step S302), the routine proceeds to Step S307 based on a determination that setting check data is not created concerning the record.

If the setting check flag indicates “EXECUTE”, and the setting check data creator 25e judges that the setting check is to be executed (“EXECUTE” in Step S302), the setting check data creator 25e checks the access rule of the extracted record (Step S303). If at least one of the setting and the acquisition of a setting value of a setting item is disabled (“UNSETTABLE AND/OR UNGETTABLE” in Step S303), the routine proceeds to Step S307 based on a determination that setting check data is not created. Specifically, if both the setting and the acquisition of a setting value of a setting item are disabled, or if either one of the setting and the acquisition of a setting value of a setting item is disabled according to the access rule of the extracted record, the setting check data creator 25e is operative not to create setting check data.

If both of the setting and the acquisition of a setting value of a setting item are enabled (“SETTABLE AND GETTABLE” in Step S303), the setting check data creator 25e checks the setting value of the extracted record (Step S304). A judgment as to whether the setting value of the setting item is data having a specific value (data without a predetermined range), or data without a specific value (data having a predetermined range) determines the process that follows.

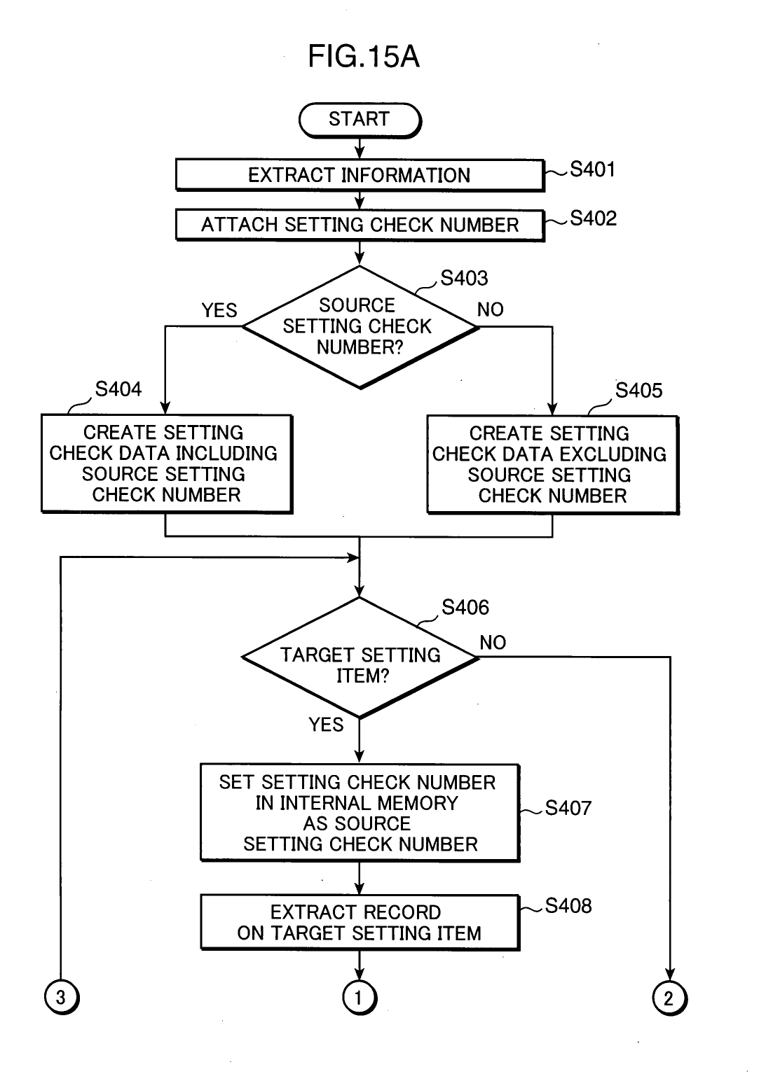

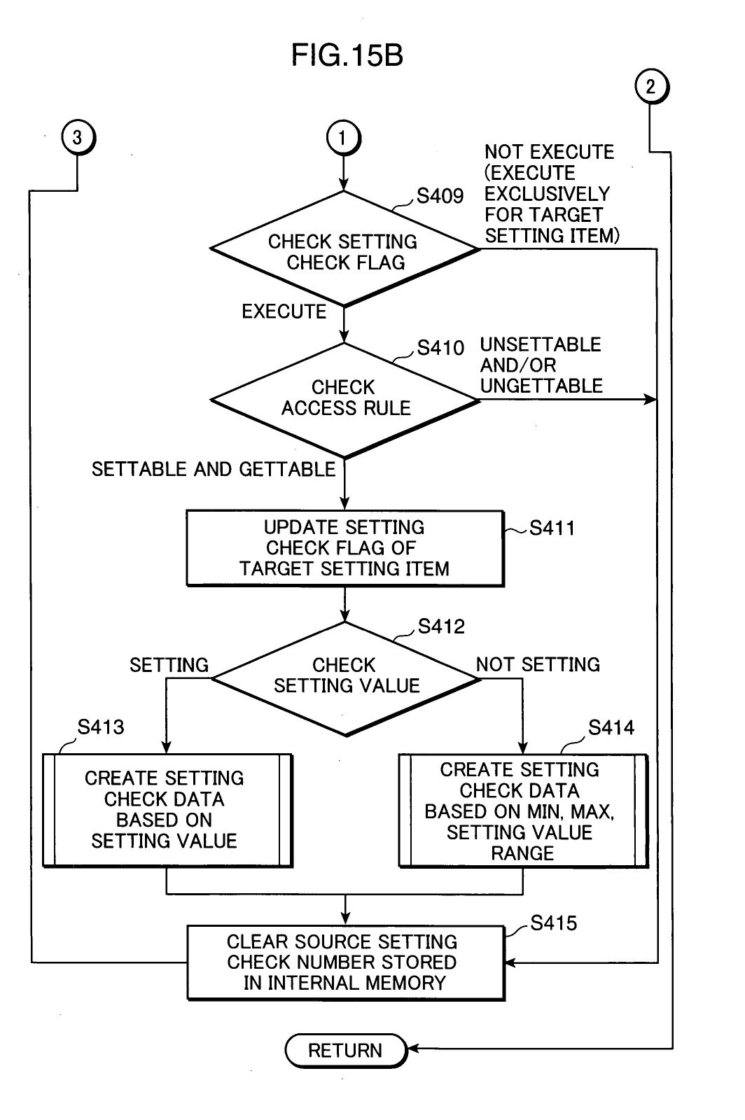

If the setting value of the setting item is data having a specific value (“SETTING” in Step S304), the setting check data creator 25e creates setting check data based on the setting value (Step S305). The setting check data creation process to be executed in the case where the setting value is data having a specific value will be described later referring to FIGS. 15A and 15B.

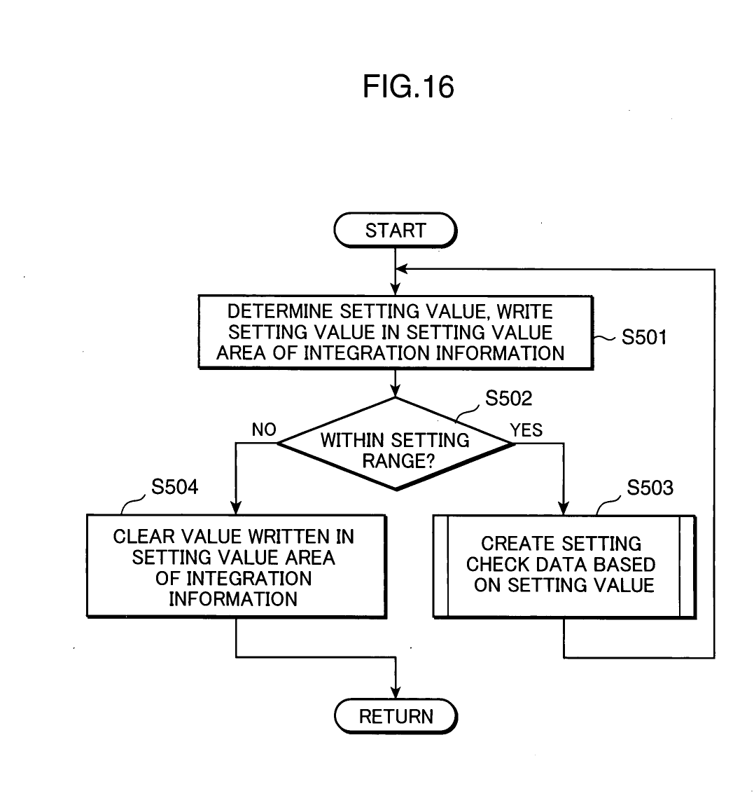

If, on the other hand, the setting value of the setting item is data having a predetermined range (“NO SETTING” in Step S304), the setting check data creator 25e creates setting check data based on the minimal value (MIN), the maximal value (MAX) of the setting range, and the setting value range (Step S306). For instance, in the case of the air conditioner having the integration information 150 shown in FIGS. 9A and 9B, the running mode of the setting item “0x01” corresponds to data having a specific value such as automatic running or cooling, and the temperature setting value of the setting item “0x03” corresponds to data having a predetermined range. The setting check data creation process to be executed in the case where the setting value is data having a predetermined range will be described later referring to FIG. 16.

Next, the setting check data creator 25e judges whether the setting check data has been created with respect to all the records of the integration information (Step S307). If the setting check data creator 25e judges that the setting check data has been created with respect to all the records (YES in Step S307), the routine ends. If, on the other hand, the setting check data creator 25e judges that the setting check data has not been created with respect to all the records (NO in Step S307), the routine returns to Step S301, and repeats the process until the setting check data is created with respect to all the records.

Now, the setting check data creation process to be executed in the case where the setting value of the setting item is data having a specific value (Step S305 in FIG. 14) is described. FIGS. 15A and 15B are a flowchart for describing the setting check data creation process to be executed in the case where the setting value of the setting item is data having a specific value. The setting check data creation process to be executed in the case where the setting value of the setting item is data having a specific value shown in FIGS. 15A and 15B is a process to be executed by the setting check data creation processor 25 in FIG. 12.

Referring to FIGS. 15A and 15B, first, the setting check data creator 25e extracts information such as the setting item, the setting value, and the status change notification from the record (Step S401). Then, the setting check data creator 25e calculates a setting check number that uniquely represents the entirety of the setting check data, and attaches the setting check number to the extracted information (Step S402). A judgment result as to whether a source setting check number is stored in the internal memory determines the process that follows.

Specifically, the setting check data creator 25e judges whether the source setting check number is stored (Step S403). The source setting check number is set in the course of the setting check data creation process (the process of Step S407 to be described later) in the case where the setting value of the setting item is data having a specific value. The source setting check number is the number to be used in applying the dependency between the setting items described in the combination information to the setting check data. In creating setting check data of a target setting item dependent on a certain setting item, the setting check number of setting check data of the certain setting item is set in the setting check data of the target setting item, as the source setting check number. This enables to apply the dependency to the setting check data, and to enhance the efficiency on the setting check by not executing a setting check concerning the setting item having a dependency, if the setting check concerning the source setting item has been failed (i.e. the setting item or the setting value is not loaded).

If the setting check data creator 25e judges that the source setting check number is stored (YES in Step S403), the setting check data creator 25e stores the setting item, the setting value, the status change notification, the setting check number, the source setting check number, and the like into the internal memory, as setting check data (Step S404). If the setting check data creator 25e judges that the source setting check number is not stored (NO in Step S403), the setting check data creator 25e stores the setting item, the setting value, the status change notification, the setting check number, and the like into the internal memory, as setting check data (Step S405).

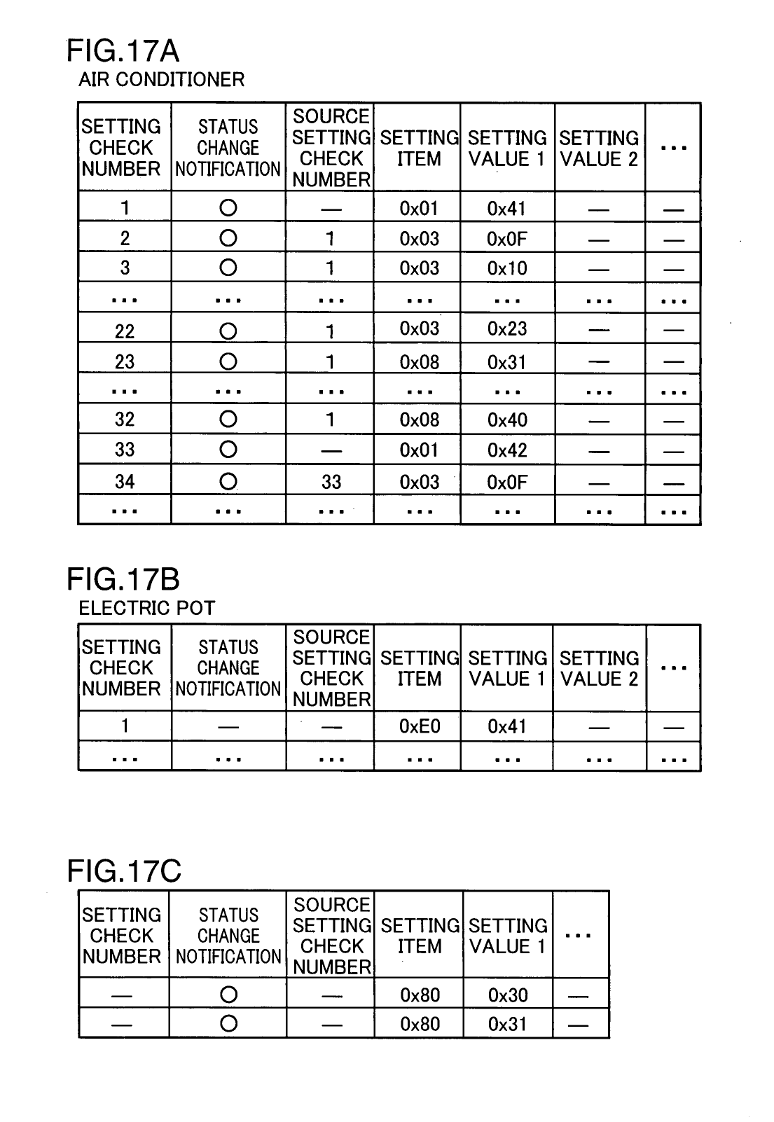

FIGS. 17A and 17B are charts each showing an example of contents of the setting check data. FIG. 17C is a chart showing an example of contents of the setting check data concerning an operating status of the home electric appliance 1. FIG. 17A is a chart showing an example of the contents of the setting check data in the case where the home electric appliance 1 is an air conditioner. FIG. 17B is a chart showing an example of the contents of the setting check data in the case where the home electric appliance 1 is an electric pot.

As shown in FIGS. 17A and 17B, the setting check data 170 includes setting check numbers each uniquely representing the entirety of the corresponding setting check data, status change notifications, source setting check numbers, setting items, and setting values. The operating status of the setting item relates to an ON/OFF state of the power source of the home electric appliance 1. Accordingly, it is desirable to create data for ON/OFF control of the power source for a condition that the ON/OFF control of the power source is necessary depending on the contents of the setting check, and to store the data for the ON/OFF control independently of the setting check data (see FIG. 17C). Alternatively, the data for the ON/OFF control of the power source may be created according to needs. The data for the ON/OFF control of the power source may be used in the case where the ON/OFF control of the power source is necessary in the setting check process or a like process.

In the case where plural setting values are settable concerning one setting item of the setting check data, the setting check number is attached with respect to each of the setting items of which the respective setting values are set.

A judgment result as to whether the target setting item has been set determines the process that follows. Specifically, the setting check data creator 25e judges whether the target setting item has been set (Step S406). If the setting check data creator 25e judges that the target setting item has not been set (NO in Step S406), the routine ends. If the setting check data creator 25e judges that the target setting item has been set (YES in Step S406), the setting check data creator 25e stores the setting check number that has been attached in Step S402 into the internal memory, as the source setting check number (Step S407).

Next, the setting check data creator 25e extracts the record having the target setting item as the setting item from the integration information (Step S408). The setting check data creator 25e judges whether a setting check is to be executed, referring to the setting check flag of the extracted record (Step S409). If the setting check flag indicates “NOT EXECUTE”, and the setting check data creator 25e judges that a setting check is not executed (“NOT EXECUTE” in Step S409), the routine proceeds to Step S415 based on a determination that setting check data is not created concerning the record.

If the setting check flag indicates “EXECUTE”, and the setting check data creator 25e judges that a setting check is to be executed (“EXECUTE” in Step S409), the setting check data creator 25e checks the access rule of the extracted record (Step S410). If at least one of the setting and the acquisition of a setting value of a setting item is disabled (“UNSETTABLE AND/OR UNGETTABLE” in Step S410), the routine proceeds to Step S415 based on a determination that setting check data is not created.

If both of the setting and the acquisition of a setting value of a setting item are enabled (“SETTABLE AND GETTABLE” in Step S410), the setting check data creator 25e updates the setting check flag of the target setting item, by attaching, to the setting check flag of the extracted record, information indicating that data creation is necessary exclusively for the target setting item (Step S411). This operation is performed, considering a point that independent setting check concerning the target setting item is not necessary since the setting check concerning the target setting item is executed in association with the setting check concerning the source setting item. If the setting check flag is updated, the judgment of Step S302 in the flowchart of FIG. 14 indicates that setting check data creation is not necessary. Alternatively, updating of the setting check flag may not be executed to execute the setting check concerning the target setting item independently of the setting check concerning the source setting item.

Next, the setting check data creator 25e checks the setting value of the setting item of the extracted record (Step S412). A judgment as to whether the setting value of the setting item is data having a specific value (data without a predetermined range), or data without a specific value (data having a predetermined range) determines the process that follows.

If the setting value of the setting item is data having a specific value (“SETTING” in Step S412), the setting check data creator 25e creates setting check data based on the setting value (Step S413). If the setting value of the setting item is data having a predetermined range (“NO SETTING” in Step S412), the setting check data creator 25e creates setting check data based on the minimal value (MIN), the maximal value (MAX) of the setting range, and the setting value range (Step S414).

After creation of the setting check data in Step S413 or Step S414, or if it is judged that setting check data is not created in Step S409 or Step S410, the setting check data creator 25e clears the latest source setting check number stored in the internal memory (Step S415). Thereafter, the routine returns to Step S406, and the setting check data creator 25e executes a judgment on a new target setting item. The internal memory storing the source setting check numbers is operative in such a manner that: the setting check number is set in the uppermost area of the internal memory in storing the setting check number; the uppermost located data in the internal memory is extracted in clearing the setting check number; and the uppermost located data is referred to in setting the setting check number in the setting check data. The processes in Steps S413 and S414 in FIG. 15B correspond to the processes in Steps S305 and S306 in FIG. 14, respectively. In this embodiment, the status change notifications are included in the setting check data. Alternatively, the status change notifications may be excluded from the setting check data.

Next, the setting check data creation process (Step S306 in FIG. 14) in the case where the setting value of the setting item is data having a predetermined range is described. FIG. 16 is a flowchart for describing the setting check data creation process to be executed in the case where the setting value of the setting item is data having a predetermined range. The setting check data creation process to be executed in the case where the setting value of the setting item is data having a predetermined range is a process to be executed by the setting check data creation processor 25 in FIG. 12.

Referring to FIG. 16, first, the setting check data creator 25e calculates the setting value, and writes the calculated setting value in a setting value area of the integration information (Step S501). For example, the setting value may be calculated by defining the minimal value (MIN in the integration information) of the setting range, or the maximal value (MAX in the integration information) of the setting range, as the setting value. A judgment as to whether the value written in the setting value area of the integration information lies in the setting value range defined by the minimal value (MIN) and the maximal value (MAX) determines the process that follows.

Specifically, the setting check data creator 25e judges whether the value written in the setting value area of the integration information lies in the setting value range (Step S502). If the setting check data creator 25e judges that the value is in the setting range (YES in Step S502), the setting check data creator 25e creates setting check data according to the flowchart shown in FIGS. 15A and 15B (Step S503). If the setting check data creator 25e judges that the value is out of the setting range (NO in Step S502), the setting check data creator 25e clears the setting value written in the setting value area of the integration information, and the routine ends (Step S504). After creation of the setting check data in Step S503, the process of calculating a new setting value, and writing the calculated setting value in the setting value area of the integration information is repeated. There is a case that a setting check is not executed at all depending on the calculated setting value. In view of this, it is desirable to set the minimal value (MIN) or the maximal value (MAX) as an initial setting value, or to calculate the setting value so that the setting check is executed at least once.

Now, the setting check execution process of executing the setting check, using the setting check data shown in FIG. 17A, and of collecting the function information of the home electric appliance 1 is described in detail. FIG. 18 is a diagram showing a configuration of the setting check processor 26 shown in FIG. 1. The setting check processor 26 includes a setting checker 26a, a setting check result judger 26b, and a function information updater 26c. The setting checker 26a executes a setting check based on the setting check data created by the setting check data creation processor 25. The setting check result judger 26b acquires a setting check result, and judges the setting check result. The function information updater 26c updates the function information stored in the function information storage 22, based on the information collected by the setting check.

In this embodiment, the setting checker 26a corresponds to an example of a setting executing means, the setting check result judger 26b corresponds to an example of a setting result checking means, and the function information updater 26c corresponds to an example of a function information updating means.

FIGS. 19A and 19B are a flowchart for describing the setting check execution process in Step S107 in FIG. 8. The setting check execution process in FIGS. 19A and 19B is a process to be executed by the setting check processor 26 in FIG. 18 and by the home electric appliance 1 in FIG. 1.

Referring to FIGS. 19A and 19B, first, the setting checker 26a extracts one setting check data from the list of the setting check data (see FIG. 17A) stored in the internal memory (Step S601). Then, the setting checker 26a creates a message including the extracted setting check data (S602). Then, the setting checker 26a outputs the created message to the communicator 28, which, in turn, sends the message outputted by the setting checker 26a to the home electric appliance 1 (Step S603).

Then, the communicator 13 of the home electric appliance 1 receives the message sent by the control device 2 (Step S621). Then, the communicator 13 judges whether the setting check data included in the message is to be received (Step S622). Specifically, if the home electric appliance 1 has a function capable of executing the setting check data, the communicator 13 receives the setting check data. If the home electric appliance 1 does not have a function capable of executing the setting check data, the communicator 13 does not receive the setting check data.

If the communicator 13 judges that the setting check data is received (YES in Step S622), the communicator 13 creates a reception result including reception information indicating that the setting check data is received (Step S623). If, on the other hand, the communicator 13 judges that the setting check data is not received (NO in Step S622), the communicator 13 creates a reception result including non-reception information indicating that the setting check data is not received (Step S624). Then, the communicator 13 sends the reception result created in Step S623 or S624 to the control device 2 (Step S625). Upon receiving the setting check data, the home electric appliance 1 executes a setting check based on the received setting check data, and stores the device status in accordance with the executed setting check into the device status storage 14.

Then, the communicator 28 of the control device 2 receives, from the home electric appliance 1, a reception result as to whether the home electric appliance 1 has received the setting check data (Step S604). If the communicator 28 has failed to receive the reception result in Step S604, the process of acquiring the reception result (process of sending the message in Step S603 to the home electric appliance 1) may be repeated a certain number of times. The reception result obtained in Step S604 determines the process that follows. Specifically, the setting checker 26a judges whether the home electric appliance 1 has received the setting check data (Step S605). If reception information is included in the received reception result, the setting checker 26a judges that the home electric appliance 1 has received the setting check data. If non-reception information is included in the received reception result, the setting checker 26a judges that the home electric appliance has not received the setting check data.

If the setting checker 26a judges that the home electric appliance 1 has not received the setting check data (NO in Step S605), the setting checker 26a updates the setting check data list (Step S610). An example of the updating operation is to erase, from the setting check data list, the setting check data having the setting check number of the setting check data that has been sent to the home electric appliance 1, as the source setting check number. This arrangement eliminates the need of executing an unwanted setting check, which enables to efficiently check the setting, and to suppress unwanted communication.

If, on the other hand, the setting checker 26a judges that the home electric appliance 1 has received the setting check data (YES in Step S605), the setting check result judger 26b acquires the status of the home electric appliance 1, using the communicator 28, to judge the setting check result. Specifically, the setting check result judger 26b creates a device status acquisition request to acquire the status of the home electric appliance 1, and the communicator 28 sends, to the home electric appliance 1, the device status acquisition request created by the setting check result judger 26b (Step S606).

Then, the communicator 13 of the home electric appliance 1 receives the device status acquisition request sent by the control device 2 (Step S626). Then, the communicator 13 reads the current device status (setting values of the respective setting items) of the home electric appliance 1 from the device status storage 14 (Step S627). Then, the communicator 13 sends the device status read out from the device status storage 14 to the control device 2 (Step S628).

Then, the communicator 28 of the control device 2 receives the device status sent by the home electric appliance 1, and outputs the received device status to the setting check result judger 26b (Step S607). The device status of the home electric appliance 1 may be acquired by receiving a status change notification if there is the status change notification from the home electric appliance 1. Further alternatively, in the case where the communicator 28 has failed to receive the device status in Step S607, the process of acquiring the device status (process of sending the device status acquisition request in Step S606 to the home electric appliance 1) may be repeated a certain number of times. Then, the setting check result judger 26b acquires the status of the home electric device 1, and judges the setting check result (Step S608). The judgment result in Step S608 determines the process that follows.

If the setting check result judger 26b judges that the contents of which the setting check has been executed is loaded by setting the contents of the setting check data in the home electric appliance 1 or a like operation (“OK” in Step S608), the function information updater 26c writes the contents of which the setting check has been executed into the function information storage 22 (Step S609). If the setting check result judger 26b judges that the contents of which the setting check has been executed is not loaded because reply information indicates an error, or because the setting value that has been sent to the home electric appliance 1 does not coincide with the acquired setting value, or a like reason (“NG” in Step S608), the setting checker 26a updates the setting check data list (Step S610). An example of the updating operation is to erase, from the setting check data list, the setting check data having the setting check number of the setting check data that has been sent to the home electric appliance 1, as the source setting check number. This arrangement eliminates the need of executing an unwanted setting check, which enables to efficiently check the setting, and to suppress unwanted communication.

Then, the setting check result judger 26b judges whether the setting check has been executed with respect to all the setting check data (Step S611). If the setting check result judger 26b judges that the setting check has been executed with respect to all the setting check data (YES in Step S611), the routine ends. If, on the other hand, the setting check result judger 26b judges that the setting check has not been executed with respect to all the setting check data (NO in Step S611), the routine returns to Step S601, and the process is repeated until the setting check is executed with respect to all the setting check data.

Now, the reset process of resetting the status of the home electric device 1 to the status before the setting check is executed is described in detail. FIG. 20 is a diagram showing a configuration of the reset processor 27 shown in FIG. 1. The reset processor 27 includes a reset data creator 27a, a resetter 27b, and a reset result judger 27c.

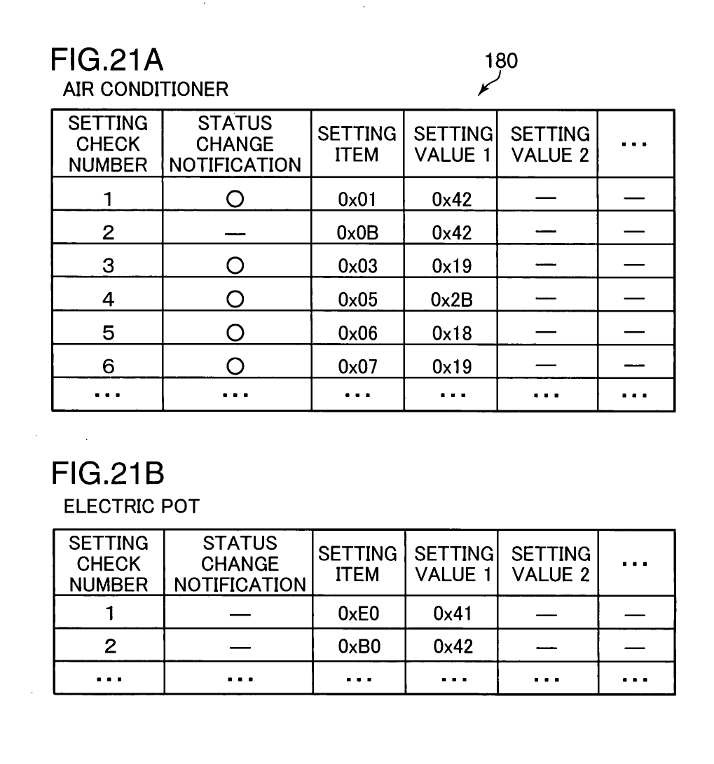

The reset data creator 27a extracts information such as the setting item, the device status, and the status change notification from the device status information created by the setting check data creation processor 25, and creates reset data. FIGS. 21A and 21B are charts each showing an example of contents of the reset data. FIG. 21A is a chart showing an example of the contents of the reset data in the case where the home electric appliance is an air conditioner. FIG. 21B is a chart showing an example of the contents of the reset data in the case where the home electric appliance is an electric pot. As shown in FIGS. 21A and 21B, the reset data 180 includes setting check numbers each uniquely representing the entirety of the corresponding reset data, status change notifications, setting items, and setting values (device statuses). The operating statuses of the setting items may be stored independently in a similar manner as the setting check data. In the reset process, data for ON/OFF control of the power source may also be used when the ON/OFF control of the power source is necessary. The resetter 27b resets the status of the home electric appliance 1 based on the reset data created by the reset data creator 27a. The reset process is a process of recovering the status of the home electric appliance 1 to the status before the setting check is executed. The reset result judger 27c judges the result of the reset process.

In this embodiment, the reset data creator 27a corresponds to an example of a reset data creating means, and the resetter 27b corresponds to an example of a resetting means.

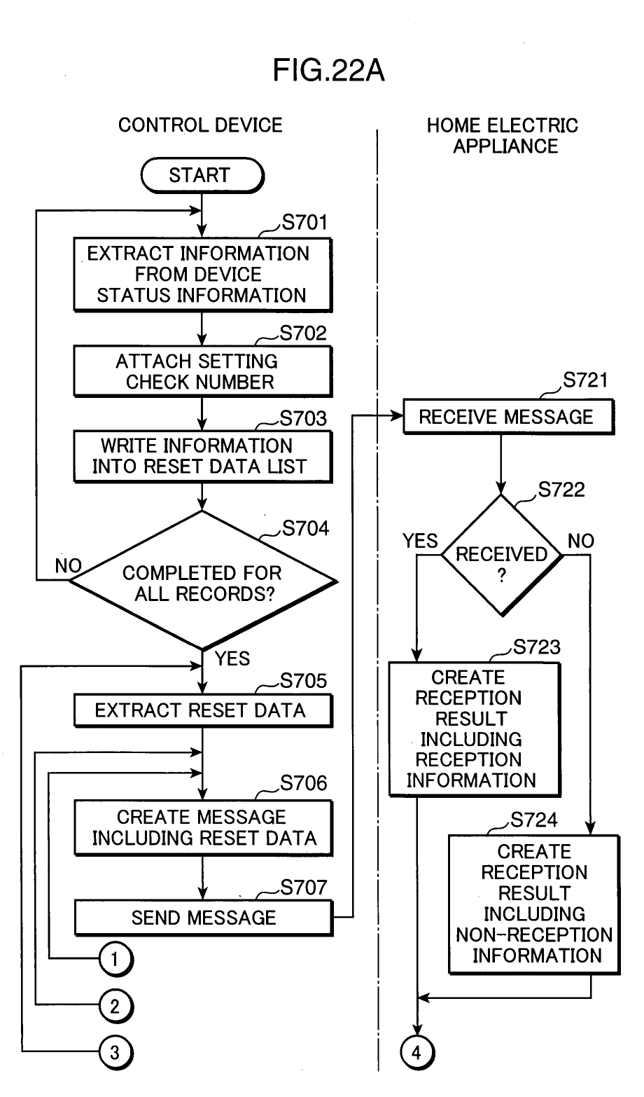

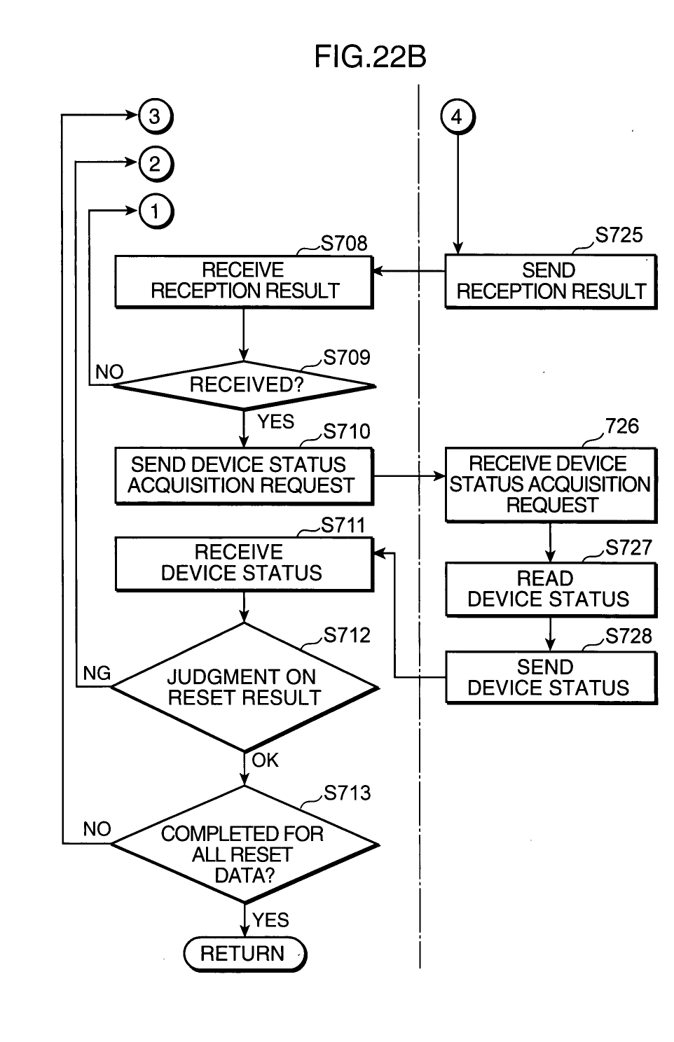

FIGS. 22A and 22B are a flowchart for describing the reset process of resetting the status of the home electric appliance 1 in Step S108 of FIG. 8. The reset process in FIGS. 22A and 22B is a process to be executed by the reset processor 27 in FIG. 20 and by the home electric appliance 1 in FIG. 1.

Referring to FIGS. 22A and 22B, first, the reset data creator 27a extracts information such as the setting item, the device status, and the status change notification of one record, from the device status information created by the setting check data creation processor 25 (Step S701). Then, the reset data creator 27a attaches, to the extracted information, the setting check number that uniquely represents the reset data (Step S702). Then, the reset data creator 27a writes the information attached with the setting check number into the reset data list (Step S703). The reset data list is stored in the internal memory.

Then, the reset data creator 27a judges whether reset data has been created with respect to all the records in the device status information (Step S704). If the reset data creator 27a judges that the reset data has been created with respect to all the records in the device status information (YES in Step S704), the routine proceeds to Step S705. If, on the other hand, the reset data creator 27a judges that the reset data has not been created with respect to all the records in the device status information (NO in Step S704), the routine returns to Step S701, and repeats the process until the reset data is created with respect to all the records in the device status information.

Then, the resetter 27b extracts the reset data of one record from the reset data list stored in the internal memory (Step S705). Then, the resetter 27b creates a message including the extracted reset data (Step S706). Then, the resetter 27b outputs the created message to the communicator 28, which, in turn, sends the message outputted from the resetter 27b to the home electric appliance 1 (Step S707).

Then, the communicator 13 of the home electric appliance 1 receives the message sent by the control device 2 (Step S721). Then, the communicator 13 judges whether the reset data included in the message is to be received (Step S722). Specifically, if the home electric appliance 1 has a function capable of executing the reset data, the communicator 13 judges that the reset data is to be received. If the home electric appliance 1 does not have a function capable of executing the reset data, the communicator 13 judges that the reset data is not to be received.

If the communicator 13 judges that the reset data is to be received (YES in Step S722), the communicator 13 creates a reception result including reception information indicating that the reset data is received (Step S723). If, on the other hand, the communicator 13 judges that the reset data is not to be received (NO in Step S722), the communicator 13 creates a reception result including non-reception information indicating that the reset data is not received (Step S724). Then, the communicator 13 sends, to the control device 2, the reception result created in Step S723 or Step S724. In the case where the communicator 13 has received the reset data, the home electric appliance 1 executes the reset process based on the reset data, and the device status in accordance with the executed reset process is stored in the device status storage 14.

Then, the communicator 28 of the control device 2 receives, from the home electric appliance 1, the reception result as to whether the home electric appliance 1 has received the reset data (Step S708). The judgment result in Step S708 determines the process that follows. Specifically, the resetter 27b judges whether the home electric appliance 1 has received the reset data (Step S709). If the received reception result includes the reception information, the resetter 27b judges that the home electric appliance 1 has received the reset data. If the received reception result includes the non-reception information, the resetter 27b judges that the home electric appliance 1 has not received the reset data.

If the resetter 27b judges that the home electric appliance 1 has not received the reset data (NO in Step S709), the routine returns to Step S706, and the resetter 27b creates a message including the reset data, and sends the message to the home electric appliance 1. If, on the other hand, the resetter 27b judges that the home electric appliance 1 has received the reset data (YES in Step S709), the reset result judger 27c acquires the status of the home electric appliance 1, using the communicator 28. Specifically, the reset result judger 27c creates a device status acquisition request, and the communicator 28 sends, to the home electric appliance 1, the device status acquisition request created by the reset result judger 27c (Step S710). The reset result judger 27c creates the device status acquisition request with respect to each of the setting items of which a setting value is acquirable.

Then, the communicator 13 of the home electric appliance 1 receives the device status acquisition request sent by the control device 2 (Step S726). Then, the communicator 13 reads, from the device status storage 14, the current device status (setting values of the respective setting items) of the home electric appliance 1 (Step S727). In this embodiment, the communicator 13 reads the setting value which is acquirable by the control device 2, and for which the reset process has already been executed. Then, the communicator 13 sends, to the control device 2, the device status read out from the device status storage 14 (Step S728).

Then, the communicator 28 of the control device 2 receives the device status sent from the home electric appliance 1, and outputs the received device status to the reset result judger 27c (Step S711). The status of the home electric appliance 1 may be acquired by receiving a status change notification if the communicator 28 receives the status change notification from the home electric appliance 1. Then, the reset result judger 27c judges the reset result based on the acquired status of the home electric appliance 1 (Step S712). The judgment result in Step S712 determines the process that follows.

If the reset result judger 27c judges that a reset process has not been executed (“NG” in Step S712), the routine returns to Step S706, and the resetter 27b creates a message including the reset data, and sends the message to the home electric appliance 1. If the reset result judger 27c judges that a reset process has been executed (“OK” in Step S712), the reset result judger 27c judges whether the reset process has been completed with respect to all the reset data (Step S713). If the reset result judger 27c judges that the reset process has been completed with respect to all the reset data (YES in Step S713), the routine ends. If, on the other hand, the reset result judger 27c judges that the reset process has not been completed with respect to all the reset data (NO in Step S713), the routine returns to Step S705, and the process is repeated until the reset process is completed with respect to all the reset data.

The reset data may be re-transmitted by limiting the number of times of the re-transmission. In this embodiment, the reset data is created by the reset processor 27. Alternatively, the setting check data creation processor 25 may create the reset data after creation of the device status information. Further alternatively, the reset data may be created each time a reset process is executed, without creating a reset data list in advance. In this embodiment, the reset data is created based on the device status information. Alternatively, a default setting value may be described in advance in the specifications information, and reset data may be created based on the default value. Further alternatively, the home electric appliance 1 may store information relating to a default setting value in advance, and reset data may be created by acquiring the default value from the home electric appliance 1.

In this embodiment, the status change notifications are included in the reset data. Alternatively, the status change notifications may be excluded from the reset data. Further alternatively, the reset process may be omitted, thereby enabling to enhance the efficiency on the setting check because a time required for the setting check is eliminated or shortened.

In this embodiment, an input section may be provided in the control device 2 to edit the setting check flag in checking a setting because execution of the setting check depends on the setting check environment. In this embodiment, the information relating to the setting check flag is described in the combination information. Alternatively, the information relating to the setting check flag may be acquired from the home electric appliance 1, as a part of the information relating to the property map.

Since the integration information and the function information are identical to each other in the format, the setting check data may be created using the acquired function information for a failure diagnosis or the like, the diagnosis result may be displayed on a display device of the control device 2, such as a display, and the display device may be connected to a server provided outside the house for transmission of the diagnosis result to an external device. Further alternatively, function information may be prepared in advance, and the function information may be utilized as a tool for checking the performance of the home electric appliance 1 for automatic check-up.

### Second Embodiment

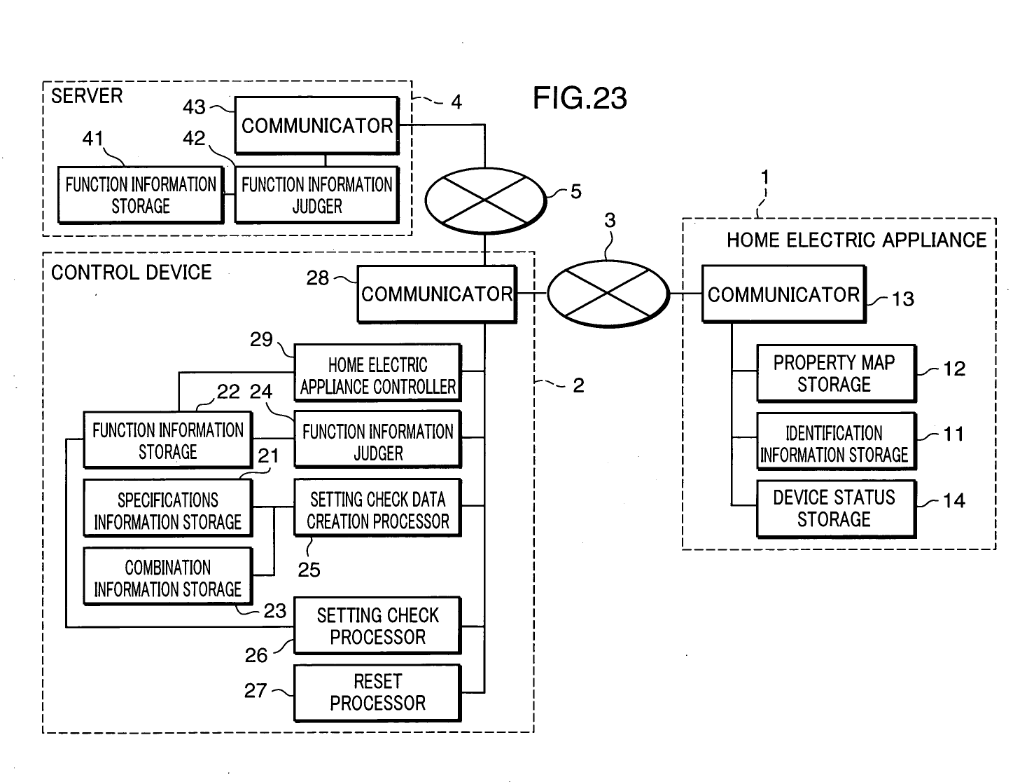

FIG. 23 is a diagram showing a configuration of a home electric appliance control system according to the second embodiment of the invention. Constituent elements in FIG. 23 identical to those in FIG. 1 are denoted at the same reference numerals, and description thereof will be omitted herein. The configuration of the home electric appliance control system in the second embodiment includes a server 4 and a network 5, in addition to the constituent elements of the home electric appliance control system in FIG. 1.

The network 5 is a network provided outside the house, and a control device 2 and the server 4 are communicatively connected to each other via the network 5. The server 4 provides the control device 2 with function information matching with identification information received from the control device 2, based on a request from the control device 2.

The server 4 includes a function information storage 41, a function information judger 42, and a communicator 43. The function information storage 41 stores function information such as setting items, setting values, or the like, which is capable of actually controlling a home electric appliance 1. The function information judger 42 judges whether the function information storage 41 stores the function information of the home electric appliance 1. The communicator 43 communicates data with the control device 2 via the network 5.

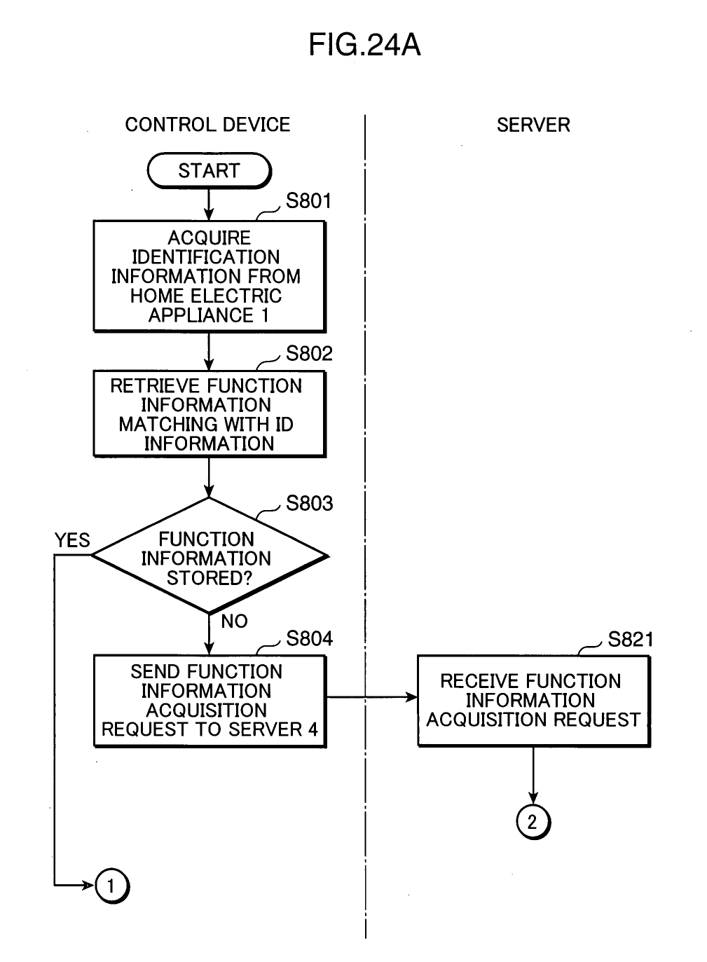

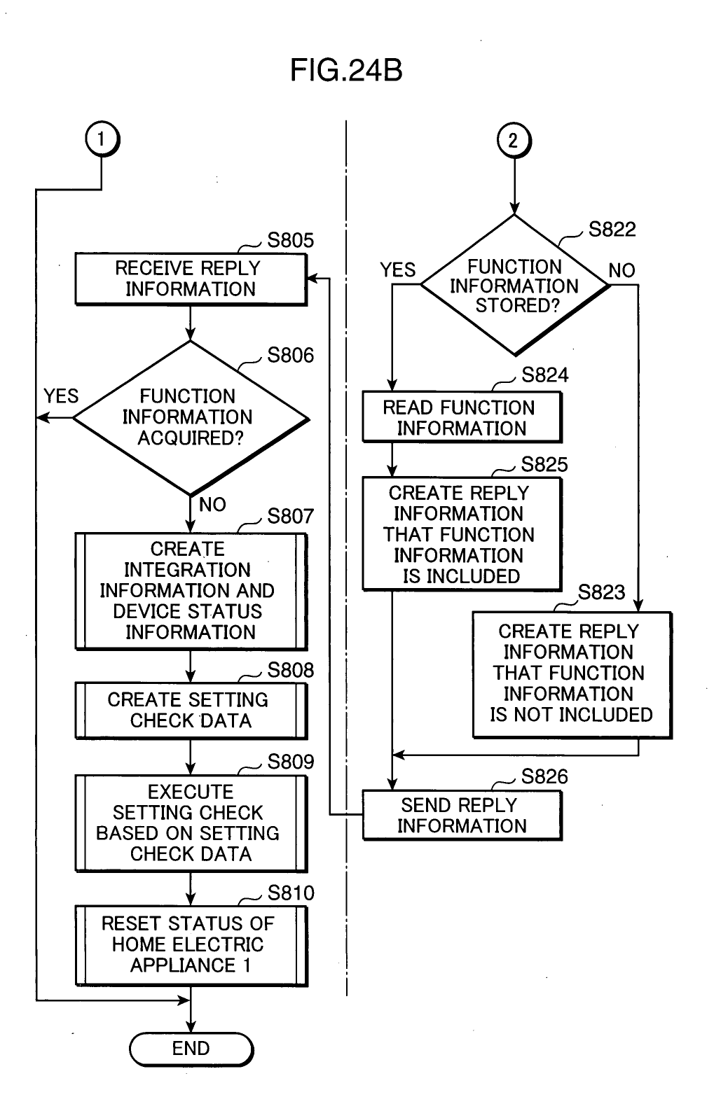

FIGS. 24A and 24B are a flowchart showing an example of an operation to be executed by the control system in the second embodiment of the invention. The following description is made on a premise that the home electric appliance 1 is connected to a network 3 for the first time. Referring to FIGS. 24A and 24B, first, a function information judger 24 acquires identification information stored in the home electric appliance 1, using a communicator 28 (Step S801). The identification information is acquired by similar processes as the processes in Steps S101, S102, and S111 through S113 shown in FIG. 8.

Then, the function information judger 24 judges whether a function information storage 22 stores the function information matching with the acquired identification information (Step S802). The judgment result in Step S802 determines the process that follows. Specifically, the function information judger 24 judges whether the function information storage 22 stores the function information matching with the acquired identification information (Step S803). If the function information judger 24 judges that the function information storage 22 stores the function information matching with the acquired identification information (YES in Step S803), the routine ends.

If, on the other hand, the function information judger 24 judges that the function information storage 22 does not store the function information matching with the acquired identification information (NO in Step S803), the communicator 28 sends, to the server 4, a function information acquisition request including the identification information acquired from the home electric appliance 1, and requests the server 4 of the function information matching with the identification information (Step S804).

Then, the communicator 43 of the server 4 receives the function information acquisition request sent from the control device 2 (Step S821). Then, the function information judger 42 of the server 4 judges whether the function information storage 41 stores the function information matching with the identification information included in the function information acquisition request (Step S822). If the function information judger 42 of the server 4 judges that the function information storage 41 does not store the function information matching with the identification information included in the function information acquisition request (NO in Step S822), the function information judger 42 creates reply information indicating that the function information is not included and that the function information is not stored (Step S823).

If, on the other hand, the function information judger 42 of the server 4 judges that the function information storage 41 stores the function information matching with the identification information included in the function information acquisition request (YES in Step S822), the function information judger 42 reads, from the function information storage 41, the function information matching with the identification information (Step S824). Then, the function information judger 42 creates reply information including the readout function information (Step S825). Then, the communicator 43 sends, to the control device 2, the reply information created in Step S823 or Step S825 (Step S826).

Then, the communicator 28 of the control device 2 receives the reply information sent by the server 4 (Step S805). The reply information in Step S805 determines the process that follows. Specifically, the function information judger 24 judges whether the received reply information includes the function information, and whether the control device 2 has acquired the function information (Step S806). If the function information judger 24 judges that the control device 2 has acquired the function information (YES in Step S806), the function information judger 24 stores the received function information into the function information storage 22, and the routine ends.

If, on the other hand, the function information judger 24 judges that the control device 2 has not acquired the function information (NO in Step S806), a setting check data creation processor 25 creates integration information for creating setting check data to be used in checking a setting of collecting the function information, and device status information for creating reset data to be used in resetting the status of the home electric appliance 1 after the setting check is completed (Step S807). Then, the setting check data creation processor 25 creates setting check data based on the created integration information (Step S808).

After creation of the setting check data, a setting check processor 26 executes a setting check based on the setting check data created by the setting check data creation processor 25, and collects the function information (Step S809). After completion of the setting check, a reset processor 27 creates reset data for executing a reset process, and executes the reset process based on the reset data (Step S810). Since the process of creating the integration information and the device status information, the process of creating the setting check data, the process of executing the setting check, and the process of executing the resetting in the second embodiment are identical to those in the first embodiment, description thereof will be omitted herein.

Specifications information and/or combination information may be stored in the server 4 so that the control device 2 acquires the specifications information and/or the combination information from the server 4.

Further, in the case where plural home electric appliances 1 having the identical models, manufacturers, model numbers, and version information are connected to the server 4, setting check may be executed simultaneously with respect to the home electric appliances 1, using simultaneous transmission. This enables to execute the setting check efficiently because a time required for the setting check is eliminated or shortened.

### Third Embodiment

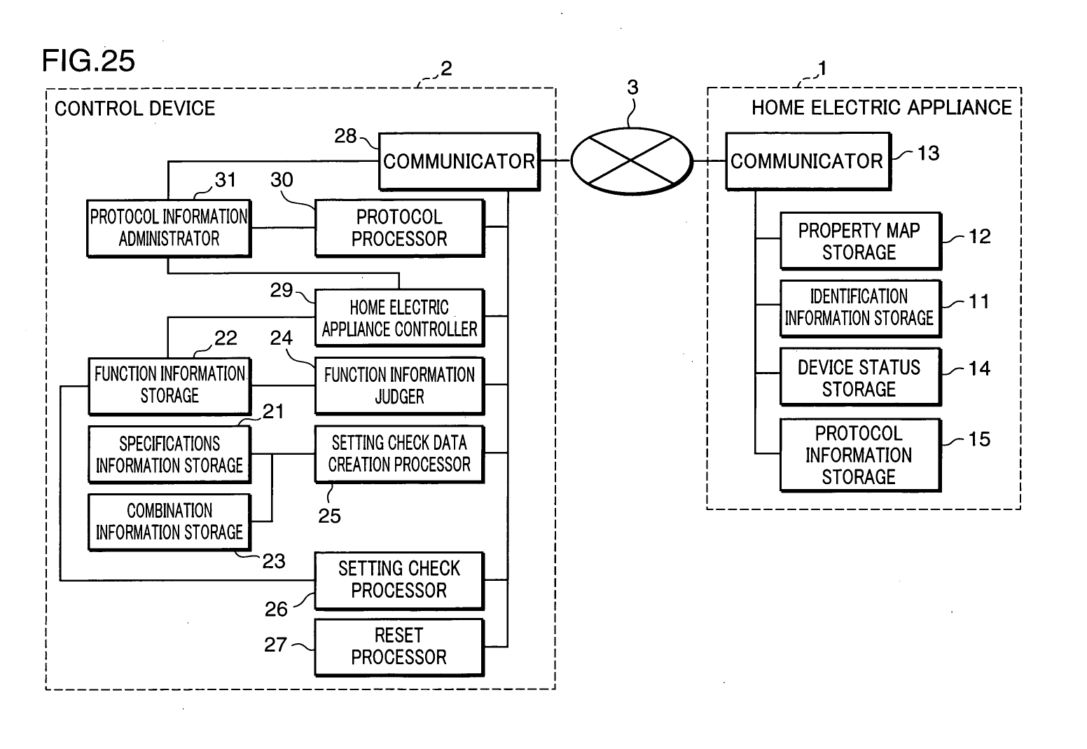

FIG. 25 is a diagram showing a configuration of a home electric appliance control system according to the third embodiment of the invention. Constituent elements in FIG. 25 identical to those in FIG. 1 are denoted at the same reference numerals, and description thereof will be omitted herein. A control device 2 in FIG. 25 further includes a protocol processor 30 and a protocol information administrator 31, in addition to the constituent elements of the home electric appliance control system in FIG. 1.

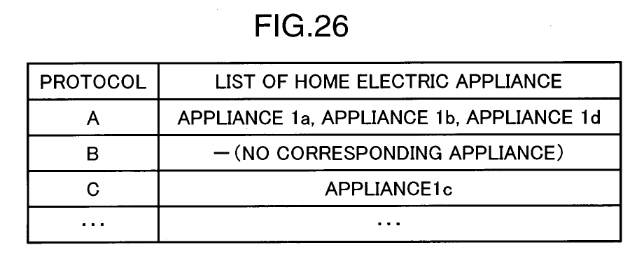

The protocol information administrator 31 stores protocol information to be used in communicating with a home electric appliance 1. The protocol information administrator 31 stores a protocol information administration list for correlating protocols processable by the control device 2 with the home electric appliances corresponding to the protocols. FIG. 26 is a chart showing an example of the protocol information administration list to be stored in the protocol information administrator 31.

The protocol information administration list shown in FIG. 26 records the protocols A, B, C, . . . , processable by the control device 2, and the home electric appliances 1a through 1d corresponding to the protocols A, B, C, . . . , in association with each other. For instance, the protocol A is recorded in association with the home electric appliance a, the home electric appliance 1b, and the home electric appliance 1d. The protocol B is recorded in association with none of the home electric appliances. The protocol C is recorded in association with the home electric appliance 1c.

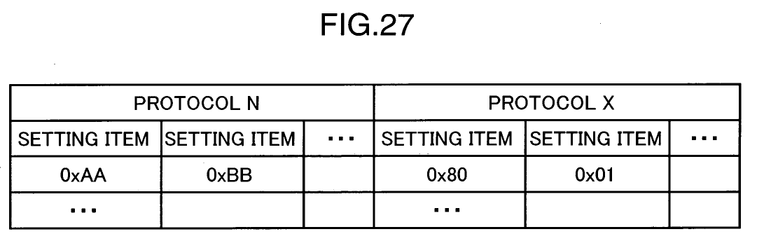

The protocol information administrator 31 also stores protocol conversion rules. FIG. 27 is a chart showing an example of the protocol conversion rules stored in the protocol information administrator 31. The protocol conversion rules include setting items and setting values. The protocol information administrator 31 stores the protocol conversion rule with respect to each of the protocols. For instance, as shown in FIG. 27, the protocol N is recorded in association with the setting item 0xAA and the setting value 0xBB, and the protocol X is recorded in association with the setting item 0x80 and the setting value 0x01.

The protocol processor 30 converts setting check data created by a setting check data creation processor 25 in accordance with the protocol information stored in the protocol information administrator 31. Specifically, the protocol processor 30 specifies a protocol of a home electric appliance to which the setting check data is to be sent, by referring to the protocol information administration list stored in the protocol information administrator 31. Then, the protocol processor 30 converts the setting check data into the protocol of the home electric appliance to which the setting check data is sent, based on the protocol conversion rule stored in the protocol information administrator 31.

The home electric appliance 1 further includes a protocol information storage 15. The protocol information storage 15 stores the kinds of protocols with which the home electric appliance 1 communicates, as the protocol information. The protocol information administrator 31 corresponds to an example of a protocol information storing means, and the protocol processor 30 corresponds to an example of a protocol converting means.

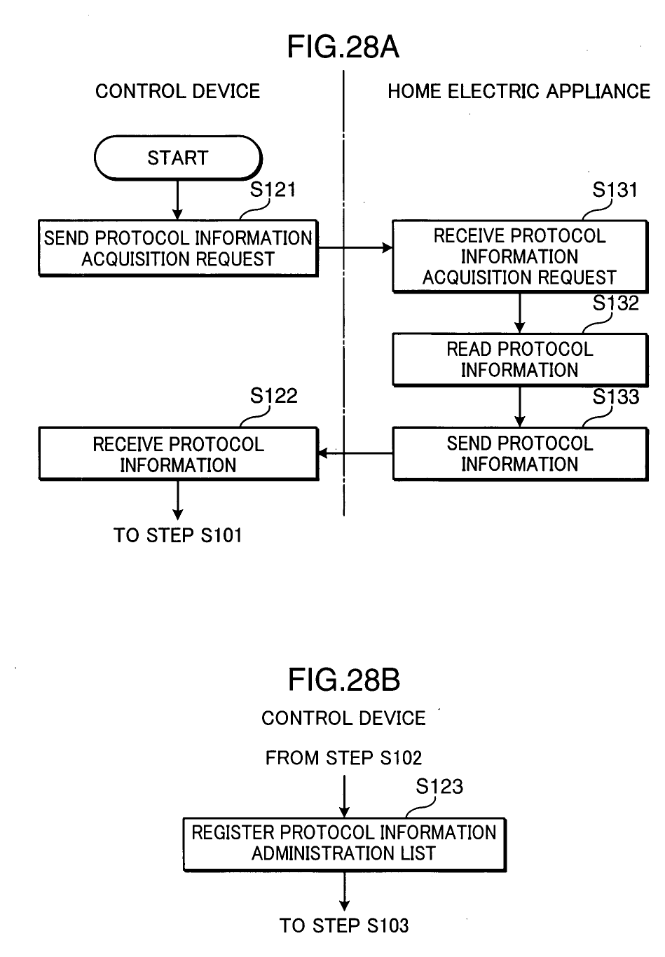

FIGS. 28A and 28B are flowcharts for describing a process of acquiring protocol information of a home electric appliance. The process shown in FIG. 28A is a process to be executed before Step S101 in FIG. 8.

First, a communicator 28 of the control device 2 sends, to the home electric appliance 1, a protocol information acquisition request to acquire protocol information of the home electric appliance 1 (Step S121). Then, a communicator 13 of the home electric appliance 1 receives the protocol information acquisition request sent by the control device 2 (Step S131). Then, the communicator 13 reads the protocol information of the home electric appliance 1 from the protocol information storage 15 (Step S132). Then, the communicator 13 sends the protocol information read out from the protocol information storage 15 to the control device 2 (Step S133).

Then, the communicator 28 of the control device 2 receives the protocol information sent by the home electric appliance 1, and outputs the received protocol information to the protocol information administrator 31 (Step S122).

Then, the routine proceeds to the process of Step S101 in FIG. 8, and the processes until Step S102 are executed. Then, a process of registering the relevant information in the protocol information administration list is described. The process shown in FIG. 28B is a process to be executed after Step S102 in FIG. 8. The protocol information administrator 31 stores the protocol information, and the identification information acquired in Step S102 in association with the protocols which are stored in advance in the protocol information administration list (Step S123).

For instance, the protocol information acquisition request may be simultaneously sent to all the home electric appliances (1 through N) connected to the network 3 every predetermined time interval (e.g. every one hour). The home electric appliances 2 through N memorize in their internal memories that their protocol information have already been registered in the control device 2. Accordingly, even if the home electric appliances 2 through N have received the protocol information acquisition request sent by the simultaneous transmission, the home electric appliances 2 through N do not send their protocol information, because their protocol information have already been registered in the control device 2. At this stage, the home electric appliances 2 through N may send reply information indicating that their protocol information have already been registered in the control device 2. Accordingly, the home electric appliance 1, which does not memorize in its internal memory that its protocol information has been registered in the control device 2, and which is newly connected to the network 3, is exclusively operative to send the protocol information to the control device 2.

Then, the routine proceeds to the process of Step S103 in FIG. 8, and the processes until Step S106 are executed. In the protocol information acquisition, the protocol information may be acquired by rendering the control device 2 in a protocol information receiving standby condition, and by causing the newly connected home electric appliance 1 to send its protocol information to the control device 2. Also, the identification information may be sent simultaneously with transmission of the protocol information from the home electric appliance 1 to the control device 2, so that the process (Steps S101 and S102 in FIG. 8) of acquiring the identification information may be omitted.

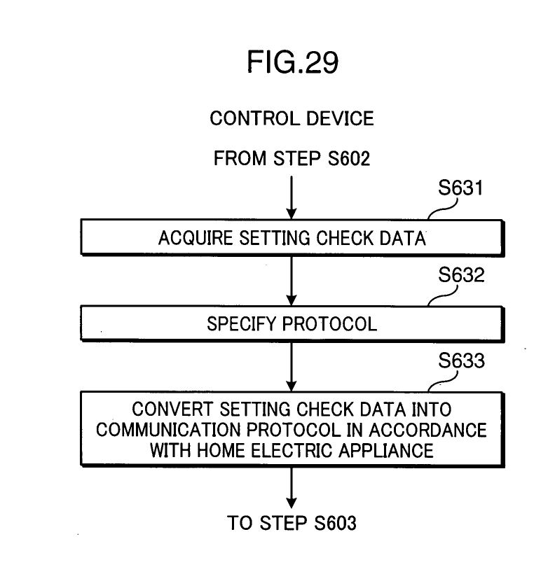

Now, a setting check execution process in the third embodiment is described. FIG. 29 is a flowchart for describing the setting check execution process to be executed in the third embodiment. The process shown in FIG. 29 is a process to be executed after Step S602 in FIG. 19.

First, a setting checker 26a outputs a message including setting check data to the protocol processor 30. Then, the protocol processor 30 acquires the message outputted by the setting checker 26a (Step S631). Then, the protocol processor 30 specifies a protocol of the home electric appliance to which the setting check data (message) is to be sent, by referring to the protocol information administration list stored in the protocol information administrator 31 (Step S632).

Then, the protocol processor 30 converts the setting check data (message) into the protocol in accordance with the home electric appliance, based on the protocol conversion rule stored in the protocol information administrator 31 (Step S633). Then, the protocol processor 30 outputs the setting check data (message) after the protocol conversion to the communicator 28. Then, the routine proceeds to the process of Step S603 in FIG. 19, and the processes thereafter are executed.

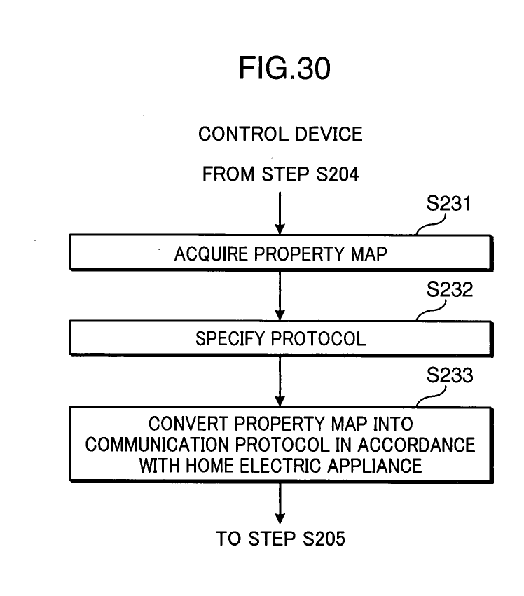

Although the control device 2 acquires a property map from the home electric appliance 1, protocol conversion is required to comprehend the contents of the property map. FIG. 30 is a flowchart for describing a process of creating integration information and device status information to be executed in the third embodiment. The process shown in FIG. 30 is a process to be executed after Step S204 in FIG. 13.

First, the communicator 28 of the control device 2 receives the property map sent by the home electric appliance 1, and outputs the received property map to the protocol processor 30. Then, the protocol processor 30 acquires the property map outputted by the communicator 28 (Step S231). Then, the protocol processor 30 specifies the protocol of the home electric appliance from which the property map has been sent, by referring to the protocol information administration list stored in the protocol information administrator 31 (Step S232).

Then, the protocol processor 30 converts the property map into the protocol in accordance with the control device 2, based on the protocol conversion rule stored in the protocol information administrator 31 (Step S233). Then, the protocol processor 30 outputs the property map after the protocol conversion to an information acquirer 25a. Then, the routine proceeds to the process of Step S205 in FIG. 13, and the processes thereafter are executed.

As mentioned above, the protocol information administrator 31 stores the protocol information for communicating with the home electric appliance 1, and the setting check data created by the setting check data creation processor 25 is converted in accordance with the protocol information stored in the protocol information administrator 31. In this arrangement, even if the communication protocols of the home electric appliances 1 are different from each other, the setting check data can be securely transmitted.

### Fourth Embodiment

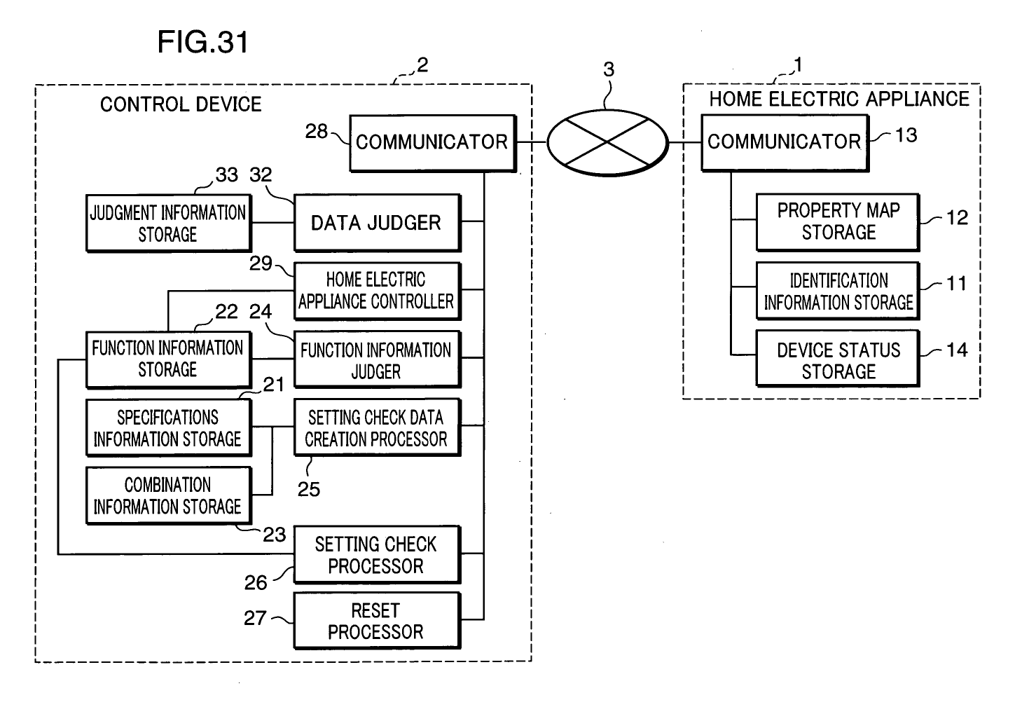

In this section, the fourth embodiment of the invention is described. FIG. 31 is a diagram showing a configuration of a home electric appliance control system according to the fourth embodiment of the invention. Constituent elements in FIG. 31 identical to those in FIG. 1 are denoted at the same reference numerals, and description thereof will be omitted herein. A control device 2 in FIG. 31 further includes a data judger 32 and a judgment information storage 33, in addition to the constituent elements of the home electric appliance control system in FIG. 1.

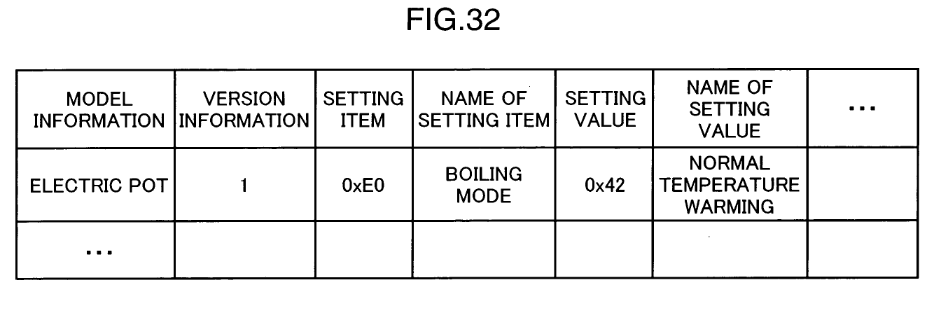

The judgment information storage 33 stores in advance judgment criteria data as to whether a setting item is manipulatable via a network in association with a home electric appliance. FIG. 32 is a chart showing an example of the judgment criteria data to be stored in the judgment information storage 33. As shown in FIG. 32, in the case of an electric pot, for instance, it is dangerous to boil water in a condition that there is no person near the electric pot. Accordingly, setting the electric pot to boiling mode via the network is prohibited. In view of this, the judgment information storage 33 stores the setting item whose manipulation via the network is disabled.

In this embodiment, the judgment information storage 33 stores in advance the judgment criteria data as to whether the setting item is manipulatable via the network in association with the home electric appliance. The invention is not specifically limited to the above. Information as to whether manipulation via the network is enabled may be added to the property map, and judgment criteria data may be created based on the property map received from the home electric appliance. In the modification, a setting item whose manipulation via the network is disabled is extracted from the property map, and the judgment criteria data is created based on the extracted property map.

The data judger 32 judges whether setting check data created by a setting check data creation processor 25 is transmittable data, by referring to the judgment criteria data stored in the judgment information storage 33. The data judger 32 corresponds to an example of a transmission judging means.

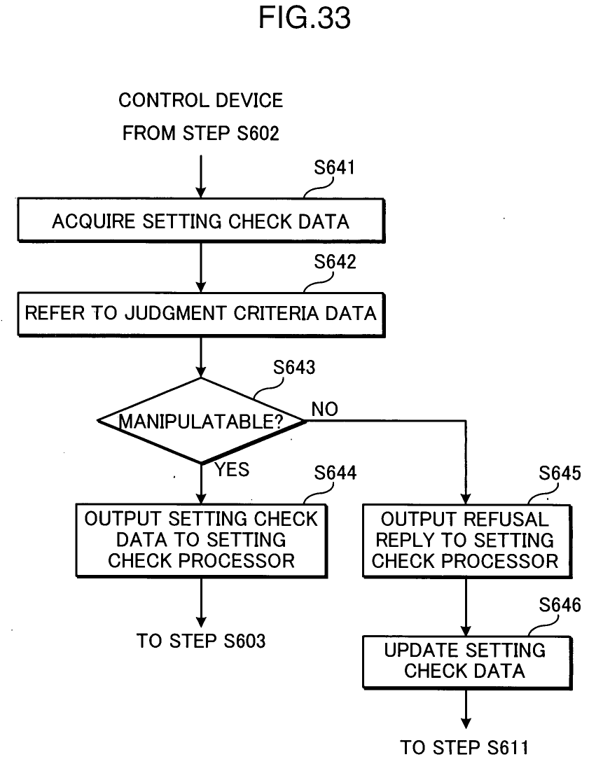

FIG. 33 is a flowchart for describing a setting check execution process to be executed in the fourth embodiment. The process shown in FIG. 33 is a process to be executed after Step S602 in FIG. 19.

A setting checker 26a outputs a message including setting check data to the data judger 32. In response to the output, the data judger 32 acquires the message outputted by the setting checker 26a (Step S641). Then, the data judger 32 refers to the judgment criteria data stored in the judgment information storage 33 (Step S642).

Then, the data judger 32 judges whether the setting item included in the setting check data is manipulatable via the network (Step S643). If it is judged that the setting item included in the setting check data is manipulatable via the network (YES in Step S643), the data judger 32 outputs the setting check data (message) to a communicator 28 (Step S644). Then, the routine proceeds to the process of Step S603 in FIG. 19, and the processes thereafter are executed.

If, on the other hand, it is judged that the setting item included in the setting check data is not manipulatable via the network (NO in Step S643), the data judger 32 outputs, to a setting check processor 26, a refusal reply indicating that manipulation via the network is disabled (Step S645).

Then, the setting check processor 26 updates the setting check data so that the setting check data whose manipulation has been judged to be disabled is not executed (Step S646). Specifically, the setting check processor 26 erases, from a setting check data list, the setting check data having the setting check number of the setting check data whose manipulation via the network has been judged to be disabled by the data judger 32, as a source setting check number, by referring to the setting check number of the setting check data. Then, the routine proceeds to the process of Step S611 in FIG. 19, and the processes thereafter are executed.

As mentioned above, the data judger 32 judges whether the setting check data created by the setting check data creation processor 25 is to be sent to the home electric appliance 1. If the data judger 32 judges that the setting check data is not to be sent to the home electric appliance 1, the setting check data creation processor 25 erases the setting check data having a dependency with the setting check data. Thus, if transmission of the targeted setting data is disabled, and setting check of the home electric appliance 1 is disabled, the setting check data having a dependency with the targeted setting check data is erased. This enables to prevent executing an unwanted check on setting, and to execute the setting check efficiently.

In this embodiment, the control device 2 judges whether setting check data is to be sent. The invention is not specifically limited to the above. A judgment as to whether the setting check data is to be executed may be made when the home electric device 1 has received the setting check data.

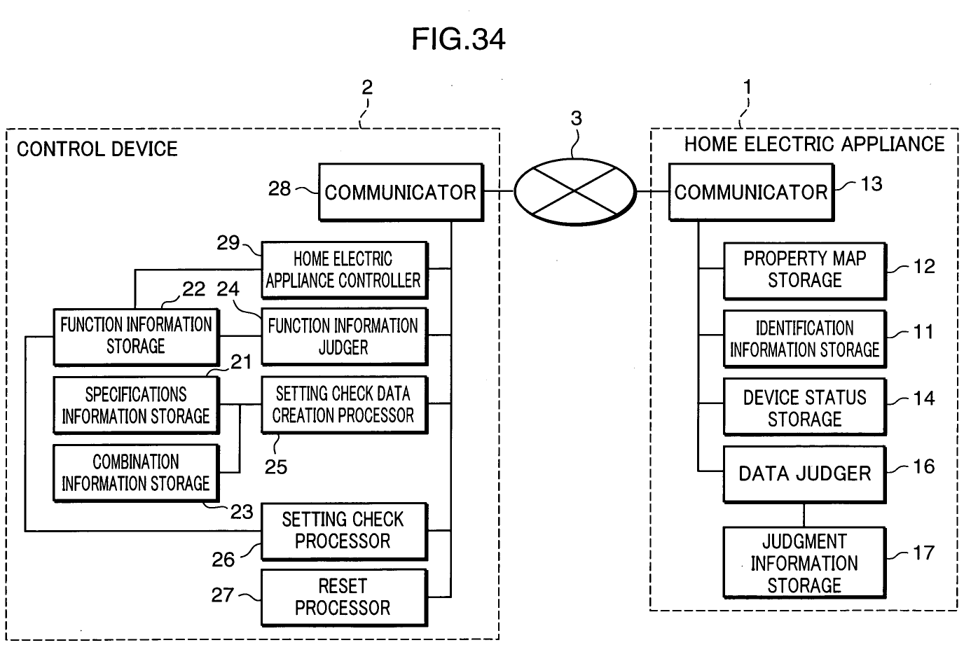

FIG. 34 is a diagram showing a configuration of a home electric appliance control system according to a modification of the fourth embodiment. Constituent elements in FIG. 34 identical to those in FIG. 1 are denoted at the same reference numerals, and description thereof will be omitted herein. A home electric appliance 1 in FIG. 34 further includes a data judger 16 and a judgment information storage 17, in addition to the constituent elements of the home electric appliance control system in FIG. 1.

The judgment information storage 17 stores in advance judgment criteria data as to whether a setting item is manipulatable via the network in association with the home electric appliance. The judgment criteria data to be stored in the judgment information storage 17 is identical to the judgment criteria data shown in FIG. 32. The data judger 16 judges whether the setting check data received by a communicator 13 is executable data, by referring to the judgment criteria data stored in the judgment information storage 17.

In this embodiment, the judgment information storage 17 stores in advance the judgment criteria data as to whether the setting item is manipulatable via the network in association with the setting item. The invention is not specifically limited to the above. Information as to whether the setting item is manipulatable via the network may be added to the property map. In the modification, the data judger 16 judges whether the setting check data received by the communicator 13 is executable data, by referring to the property map stored in a property map storage 12. In this case, the judgment information storage 17 is not necessary.

The data judger 16 and the judgment information storage 17 correspond to an example of an execution judging means. The communicator 13 corresponds to an example of a transmitting means, and the communicator 28 corresponds to a receiving means.

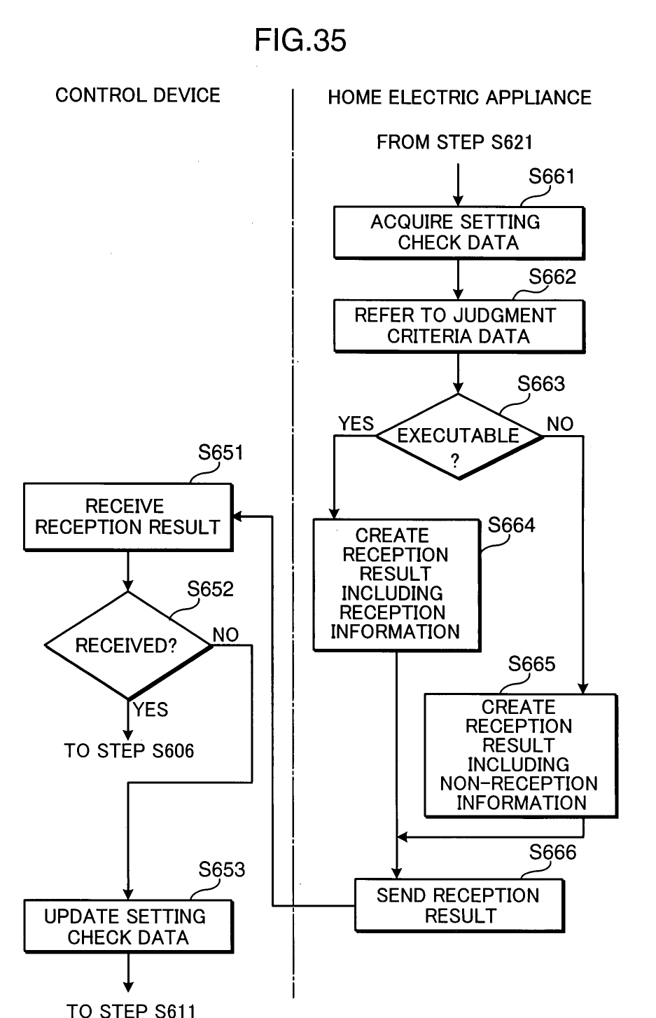

FIG. 35 is a flowchart for describing a setting check execution process to be executed in a modification of the fourth embodiment. The process shown in FIG. 35 is a process to be executed after Step S621 in FIG. 19.

The communicator 13 outputs setting check data included in a message to the data judger 16. Then, the data judger 16 acquires the setting check data outputted by the communicator 13 (Step S661). Then, the data judger 16 refers to the judgment criteria data stored in the judgment information storage 17 (Step S662).

Then, the data judger 16 judges whether the setting item included in the setting check data is executable (Step S663). If the setting item included in the setting check data is judged to be executable (YES in Step S663), the communicator 13 creates a reception result including reception information indicating that the setting check data is received (Step S664). If, on the other hand, the setting item included in the setting check data is judged to be not executable (NO in Step S663), the communicator 13 creates a reception result including non-reception information indicating that the setting check data is not received (Step S665).

Then, the communicator 13 sends, to the control device 2, the reception result created in Step S664 or Step S665 (Step S666). If it is judged that the setting check data is executable, the home electric appliance 1 is operative to execute a setting check based on the setting check data, and a device status of the home electric appliance 1 in accordance with the setting check is stored in a device status storage 14.

Then, the communicator 28 of the control device 2 receives, from the home electric appliance 1, a reception result as to whether the home electric appliance 1 can execute the setting check data (Step S651). The setting checker 26a judges whether the home electric appliance 1 has received the setting check data (Step S652). If the received reception result includes the reception information, the setting checker 26a judges that the setting check data has been received. If the received reception result includes the non-reception information, the setting checker 26a judges that the setting check data has not been received.

If the setting checker 26a judges that the setting check data has not been received (NO in Step S652), the setting checker 26a updates the setting check data list (Step S653). Specifically, the setting checker 26a erases, from the setting check data list, the setting check data having the setting check number of the setting check data sent to the home electric appliance 1, as a source setting check number. If, on the other hand, the setting checker 26a judges that the setting check data has been received (YES in Step S652), the routine proceeds to the process of Step S606 in FIG. 19, and the processes thereafter are executed.

As mentioned above, the data judger 16 of the home electric appliance 1 judges whether the setting check data created by the setting check data creation processor 25 is to be executed. If the data judger 16 judges that the setting check data is not to be executed, the communicator 13 sends, to the control device 2, the reply information indicating that the setting check data is not executed. The communicator 28 of the control device 2 receives the reply information sent by the home electric appliance 1. If the reply information has been received by the communicator 28, the setting check data creation processor 25 erases the setting check data having a dependency with the setting check data sent to the home electric appliance 1.

Thus, if execution of targeted setting check data is disabled, and, setting check of the home electric appliance 1 is disabled, the setting check data having a dependency with the targeted setting check data is erased. This enables to prevent executing an unwanted check on setting, and to execute the setting check efficiently.

In this embodiment, the judgment information storage 33 stores in advance the judgment criteria data as to whether the setting item is manipulatable via the network in association with the home electric appliance. The invention is not specifically limited to the above. The home electric appliances may be categorized into a predetermined number of groups according to the kinds thereof, and setting items whose manipulation via the network is disabled may be stored in advance with respect to each of the groups.

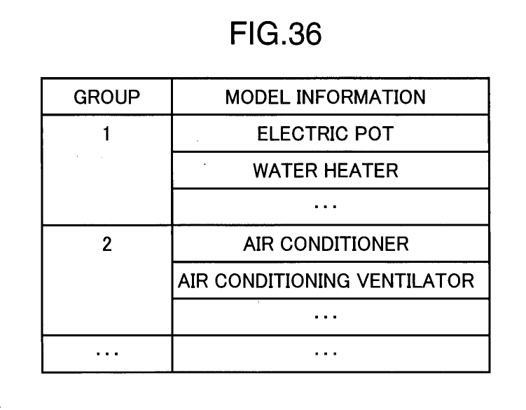

In the modification, the judgment information storage 33 stores a group list, in which the names of the groups, and the home electric devices categorized according to the groups are recorded in association with each other. FIG. 36 is a chart showing an example of the group list to be stored in the judgment information storage 33. As shown in FIG. 36, an electric pot and a water heater are categorized into the group 1, and an air-conditioner and an air-conditioning ventilator are categorized into the group 2.

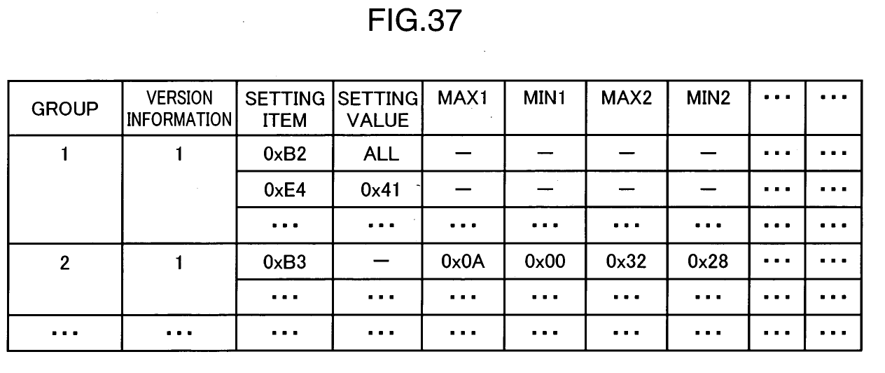

The judgment information storage 33 stores in advance setting items whose manipulation via the network is disabled with respect to each of the groups. FIG. 37 is a chart showing an example of the judgment criteria data to be stored in the judgment information storage 33. As shown in FIG. 37, for instance, the group 1 is associated with the setting item 0xB2 and the setting item 0xE4, and the group 2 is associated with the setting item 0xB3.

The data judger 32 specifies the group of the home electric appliance to which the setting check data is to be sent, by referring to the group list stored in the judgment information storage 33. Then, the data judger 32 judges whether the setting item included in the setting check data is manipulatable via the network, by referring to the judgment criteria data stored in the judgment information storage 33.

The data judger 32 may judge that manipulation of setting check data is disabled if the setting item is a specific setting value. For instance, if the setting item is a setting value concerning heating, the data judger 32 judges that manipulation of the setting check data is disabled. Also, if the setting value of the setting item has a specific range, the data judger 32 may judge that manipulation of the setting check data is disabled. For instance, if the setting value concerning the temperature setting of an air conditioner is 10 degrees C. or lower, or 40 degrees C. or higher, the data judger 32 judges that manipulation of the setting check data is disabled.

The judgment information storage 33 corresponds to an example of a judgment criteria storing means, and the data judger 32 corresponds to an example of a transmission judging means.

As mentioned above, the judgment information storage 33 categories in advance the plural home electric appliances 1 into a predetermined number of groups according to the kinds thereof, and setting items whose manipulation via the network is disabled are stored in advance as the judgment criteria data with respect to each of the groups. Then, the data judger 32 judges whether the setting check data created by the setting check data creation processor 25 is to be sent to the home electric appliance 1, by referring to the judgment criteria data stored in the judgment information storage 33.

In this arrangement, the plural home electric appliances 1 are categorized into the predetermined number of groups in advance according to the kinds thereof, and the setting items whose manipulation via the network is disabled are stored as the judgment criteria data with respect to each of the groups. This enables to eliminate the need of storing all the setting items whose manipulation via the network is disabled, and to reduce the storage capacity by categorizing the home electric appliances 1 having setting items similar to each other into one group.

Also, it is possible to store in advance the installation sites of the home electric appliances, and the installation sites of the control device. In the case where the installation site of the home electric appliance to which the setting check data is to be sent, and the installation site of the control device are identical to each other, the setting check data is sent to the home electric appliance. In the case where the installation site of the home electric appliance to which the setting check data is to be sent, and the installation site of the control device are different from each other, a judgment is made as to whether the setting item included in the setting check data is manipulatable via the network.

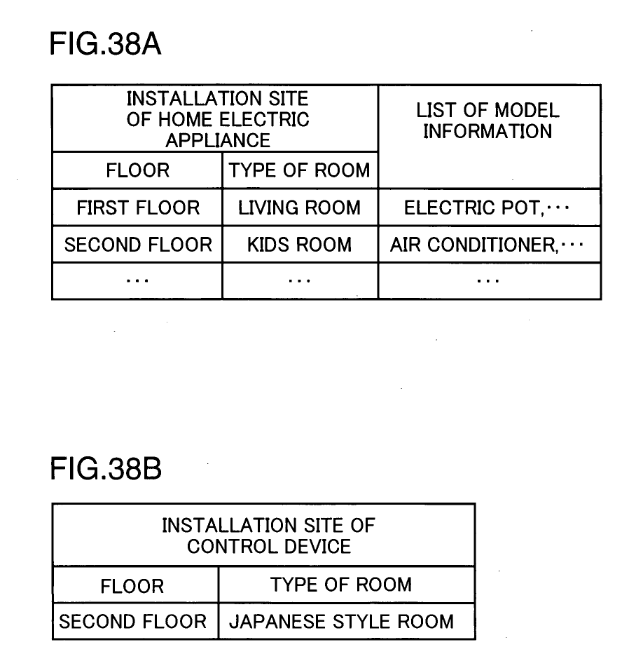

In the above arrangement, the judgment information storage 33 stores in advance installation site data representing the installation sites of the home electric appliances, and the installation sites of the control device. FIGS. 38A and 38B are charts showing examples of the installation site data to be stored in the judgment information storage 33. FIG. 38A is a chart showing installation sites of the home electric appliances, and FIG. 38B is a chart showing an installation site of the control device. As shown in FIG. 38A, an electric pot is installed e.g. in a living room on the first floor, and an air-conditioner is installed in a kids room on the second floor. As shown in FIG. 38B, the control device is installed e.g. in a Japanese-style room on the second floor.

The judgment information storage 33 stores in advance judgment criteria data as to whether a setting item is manipulatable via the network in association with the home electric appliance.

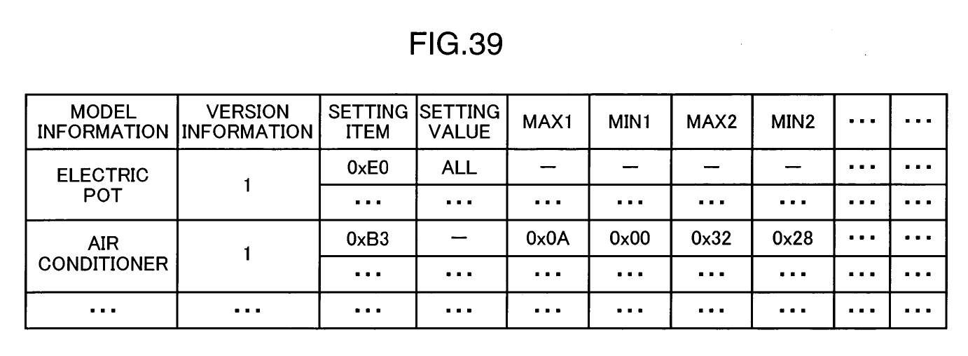

FIG. 39 is a chart showing an example of the judgment criteria data to be stored in the judgment information storage 33. As shown in FIG. 39, the electric pot is associated with the setting item 0xE0, and the air-conditioner is associated with the setting item 0xB3.

The data judger 32 judges whether the installation site of the home electric appliance to which the setting check data is to be sent, and the installation site of the control device are identical to each other, by referring to the installation site data stored in the judgment information storage 33. If it is judged that the installation site of the home electric appliance and the installation site of the control device are identical to each other, the data judger 32 outputs the setting check data to the communicator 28. If, on the other hand, it is judged that the installation site of the home electric appliance and the installation site of the control device are different from each other, the data judger 32 judges whether the setting check data is transmittable data, by referring to the judgment criteria data stored in the judgment information storage 33. The data judger 32 corresponds to an example of an installation site judging means and a transmission judging means.

As mentioned above, the data judger 32 judges whether the installation site of the home electric appliance 1 to which the setting check data created by the setting check data creation processor 25 is to be sent, and the installation site of the control device 2 are identical to each other. If it is judged that the installation site of the home electric appliance 1, and the installation site of the control device 2 are different from each other, the data judger 32 judges whether the setting check data is to be sent to the home electric appliance 1.

Thus, in the case where the installation site of the home electric appliance 1 to which the setting check data is to be sent, and the installation site of the control device 2 are different from each other, a judgment is made as to whether the setting check data is to be sent to the home electric appliance 1. This enables to judge whether the setting check data is to be sent to the home electric appliance 1 in accordance with the installation site of the home electric appliance 1.

Alternatively, if a home electric appliance controller 29 controls the home electric appliance 1, the home electric appliance controller 29 may judge whether the home electric appliance 1 is to be controlled, by referring to the installation site data stored in the judgment information storage 33. For instance, in the case where the control device installed on the second floor controls the electric pot installed on the first floor, the home electric appliance controller 29 outputs control information to the data judger 32. Then, the data judger 32 judges whether the installation of the home electric appliance 1 is identical to the installation site of the control device 2, by referring to the installation site data stored in the judgment information storage 33.

If it is judged that the installation site of the home electric appliance 1 is identical to that of the control device 2, the data judger 32 outputs the control information to the communicator 28. If it is judged that the installation site of the home electric appliance 1 is different from that of the control device 2, the data judger 32 judges whether the control information is transmittable data, by referring to the judgment criteria data which has been predefined with respect to each of the home electric appliances. At this time, if the control information is judged to be non-transmittable data, the data judger 32 sends a refusal reply indicating data transmission is disabled to the home electric appliance controller 29. If the control information is judged to be transmittable data, the data judger 32 outputs the control information to the communicator 28.

Also, in the case where the home electric appliance is controlled by a remotely-installed control device, a judgment may be made as to whether the home electric appliance 1 is to be controlled, by referring to the judgment criteria data stored in the judgment information storage 33. In this modification, the judgment information storage 33 stores installation site data, in which addresses for identifying the control devices, and the installation sites of the control devices are recorded in association with each other. Also, the judgment information storage 33 stores in advance judgment criteria data as to whether the setting item is manipulatable via the network in association with the home electric appliance.

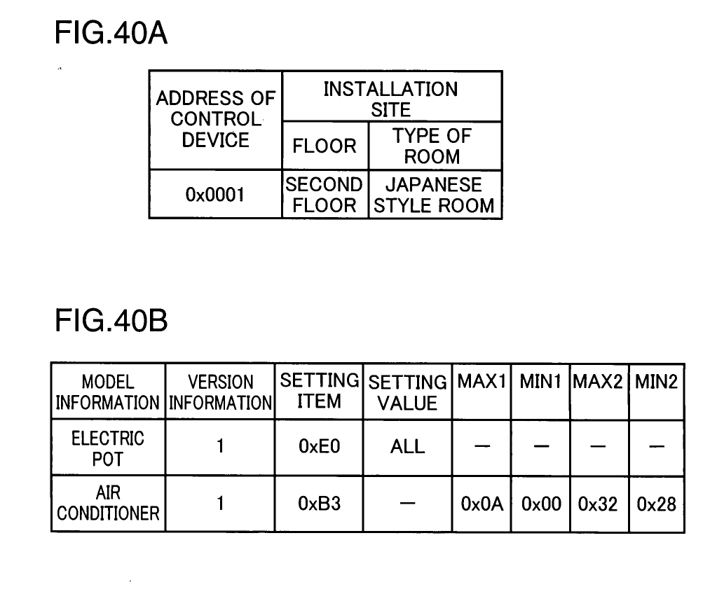

FIGS. 40A and 40B are charts showing examples of the installation site data and the judgment criteria data to be stored in the judgment information storage 33. FIG. 40A is a chart showing an example of the installation site data, and FIG. 40B is a chart showing an example of the judgment criteria data. As shown in FIG. 40A, the judgment information storage 33 stores the address (0x0001) of the control device, and the installation site (Japanese-style room on the second floor) in association with each other. As shown in FIG. 40B, for instance, the electric pot is associated with the setting item 0xE0, and the air-conditioner is associated with the setting item 0xB3.

For instance, in the case where the home electric appliance 1 is controlled by another control device connected to the network 3 via the control device 2, the communicator 28 of the control device 2 receives control information sent by the other control device. Then, the communicator 28 outputs the control information to the data judger 32. The control information includes an address of the other control device. The data judger 32 judges whether the address of the control device 2 included in the installation site data is identical to the address of the other control device included in the control information.

In the above arrangement, if the address of the control device 2 included in the installation site data is judged to be identical to the address of the other control device included in the control information, the data judger 32 outputs the control information to the communicator 28. If the address of the control device 2 included in the installation site data is judged to be different from the address of the other control device included in the control information, the data judger 32 judges whether the control information is transmittable data, by referring to the judgment criteria data which has been predefined with respect to each of the home electric appliances. At this time, if the control information is judged to be non-transmittable data, the data judger 32 sends, to the other control device, a refusal reply indicating that data transmission is disabled via the communicator 28. If the control information is judged to be transmittable data, the data judger 32 outputs the control information to the communicator 28. In this way, in the case where the home electric appliance is to be controlled by the remotely-installed other control device, manipulation which may cause a hazardous condition can be disabled.

In the fourth embodiment, a setting check flag which is stored as the combination information may be eliminated. Further, the process of Step S409 in FIG. 15 may be a judgment as to whether the setting item is a source setting item.

### Fifth Embodiment

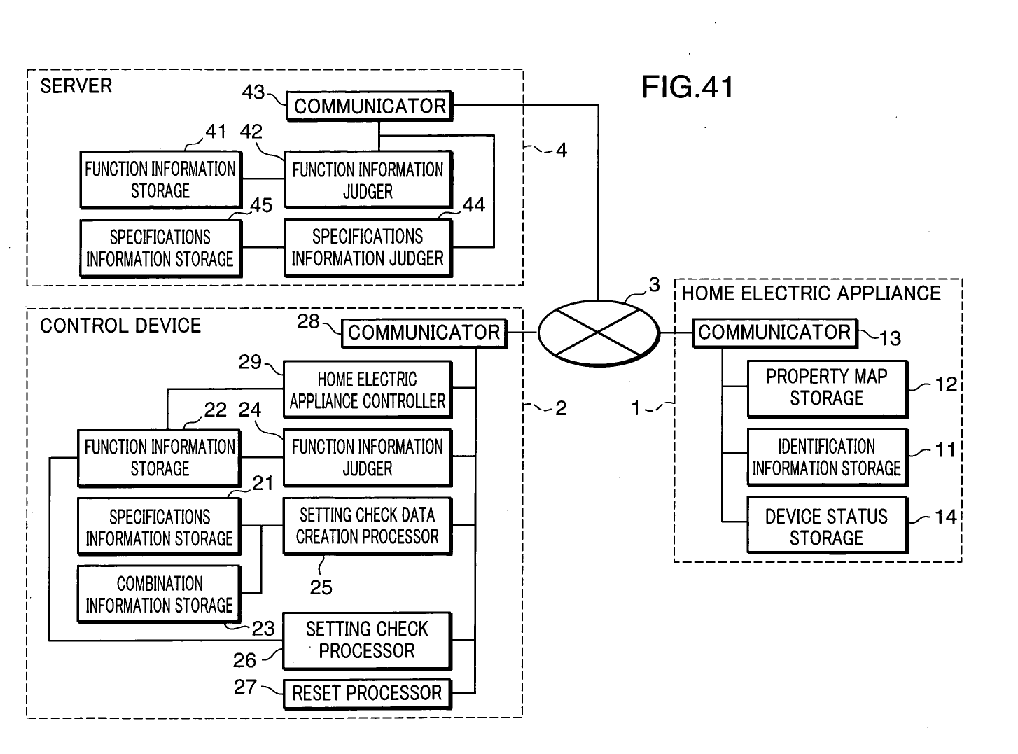

In this section, the fifth embodiment of the invention is described. FIG. 41 is a diagram showing a configuration of a home electric appliance control system according to the fifth embodiment of the invention. Constituent elements in FIG. 41 identical to those in FIGS. 1 and 23 are denoted at the same reference numerals, and description thereof will be omitted herein. A server 4 in FIG. 41 further includes a specifications information judger 44 and a specifications information storage 45, in addition to the constituent elements of the home electric appliance control system in FIGS. 1 and 23.

A setting check data creation processor 25 creates a specifications information acquisition request, and outputs the request to a communicator 28 in the case where specifications information corresponding to version information matching with version information included in identification information acquired from a home electric appliance 1 is not stored in a specifications information storage 21. The specifications information acquisition request includes the version information in the specifications information of the home electric appliance 1. The communicator 28 sends the specifications information acquisition request to the server 4.

In response to the transmission of the specifications information acquisition request, a communicator 43 of the server 4 receives the specifications information acquisition request sent by a control device 2. The specifications information storage 45 stores specifications information. The specifications information judger 44 judges whether the specifications information corresponding to the version information matching with the version information included in the specifications information acquisition request sent by the control device 2 is stored in the specifications information storage 45. If it is judged that the specifications information whose version information matches with the version information included in the specifications information acquisition request is stored in the specifications information storage 45, the specifications information judger 44 reads the specifications information from the specifications information storage 45, and outputs the specifications information to the communicator 28. Then, the communicator 28 sends the specifications information to the control device 2. If, on the other hand, it is judged that the specifications information whose version information matches with the version information included in the specifications information acquisition request is not stored in the specifications information storage 45, the specifications information judger 44 creates reply information indicating no storage of the specifications information, and outputs the reply information to the communicator 28. Then, the communicator 28 sends the reply information to the control device 2.

The setting check data creation processor 25 corresponds to an example of a specifications information judging means and a specifications information acquiring means.

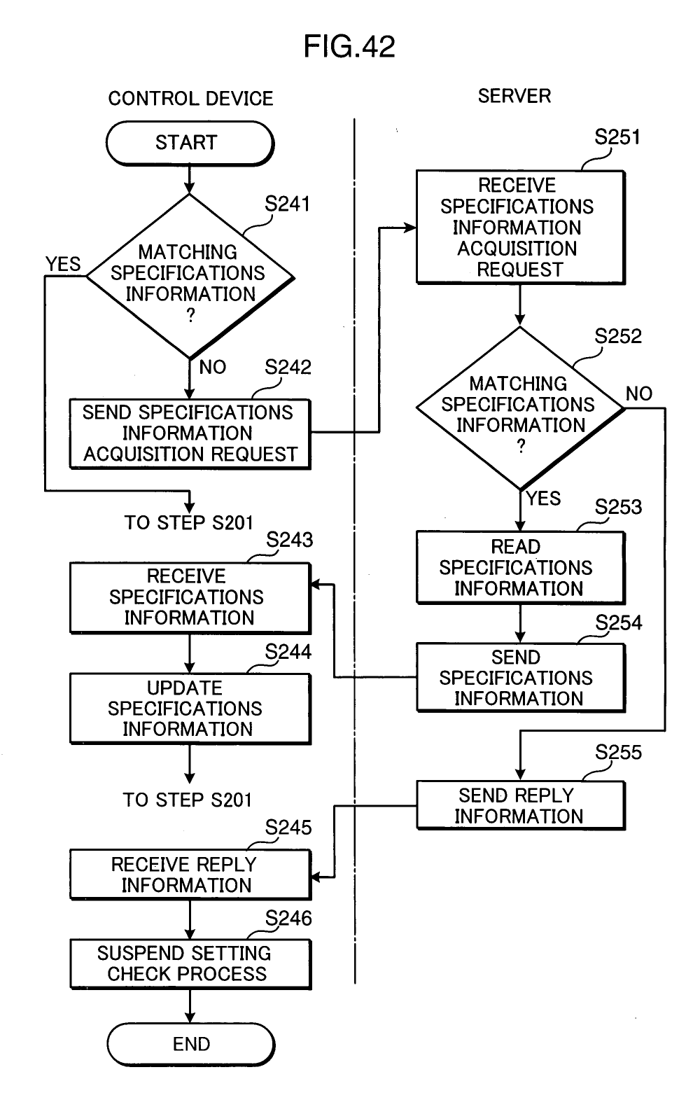

FIG. 42 is a flowchart for describing a process of creating integration information and device status information to be executed in the fifth embodiment. The process shown in FIG. 42 is a process to be executed before Step S201 of FIG. 13.

First, an information acquirer 25a judges whether the specifications information storage 21 stores the specifications information corresponding to the version information matching with the version information included in the identification information stored in the internal memory of the home electric appliance (Step S241). If the information acquirer 25a judges that the specifications information whose version information matches with the version information included in the identification information is stored in the specifications information storage 21 (YES in Step S241), the routine proceeds to the process of Step S201, and the information acquirer 25a acquires the specifications information.

If, on the other hand, the information acquirer 25a judges that the specifications information whose version information matches with the version information included in the identification information is not stored in the specifications information storage 21 (NO in Step S241), the information acquirer 25a creates a specifications information acquisition request, and outputs the request to the communicator 28. Then, the communicator 28 sends the specifications information acquisition request to the server 4 (Step S242).

Then, the communicator 43 of the server 4 receives the specifications information acquisition request sent by the control device 2 (Step S251). Then, the communicator 43 outputs the received specifications information acquisition request to the specifications information judger 44. Then, the specifications information judger 44 judges whether the specifications information whose version information matches with the version information included in the specifications information acquisition request is stored in the specifications information storage 45 (Step S252).

If the specifications information judger 44 judges that the specifications information whose version information matches with the version information included in the specifications information acquisition request is stored in the specifications information storage 45 (YES in Step S252), the specifications information judger 44 reads the specifications information corresponding to the version information from the specifications information storage 45 (Step S253). Then, the specifications information judger 44 outputs the readout specifications information to the communicator 43. Then, the communicator 43 sends the specifications information to the control device 2 (Step S254).

Then, the communicator 28 of the control device 2 receives the specifications information sent by the server 4 (Step S243). Then, the communicator 28 outputs the received specifications information to the setting check data creation processor 25. The information acquirer 25a of the setting check data creation processor 25 updates the specifications information by storing the newly acquired specifications information in the specifications information storage 21 (Step S244). Then, the routine proceeds to the process of Step S201 in FIG. 13, and the processes thereafter are executed.

If, on the other hand, the specifications information judger 44 judges that the specifications information whose version information matches with the version information included in the specifications information acquisition request is not stored in the specifications information storage 45 (NO in Step S252), the specifications information judger 44 creates reply information notifying that the server 4 does not store the specifications information corresponding to the version information, and outputs the reply information to the communicator 43. Then, the communicator 43 sends the reply information to the control device 2 (Step S255).

Then, the communicator 28 of the control device 2 receives the reply information sent by the server 4 (Step S245). Then, the communicator 28 outputs the received reply information to the setting check data creation processor 25. Then, the information acquirer 25a of the setting check data creation processor 25 suspends the process of creating integration information and device status information.

As mentioned above, the setting check data creation processor 25 judges whether the specifications information matching with the model information included in the identification information is stored in the specifications information storage 21. Then, if it is judged that the specifications information matching with the model information is not stored in the specifications information storage 21, the setting check data creation processor 25 is operative to acquire specifications information matching with the model information from the server 4 communicatively connected to the control device 2. Then, the setting check data creation processor 25 creates setting check data for checking a setting concerning the home electric appliance 1 with respect to each of the setting items, based on the acquired specifications information.

In the above arrangement, even if the specifications information stored in the control device 2, and the specifications information acquired from the home electric appliance 1 are different from each other, setting check data can be created by newly acquiring specifications information from the server 4. This enables to expediently cope with version up of the home electric appliance 1.

### Sixth Embodiment

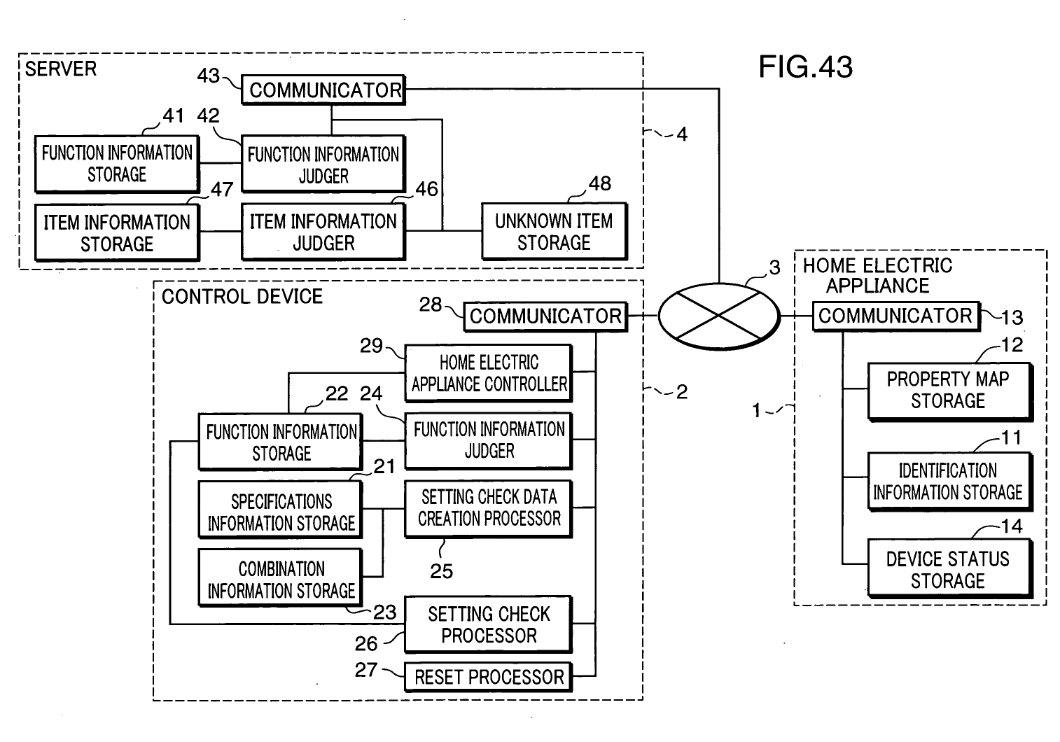

In this section, the sixth embodiment of the invention is described. FIG. 43 is a diagram showing a configuration of a home electric appliance control system according to the sixth embodiment of the invention. Constituent elements in FIG. 43 identical to those in FIGS. 1 and 23 are denoted at the same reference numerals, and description thereof will be omitted herein. A server 4 in FIG. 43 further includes an item information judger 46, an item information storage 47, and an unknown item storage 48, in addition to the constituent elements of the home electric appliance control system in FIGS. 1 and 23.

In the case where a property map acquired from a home electric appliance 1 includes an unknown setting item, a setting check data creation processor 25 creates an unknown item information acquisition request, and outputs the request to a communicator 28. The unknown item information acquisition request includes unknown setting items included in the property map acquired from the home electric appliance 1. The communicator 28 sends the unknown item information acquisition request to the server 4.

Then, a communicator 43 of the server 4 receives the unknown item information acquisition request sent by a control device 2. The item information storage 47 stores the setting items with respect to each of the kinds of the home electric appliances. The setting item information judger 46 judges whether a setting item matching with the setting item included in the unknown item information acquisition request sent by the control device 2 is stored in the item information storage 47. If it is judged that the setting item matching with the setting item included in the unknown item information acquisition request is stored in the item information storage 47, the item information judger 46 reads the setting item from the item information storage 47, and outputs the setting item to the communicator 28. Then, the communicator 28 sends the setting item to the control device 2.

If, on the other hand, it is judged that the setting item matching with the setting item included in the unknown item information acquisition request is not stored in the item information storage 47, the item information judger 46 stores the setting item in the unknown item storage 48. The unknown item storage 48 stores the unknown setting items which are not stored in the item information storage 47. The setting check data creation processor 25 and the communicator 28 corresponding to an example of a setting item acquiring means.

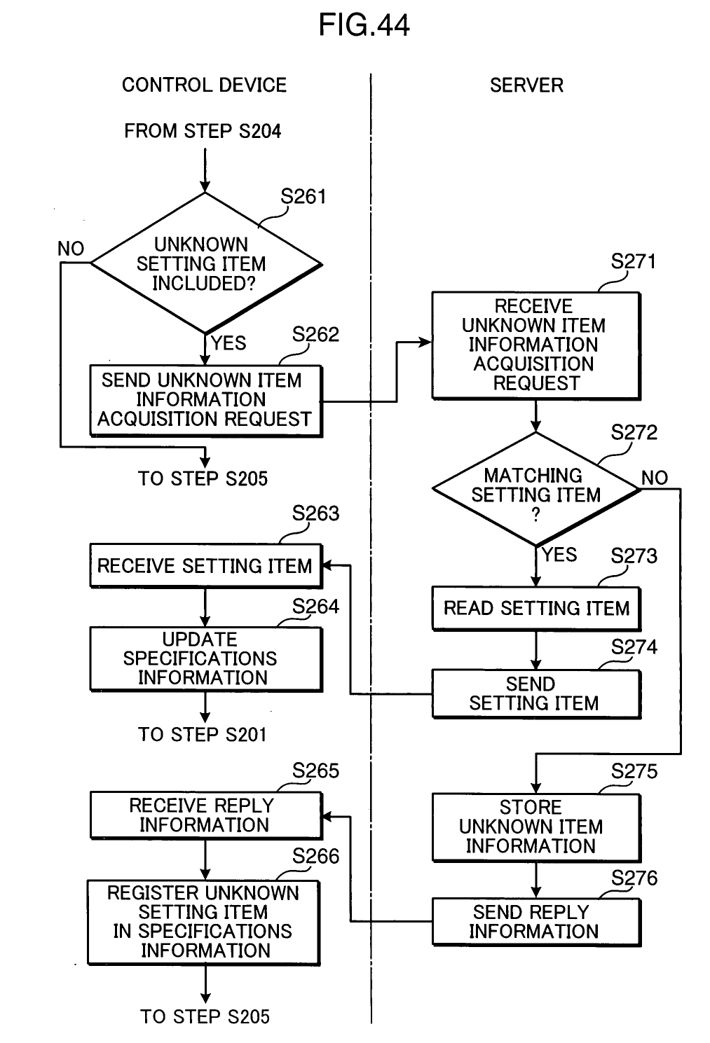

FIG. 44 is a flowchart for describing a process of creating integration information and model information to be executed in the sixth embodiment. The process shown in FIG. 44 is a process to be executed after Step S204 in FIG. 13.

First, an information acquirer 25a judges whether the property map sent by the home electric appliance 1 includes an unknown setting item (Step S261). If it is judged that the property map does not include an unknown setting item (NO in Step S261), the routine proceeds to the process of Step S205 in FIG. 13, and the processes thereafter are executed.

If, on the other hand, it is judged that the property map includes an unknown setting item (YES in Step S261), the information acquirer 25a creates an unknown item information acquisition request, and outputs the request to the communicator 28. Then, the communicator 28 sends the unknown item information acquisition request to the server 4 (Step S262).

Then, the communicator 43 of the server 4 receives the unknown item information acquisition request sent by the control device 2 (Step S271). Then, the communicator 43 outputs the received unknown item information acquisition request to the item information judger 46. Then, the item information judger 46 judges whether the setting item matching with the setting item included in the unknown item information acquisition request is stored in the item information storage 47 (Step S272).

If the item information judger 46 judges that the setting item matching with the setting item included in the unknown item information acquisition request is stored in the item information storage 47 (YES in Step S272), the item information judger 46 reads the setting item from the item information storage 47 (Step S273). Then, the item information judger 46 outputs the readout setting item to the communicator 43. Then, the communicator 43 sends the setting item to the control device 2 (Step S274).

Then, the communicator 28 of the control device 2 receives the setting item sent by the server 4 (Step S263). Then, the communicator 28 outputs the received setting item to the setting check data creation processor 25. Then, the information acquirer 25a of the setting check data creation processor 25 updates the specifications information by storing the newly acquired setting item in the specifications information storage 21 (Step S264). Then, the routine proceeds to the process of Step S201 in FIG. 13, and the processes thereafter are executed.

If, on the other hand, the item information judger 46 judges that the setting item matching with the setting item included in the unknown item information acquisition request is not stored in the item information storage 47 (NO in Step S272), the item information judger 46 stores, in the unknown item storage 48, the setting item included in the unknown item information acquisition request, as unknown item information (Step S275). The unknown item information is stored in the item information storage 47, as a new setting item to be used in maintenance service. Then, the item information judger 46 creates reply information notifying that the server 4 does not store a setting item matching with the unknown setting item, and outputs the reply information to the communicator 43. Then, the communicator 43 sends the reply information to the control device 2 (Step S276).

Then, the communicator 28 of the control device 2 receives the reply information sent by the server 4 (Step S265). Then, the communicator 28 outputs the received reply information to the setting check data creation processor 25. Then, the information acquirer 25a of the setting check data creation processor 25 registers the unknown setting item in the specifications information, as a setting item whose manipulation via the network is disabled (Step S266). Then, the routine proceeds to the process of Step S205 in FIG. 13, and the processes thereafter are executed.

As mentioned above, in the case where the property map acquired from the home electric appliance 1 includes a setting item which is not included in the specifications information, the setting check data creation processor 25 is operative to acquire the setting item from the server 4 communicatively connected to the control device 2. Then, the setting check data creation processor 25 is operative to add the acquired setting item to the specifications information, and to store the specifications information in the specifications information storage 21.

In the above arrangement, even in the case where the property map acquired from the home electric appliance 1 includes a setting item which is not included in the specifications information, setting check data can be created by acquiring a new setting item from the server 4. This enables to expediently cope with version up of the home electric appliance 1.

### Seventh Embodiment

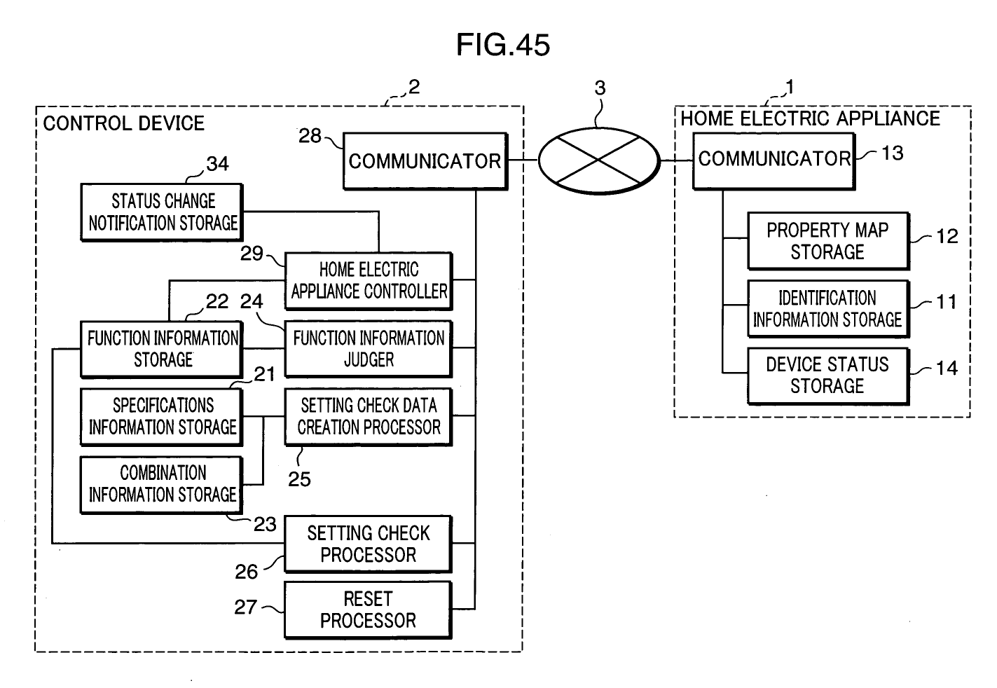

In this section, the seventh embodiment of the invention is described. FIG. 45 is a diagram showing a configuration of a home electric appliance control system according to the seventh embodiment of the invention. Constituent elements in FIG. 45 identical to those in FIG. 1 are denoted at the same reference numerals, and description thereof will be omitted herein. A control device 2 in FIG. 45 further includes a status change notification storage 34, in addition to the constituent elements of the home electric appliance control system in FIG. 1.

At first, a setting check processor 26 executes only a setting check concerning a specific setting item e.g. a setting item concerning power on/off. The status change notification storage 34 stores a status change notification sent by a home electric appliance 1. A home electric appliance controller 29 judges whether the status change notification sent by the home electric appliance 1 is stored in a function information storage 22. If it is judged that the status change notification is not stored in the function information storage 22, the home electric appliance controller 29 is operative to store the status change notification in the status change notification storage 34.

A communicator 28 corresponds to an example of a status change notification receiving means, and the status change notification storage 34 corresponds to an example of a status change notification storing means.

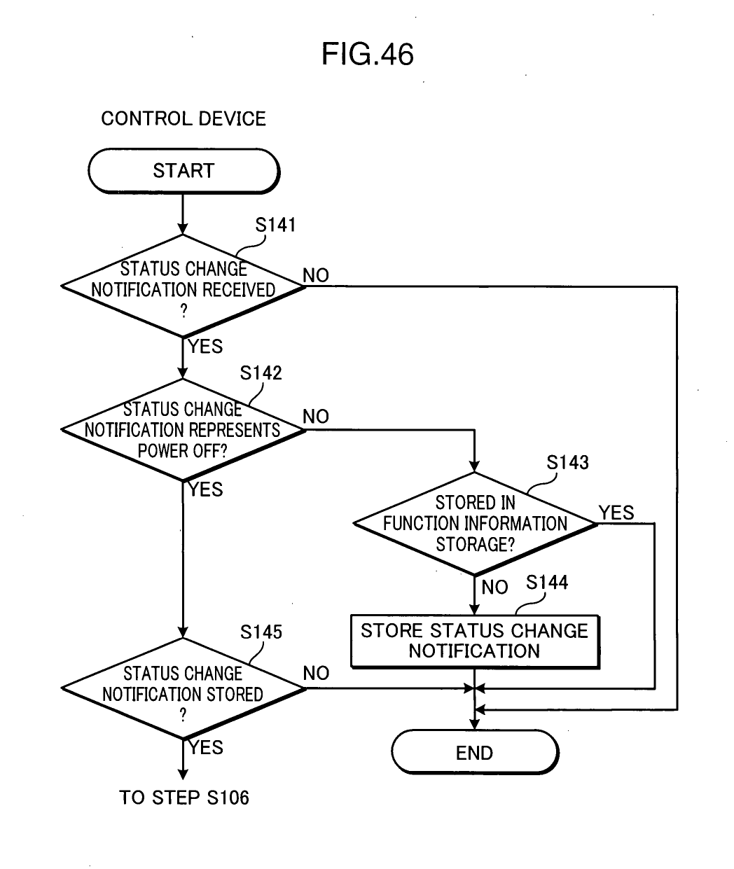

FIG. 46 is a flowchart showing an example of an operation to be executed by the control system according to the seventh embodiment of the invention.

First, the home electric appliance controller 29 judges whether the control device 2 has received a status change notification (Step S141). If it is judged that the control device 2 has received the status change notification sent by the home electric appliance 1, the communicator 28 outputs the status change notification to the home electric appliance controller 29. If it is judged that the control device 2 has received the status change notification (YES in Step S141), the home electric appliance controller 29 judges whether the status change notification represents power off (Step S142).

If it is judged that the status change notification does not represent power off (NO in Step S142), the home electric appliance controller 29 judges whether the contents of the status change notification is stored in the function information storage 22 (Step S143). If it is judged that the contents of the status change notification is not stored in the function information storage 22 (NO in Step S143), the home electric appliance controller 29 stores the status change notification in the status change notification storage 34 (Step S144).

If, on the other hand, it is judged that the status change notification represents power off (YES in Step S142), the home electric appliance controller 29 judges whether the status change notification is stored in the status change notification storage 34 (Step S145). If it is judged that the status change notification is stored in the status change notification storage 34 (YES in Step S145), the routine proceeds to the process of Step S106 in FIG. 8, and the processes thereafter are executed.

The routine is ended, if it is judged that the control device 2 has not received the status change notification (NO in Step S141), or if it is judged that the contents of the status change notification is stored in the function information storage 22 (YES in Step S143), or if it is judged that the status change notification is not stored in the status change notification storage 34 (NO in Step S145), or after the status change notification is stored in the status change notification storage 34 in Step S144. In this arrangement, since all the setting checks are not executed at a time, the time required for the setting check can be shortened.

In this embodiment, in the case where the status change notification representing power off is received, setting check data corresponding to the status change notification stored in the status change notification storage 34 is created. The invention is not specifically limited to the above, and setting check data may be created in advance. In the modification, in response to receiving the status change notification representing power off, setting check data corresponding to the status change notification stored in the status change notification storage 34 is read out therefrom, and the readout setting check data is executed.

As mentioned above, the communicator 28 receives the status change notification sent by the home electric appliance 1 when the status of the home electric appliance 1 is changed. Then, the status change notification storage 34 stores the status change notification received by the communicator 28. In the case where the predetermined status change notification is received by the communicator 28, the setting check data creation processor 25 is operative to create setting check data for checking a setting concerning the setting item corresponding to the status change notification stored in the status change notification storage 34.

In the above arrangement, the status change notification sent by the home electric appliance 1 is stored, and in response to receiving the predetermined status change notification, the setting check data for checking the setting concerning the setting item corresponding to the stored status change notification is created. This enables to eliminate the need of executing a setting check during an operation of the home electric appliance 1, and to execute the setting check after the operation of the home electric appliance 1 is completed. This is advantageous in enhancing the operability of the user.

The aforementioned embodiments mainly include the inventions having the following arrangements.

A control device according to an aspect of the invention is communicatively connected with at least one electric device for controlling the electric device. The control device comprises: a specifications information storing means for storing specifications information, in which function information including at least setting items for controlling the electric device is predefined, in association with model information representing a model of the electric device; an identification information acquiring means for acquiring, from the electric device, identification information including the model information of the electric device; a setting check data creating means for reading, from the specifications information storing means, the specifications information corresponding to the model information matching with the model information included in the identification information acquired by the identification information acquiring means, and for creating setting check data for checking a setting concerning the electric device with respect to each of the setting items, based on the readout specifications information; a setting executing means for executing the setting concerning the electric device, using the setting check data created by the setting check data creating means; a setting result checking means for acquiring, from the electric device, a result on the setting executed by the setting executing means, and for checking the setting result; a function information storing means for storing the function information of the electric device; a function information updating means for updating the function information stored in the function information storing means, based on the setting result checked by the setting result checking means; and an electric device controlling means for controlling the electric device, based on the function information updated by the function information updating means.

In the above arrangement, the specifications information storing means stores the specifications information, in which the function information including at least setting items for controlling the electric device is predefined, in association with the model information representing the model of the electric device. The identification information acquiring means acquires, from the electric device, the identification information including the model information of the electric device. Then, the setting check data creating means reads, from the specifications information storing means, the specifications information corresponding to the model information matching with the model information included in the identification information acquired by the identification information acquiring means, and creates the setting check data for checking the setting concerning the electric device with respect to the each of the setting items, based on the readout specifications information. Then, the setting executing means executes the setting concerning the electric device, using the setting check data created by the setting check data creating means. The setting result checking means acquires, from the electric device, the result on the setting executed by the setting executing means, and checks the setting result. The function information storing means stores the function information of the electric device. The function information updating means updates the function information stored in the function information storing means, based on the setting result checked by the setting result checking means. The electric device controlling means controls the electric device, based on the function information updated by the function information updating means.

As mentioned above, the setting check data with respect to the each of the setting items is created based on the specifications information, in which the function information is predefined, the setting concerning the electric device is executed, using the created setting check data, and the function information is updated based on the setting result. This enables to automatically acquire the function information of the electric devices whose manufacturers, models, and model numbers are different one from another.

Preferably, the control device may further comprise a combination information storing means for storing combination information describing a dependency between the setting items included in the specifications information in association with the model information, wherein the setting check data creating means is operative to read, from the specifications information storing means, the specifications information corresponding to the model information matching with the model information included in the identification information acquired by the identification information acquiring means, to read, from the combination information storing means, the combination information matching with the model information included in the identification information acquired by the identification information acquiring means, and to create the setting check data for checking the setting concerning the electric device with respect to the each of the setting items, based on the readout specifications information and the readout combination information.

In the above arrangement, the combination information storing means stores the combination information describing the dependency between the setting items included in the specifications information in association with the model information. The setting check data creating means is operative to read, from the specifications information storing means, the specifications information corresponding to the model information matching with the model information included in the identification information acquired by the identification information acquiring means, to read, from the combination information storing means, the combination information corresponding to the model information matching with the model information included in the identification information acquired by the identification information acquiring means, and to create the setting check data for checking the setting concerning the electric device with respect to the each of the setting items, based on the readout specifications information and the readout combination information.

Thus, the setting check data to be used in the setting check is created, considering the dependency between the setting items. This enables to avoid execution of the setting check concerning the setting item whose setting check has already been executed, enhance the efficiency concerning controllable combinations on setting items, and suppress unwanted communication.

Preferably, in the control device, the setting check data creating means may be operative to acquire, from the electric device, a property map describing whether a value is settable with respect to the setting item in response to a request from the control device, and describing whether the value of the setting item is gettable in response to the request from the control device, and to create the setting check data based on the property map, the specifications information, and the combination information.

In the above arrangement, the setting check data creating means is operative to acquire, from the electric device, the property map describing whether the value is settable with respect to the setting item in response to the request from the control device, and describing whether the value of the setting item is gettable in response to the request from the control device, and to create the setting check data based on the property map, the specifications information, and the combination information.

As mentioned above, the setting check data is created based on the judgment as to whether the value is settable with respect to the setting item in response to the request from the control device, and whether the value of the setting item is gettable in response to the request from the control device. Accordingly, in the case where the electric device is controllable by the control device, the setting check data is created, and in the case where the electric device is uncontrollable by the control device, the setting check data is not created. This enables to efficiently acquire the function information of the electric device, without executing an unwanted check on setting.

Preferably, in the control device, the setting check data creating means may be operative to create the setting check data, if the function information matching with the identification information for identifying the electric device is not stored in the function information storing means.

In the above arrangement, the setting check data creating means is operative to create the setting check data, if the function information matching with the identification information for identifying the electric device is not stored in the function information storing means. Accordingly, in the case where the function information is stored, there is no need of checking the setting concerning the electric device. This enables to prevent executing an unwanted check on setting, and to efficiently execute the setting check.

Preferably, the control device may further comprise: a device status information creating means for creating device status information describing a status of the electric device before the setting execution by the setting executing means; a reset data creating means for creating reset data for resetting the status of the electric device after the setting execution by the setting executing means to the status before the setting execution at a time before the setting execution or after the setting execution; and a resetting means for resetting the status of the electric device to the status before the setting execution, using the reset data created by the reset data creating means after the setting execution by the setting executing means.

In the above arrangement, the device status information creating means is operative to create the device status information describing the status of the electric device before the setting execution by the setting executing means. The reset data creating means is operative to create the reset data for resetting the status of the electric device after the setting execution by the setting executing means to the status before the setting execution at the time before the setting execution or after the setting execution. Then, the resetting means is operative to reset the status of the electric device to the status before the setting execution, using the reset data created by the reset data creating means after the setting execution by the setting executing means.

As mentioned above, since the status of the electric device is reset to the status before the setting execution after the setting execution, the contents of the setting concerning the electric device which has been changed by the setting can be recovered to the original status.

Preferably, in the control device, the setting check data creating means may be operative to attach a setting check number for uniquely identifying the setting check data to apply the dependency between the setting items described in the combination information to the setting check data.

In the above arrangement, the setting check data creating means is operative to attach the setting check number for uniquely identifying the setting check data to apply the dependency between the setting items described in the combination information to the setting check data. Thus, the setting item on which the setting check is executed can be administered by the setting check number, thereby enabling to check the setting efficiently.

Preferably, the control device may further comprise: a protocol information storing means for storing protocol information for communicating with the electric device; and a protocol converting means for converting the setting check data created by the setting check data creating means in accordance with the protocol information stored in the protocol information storing means.

In the above arrangement, the protocol information storing means is operative to store the protocol information for communicating with the electric device. The setting check data created by the setting check data creating means is converted in accordance with the protocol information stored in the protocol information storing means. Thus, even if the communication protocols of the electric devices are different from each other, the setting check data can be securely sent to the electric devices.

Preferably, the control device may further comprise a transmission judging means for judging whether the setting check data created by the setting check data creating means is to be sent to the electric device. In this arrangement, the transmission judging means is operative to judge whether the setting check data created by the setting check data creating means is to be sent to the electric device. This enables to determine whether the setting check data is to be sent to the electric device, based on the judgment result.

Preferably, in the control device, the setting check data creating means may be operative to erase the setting check data having the dependency with the setting check data, if the transmission judging means judges that the setting check data is not to be sent to the electric device.

In the above arrangement, the transmission judging means is operative to judge whether the setting check data created by the setting check data creating means is to be sent to the electric device. Then, the setting check data creating means is operative to erase the setting check data having the dependency with the setting check data, if the transmission judging means judges that the setting check data is not to be sent to the electric device. In this arrangement, in the case where transmission of the setting check data is disabled, and the setting check concerning the electric device is disabled, the setting check data having the dependency with the setting check data is erased. This enables to prevent executing an unwanted check on setting, and to efficiently execute the setting check.

Preferably, in the control device, the electric device may include a plurality of the electric devices. The control device may further include a judgment criteria storing means for storing in advance setting items whose manipulation via a network is disabled with respect to each of groups obtained by categorizing the electric devices according to the kinds thereof, as judgment criteria data. The transmission judging means may be operative to judge whether the setting check data created by the setting check data creating means is to be sent to the electric device, by referring to the judgment criteria data stored in the judgment criteria storing means.

In the above arrangement, the judgment criteria storing means is operative to store in advance the setting items whose manipulation via the network is disabled with respect to the each of groups obtained by categorizing the electric devices according to the kinds thereof, as the judgment criteria data. The transmission judging means is operative to judge whether the setting check data created by the setting check data creating means is to be sent to the electric device, by referring to the judgment criteria data stored in the judgment criteria storing means.

Accordingly, there can be stored the setting items whose manipulation via the network is disabled with respect to the each of the groups obtained by categorizing the electric devices according to the kinds thereof, as the judgment criteria data. Thus, by categorizing the electric device having setting items similar to each other into one group, there is no need of storing all the setting items whose manipulation via the network is disabled, thereby reducing the storage capacity.

Preferably, the control device may further comprise an installation site judging means for judging whether an installation site of the electric device to which the setting check data created by the setting check data creating means is to be sent, and an installation site of the control device are identical to each other, wherein the transmission judging means is operative to judge whether the setting check data is to be sent to the electric device, if the installation site judging means judges that the installation site of the electric device is different from the installation site of the control device.

In the above arrangement, the installation site judging means is operative to judge whether the installation site of the electric device to which the setting check data created by the setting check data creating means is to be sent, and the installation site of the control device are identical to each other. The transmission judging means is operative to judge whether the setting check data is to be sent to the electric device, if the installation site judging means judges that the installation site of the electric device is different from the installation site of the control device.

Accordingly, if the installation site of the electric device to which the setting check data is to be sent is different from the installation site of the control device, the judgment is made as to whether the setting check data is to be sent to the electric device. This enables to judge whether the setting check data is to be sent to the electric device depending on the installation site of the electric device.

Preferably, in the control device, the specifications information storing means may be operative to store the specifications information in association with version information representing a version of the electric device, and the identification information acquiring means may be operative to acquire, from the electric device, the identification information including the version information of the electric device. The control device may further include: a specifications information judging means for judging whether the specifications information corresponding to the version information matching with the version information included in the identification information is stored in the specifications information storing means; and a specifications information acquiring means for acquiring the specifications information matching with the version information from a server communicatively connected with the control device, if the specifications information judging means judges that the specifications information matching with the version information is not stored in the specifications information storing means. The setting check data creating means may be operative to create the setting check data for checking the setting concerning the electric device with respect to the each of the setting items, based on the specifications information acquired by the specifications information acquiring means.

In the above arrangement, the specifications information judging means is operative to judge whether the specifications information corresponding to the version information matching with the version information included in the identification information is stored in the specifications information storing means. The specifications information acquiring means is operative to acquire the specifications information matching with the version information from the server communicatively connected with the control device, if the specifications information judging means judges that the specifications information matching with the version information is not stored in the specifications information storing means. The setting check data creating means is operative to create the setting check data for checking the setting concerning the electric device with respect to the each of the setting items, based on the specifications information acquired by the specifications information acquiring means.

Accordingly, even in the case where the specifications information stored in the control device, and the specifications information acquired from the electric device are different from each other, the setting check data can be created by acquiring new specifications information from the server. This enables to expediently cope with version up of the electric device.

Preferably, the control device may further comprise a setting item acquiring means for acquiring the setting item from a server communicatively connected with the control device, if the property map acquired from the electric device includes the setting item which is not included in the specifications information, wherein the setting check data creating means is operative to add the setting item acquired by the setting item acquiring means to the specifications information to store the specifications information in the specifications information storing means.

In the above arrangement, the setting item acquiring means is operative to acquire the setting item from the server communicatively connected with the control device, if the property map acquired from the electric device includes the setting item which is not included in the specifications information. The setting check data creating means is operative to add the setting item acquired by the setting item acquiring means to the specifications information to store the specifications information in the specifications information storing means.

Accordingly, even in the case where the property map acquired from the electric device includes the setting item which is not included in the specifications information, the setting check data can be created by acquiring the new setting item from the server. This enables to expediently cope with version up of the electric device.

Preferably, the control device may further comprise: a status change notification receiving means for receiving a status change notification from the electric device when a status of the electric device is changed, and a status change notification storing means for storing the status change notification received by the status change notification receiving means, wherein the setting check data creating means is operative to create the setting check data for checking the setting concerning the setting item corresponding to the status change notification stored in the status change notification storing means, if the predetermined status change notification is received by the status change notification receiving means.

In the above arrangement, the status change notification receiving means is operative to receive the status change notification from the electric device when the status of the electric device is changed. The status change notification storing means is operative to store the status change notification received by the status change notification receiving means. The setting check data creating means is operative to create the setting check data for checking the setting concerning the setting item corresponding to the status change notification stored in the status change notification storing means, if the status change notification is received by the status change notification receiving means.

Accordingly, the status change notification sent by the electric device is stored, and in response to receiving the predetermined status change notification, the setting check data for checking the setting concerning the setting item corresponding to the stored status change notification is created. This enables to prevent the control device from checking a setting during an operation of the electric device, and allows the control device to check the setting after the operation of the electric device is completed. This is advantageous in enhancing the operability of the user.

A device control system according to another aspect of the invention is provided with at least one electric device, and a control device communicatively connected with the electric device for controlling the electric device. The electric device includes an identification information storing means for storing identification information for identifying the electric device. The control device includes: a specifications information storing means for storing specifications information, in which function information including at least setting items for controlling the electric device is predefined, in association with model information representing a model of the electric device; an identification information acquiring means for acquiring, from the electric device, the identification information including the model information of the electric device; a setting check data creating means for reading, from the specifications information storing means, the specifications information corresponding to the model information matching with the model information included in the identification information acquired by the identification information acquiring means, and for creating setting check data for checking a setting concerning the electric device with respect to each of the setting items, based on the readout specifications information; a setting executing means for executing the setting concerning the electric device, using the setting check data created by the setting check data creating means; a setting result checking means for acquiring, from the electric device, a result on the setting executed by the setting executing means, and for checking the setting result; a function information storing means for storing the function information of the electric device; a function information updating means for updating the function information stored in the function information storing means, based on the setting result checked by the setting result checking means; and an electric device controlling means for controlling the electric device, based on the function information updated by the function information updating means.

In the above arrangement, the identification information storing means of the electric device is operative to store the identification information for identifying the electric device. The specifications information storing means of the control device is operative to store the specifications information, in which the function information including at least setting items for controlling the electric device is predefined, in association with the model information representing the model of the electric device. The identification information acquiring means of the control device is operative to acquire, from the electric device, the identification information including the model information of the electric device. The setting check data creating means is operative to read, from the specifications information storing means, the specifications information corresponding to the model information matching with the model information included in the identification information acquired by the identification information acquiring means, and create the setting check data for checking the setting concerning the electric device with respect to the each of the setting items, based on the readout specifications information. The setting executing means is operative to execute the setting concerning the electric device, using the setting check data created by the setting check data creating means. The setting result checking means is operative to acquire, from the electric device, the result on the setting executed by the setting executing means, and check the setting result. The function information storing means is operative to store the function information of the electric device. The function information updating means is operative to update the function information stored in the function information storing means, based on the setting result checked by the setting result checking means. The electric device controlling means is operative to control the electric device, based on the function information updated by the function information updating means.

As mentioned above, the setting check data with respect to the each of the setting items is created based on the specifications information, in which the function information is predefined, the setting concerning the electric device is executed, using the created setting check data, and the function information is updated based on the setting result. This enables to automatically acquire the function information of the electric devices whose manufacturers, models, and model numbers are different one from another.

Preferably, in the device control system the control device may further comprise: a combination information storing means for storing combination information describing a dependency between the setting items included in the specifications information in association with the model information, wherein the setting check data creating means is operative to read, from the specifications information storing means, the specifications information corresponding to the model information matching with the model information included in the identification information acquired by the identification information acquiring means, to read, from the combination information storing means, the combination information corresponding to the model information matching with the model information included in the identification information acquired by the identification information acquiring means, and to create the setting check data for checking the setting concerning the electric device with respect to the each of the setting items, based on the readout specifications information and the readout combination information.

In the above arrangement, the combination information storing means is operative to store the combination information describing the dependency between the setting items included in the specifications information in association with the model information. The setting check data creating means is operative to read, from the specifications information storing means, the specifications information corresponding to the model information matching with the model information included in the identification information acquired by the identification information acquiring means, to read, from the combination information storing means, the combination information corresponding to the model information matching with the model information included in the identification information acquired by the identification information acquiring means, and to create the setting check data for checking the setting concerning the electric device with respect to the each of the setting items, based on the readout specifications information and the readout combination information.

Accordingly, the setting check data with respect to the each of the setting items is created, based on the specifications information, in which the function information is predefined, and the combination information describing the dependency between the setting items included in the specifications information, the setting concerning the electric device is executed, using the created setting check data, and the function information is updated based on the setting result. This enables to automatically acquire the function information of the electric devices whose manufacturers, models, and model numbers are different one from another.

Preferably, in the device control system, the electric device may further include a property map storing means for storing a property map describing whether a value is settable with respect to the setting item in response to a request from the control device, and describing whether the setting value of the setting item is gettable in response to the request from the control device, wherein the setting check data creating means is operative to acquire the property map from the electric device, and create the setting check data based on the property map, the specifications information, and the combination information.

In the above arrangement, the property map storing means of the electric device is operative to store the property map describing whether the value is settable with respect to the setting item in response to the request from the control device, and describing whether the setting value of the setting item is gettable in response to the request from the control device. The setting check data creating means is operative to acquire the property map from the electric device, and create the setting check data based on the property map, the specifications information, and the combination information.

Accordingly, the setting check data is created based on the judgment as to whether the value is settable with respect to the setting item in response to the request from the control device, and whether the value of the setting item is gettable in response to the request from the control device. Accordingly, in the case where the electric device is controllable by the control device, the setting check data is created, and in the case where the electric device is uncontrollable by the control device, the setting check data is not created. This enables to efficiently acquire the function information of the electric device, without executing an unwanted check on setting.

Preferably, in the device control system, the setting check data creating means may be operative to create the setting check data, if the function information matching with the identification information for identifying the electric device is not stored in the function information storing means.

In the above arrangement, the setting check data creating means is operative to create the setting check data, if the function information matching with the identification information for identifying the electric device is not stored in the function information storing means. Accordingly, in the case where the function information is stored, there is no need of checking the setting concerning the electric device. This enables to prevent executing an unwanted check on setting, and to efficiently execute the setting check.

Preferably, in the device control system, the control device may further include a device status information creating means for creating device status information describing a status of the electric device before the setting execution by the setting executing means; a reset data creating means for creating reset data for resetting the status of the electric device after the setting execution by the setting executing means to the status before the setting execution at a time before the setting execution or after the setting execution; and a resetting means for resetting the status of the electric device to the status before the setting execution, using the reset data created by the reset data creating means after the setting execution by the setting executing means.

In the above arrangement, the device status information creating means of the control device is operative to create the device status information describing the status of the electric device before the setting execution by the setting executing means. The reset data creating means is operative to create the reset data for resetting the status of the electric device after the setting execution by the setting executing means to the status before the setting execution at the time before the setting execution or after the setting execution. The resetting means is operative to reset the status of the electric device to the status before the setting execution, using the reset data created by the reset data creating means after the setting execution by the setting executing means.

Accordingly, since the status of the electric device is reset to the status before the setting execution after the setting execution, the contents of the setting concerning the electric device which has been changed by the setting can be recovered to the original status.

Preferably, in the device control system, the setting check data creating means may be operative to attach a setting check number for uniquely identifying the setting check data to apply the dependency between the setting items described in the combination information to the setting check data.

In the above arrangement, the setting check data creating means is operative to attach the setting check number for uniquely identifying the setting check data to apply the dependency between the setting items described in the combination information to the setting check data. Thus, the setting item for which the setting check is executed can be administered by the setting check number, thereby enabling to check the setting efficiently.

Preferably, in the device control system, the electric device may further include: an execution judging means for judging whether the setting check data created by the setting check data creating means is to be executed; and a transmitting means for sending, to the control device, reply information indicating that the setting check data is not executed, if the execution judging means judges that the setting check data is not executed, and the control device may further include a receiving means for receiving the reply information sent by the transmitting means.

In the above arrangement, the execution judging means of the electric device is operative to judge whether the setting check data created by the setting check data creating means is to be executed. The transmitting means is operative to send, to the control device, the reply information indicating that the setting check data is not executed, if the execution judging means judges that the setting check data is not executed. The receiving means of the control device is operative to receive the reply information sent by the transmitting means.

Accordingly, in the case where it is judged that the setting check data is not executed, the reply information indicating that the setting check data is not executed is sent to the control device. This allows the control device to recognize that the setting check data has not been executed in the electric device.

Preferably, in the device control system, the setting check data creating means may be operative to erase the setting check data having the dependency with the setting check data that has been sent to the electric device, if the reply information is received by the receiving means.

In the above arrangement, the setting check data creating means is operative to erase the setting check data having the dependency with the setting check data sent to the electric device, if the reply information is received by the receiving means.

Accordingly, in the case where execution of the setting check data is disabled, and the setting check concerning the electric device is disabled, the setting check data having the dependency with the setting check data is erased. This enables to prevent executing an unwanted check on setting, and to execute the setting check efficiently.

A setting check data creating method according to another aspect of the invention is adapted for use in a control device communicatively connected with at least one electric device stored with identification information for identifying the electric device. The control device is provided with: a specifications information storing means for storing specifications information, in which function information including at least setting items for controlling the electric device is predefined, in association with model information representing a model of the electric device; and a combination information storing means for storing combination information describing a dependency between the setting items included in the specifications information in association with the model information for controlling the electric device. The method comprises: an identification information acquiring step of acquiring, from the electric device, the identification information including the model information of the electric device; a specifications information reading step of reading, from the specifications information storing means, the specifications information corresponding to the model information matching with the model information included in the identification information acquired in the identification information acquiring step; a combination information reading step of reading, from the combination information storing means, the combination information corresponding to the model information matching with the model information included in the identification information acquired in the identification information acquiring step; an integration information creating step of creating integration information by integrating the specifications information read in the specifications information reading step, and the combination information read in the combination information reading step, using the combination information as core data; and a setting check data creating step of creating setting check data for checking a setting concerning the electric device with respect to each of the setting items, based on the integration information created in the integration information creating step.

In the above arrangement, the control device for controlling the electric device is communicatively connected with the at least one electric device stored with the identification information for identifying the electric device. The control device is provided with: the specifications information storing means for storing the specifications information, in which the function information including at least setting items for controlling the electric device is predefined, in association with the model information representing the model of the electric device; and the combination information storing means for storing the combination information describing the dependency between the setting items included in the specifications information in association with the model information for controlling the electric device. In the identification information acquiring step, the identification information including the model information of the electric device is acquired from the electric device. In the specifications information reading step, the specifications information corresponding to the model information matching with the model information included in the identification information acquired in the identification information acquiring step is read from the specifications information storing means. In the combination information reading step, the combination information corresponding to the model information matching with the model information included in the identification information acquired in the identification information acquiring step is read from the combination information storing means. Then, in the integration information creating step, the integration information is created by integrating the specifications information read in the specifications information reading step, and the combination information read in the combination information reading step, using the combination information as the core data. In the setting check data creating step, the setting check data for checking the setting concerning the electric device with respect to the each of the setting items is created, based on the integration information created in the integration information creating step.

As mentioned above, the setting check data with respect to the each of the setting items is created, based on the specifications information, in which the function information is predefined, and the combination information describing the dependency between the setting items included in the specifications information. This enables to execute the setting concerning the electric device, using the created setting check data, create the function information in accordance with the executed setting result, and

automatically acquire the function information of the electric devices whose manufacturers, models, and model numbers are different one from another.

Also, the setting check data to be used in the setting check is created, considering the dependency between the setting items. This enables to avoid execution of the setting check concerning the setting item whose setting check has already been executed, enhance the efficiency concerning controllable combinations on setting items, and suppress unwanted communication.

Preferably, in the setting check data creating method, the electric device may be operative to store a property map describing whether a value is settable with respect to the setting item in response to a request from the control device, and describing whether the value of the setting item is gettable in response to the request from the control device. The method may further include a property map acquiring step of acquiring the property map from the electric device. The integration information creating step may be a step of creating the integration information by integrating the specifications information read in the specifications information reading step, the combination information read in the combination information reading step, and the property map acquired in the property map acquiring step, using the combination information as the core data; and the setting check data creating step may be a step of creating the setting check data for checking the setting concerning the electric device with respect to the each of the setting items, based on the integration information created in the integration information creating step.

In the above arrangement, the electric device is operative to store the property map describing whether the value is settable with respect to the setting item in response to the request from the control device, and describing whether the value of the setting item is gettable in response to the request from the control device. In the property map acquiring step, the property map is acquired from the electric device. Then, in the integration information creating step, the integration information is created by integrating the specifications information read in the specifications information reading step, the combination information read in the combination information reading step, and the property map acquired in the property map acquiring step, using the combination information as the core data. Then, in the setting check data creating step, the setting check data for checking the setting concerning the electric device with respect to the each of the setting items is created, based on the integration information created in the integration information creating step.

As mentioned above, the setting check data is created based on the judgment as to whether the value is settable with respect to the setting item in response to the request from the control device, and whether the value of the setting item is gettable in response to the request from the control device. Accordingly, in the case where the electric device is controllable by the control device, the setting check data is created, and in the case where the electric device is uncontrollable by the control device, the setting check data is not created. This enables to efficiently acquire the function information of the electric device, without executing an unwanted check on setting.

Preferably, in the setting check data creating step of the setting check data creating method, a setting check number for uniquely identifying the setting check data may be attached to apply the dependency between the setting items described in the combination information to the setting check data.

In the above arrangement, in the setting check data creating step, the setting check number for uniquely identifying the setting check data is attached to apply the dependency between the setting items described in the combination information to the setting check data. Thus, the setting item for which the setting check is executed can be administered by the setting check number, thereby enabling to check the setting efficiently.

A device control program according to yet another aspect of the invention is adapted for use in a control device communicatively connected with at least one electric device for controlling the electric device. The device control program causes a computer to function as: a specifications information storing means for storing specifications information, in which function information including at least setting items for controlling the electric device is predefined, in association with model information representing a model of the electric device; an identification information acquiring means for acquiring, from the electric device, identification information including the model information of the electric device; a setting check data creating means for reading, from the specifications information storing means, the specifications information corresponding to the model information matching with the model information included in the identification information acquired by the identification information acquiring means, and for creating setting check data for checking a setting concerning the electric device with respect to each of the setting items, based on the readout specifications information; a setting executing means for executing the setting concerning the electric device, using the setting check data created by the setting check data creating means; a setting result checking means for acquiring, from the electric device, a result on the setting executed by the setting executing means, and for checking the setting result; a function information storing means for storing the function information of the electric device; a function information updating means for updating the function information stored in the function information storing means, based on the setting result checked by the setting result checking means; and an electric device controlling means for controlling the electric device, based on the function information updated by the function information updating means.

In the above arrangement, the specifications information storing means is operative to store the specifications information, in which the function information including at least setting items for controlling the electric device is predefined, in association with the model information representing the model of the electric device. The identification information acquiring means is operative to acquire, from the electric device, the identification information including the model information of the electric device. Then, the setting check data creating means is operative to read, from the specifications information storing means, the specifications information corresponding to the model information matching with the model information included in the identification information acquired by the identification information acquiring means, and create the setting check data for checking the setting concerning the electric device with respect to the each of the setting items, based on the readout specifications information. Then, the setting executing means is operative to execute the setting concerning the electric device, using the setting check data created by the setting check data creating means. The setting result checking means is operative to acquire, from the electric device, the result on the setting executed by the setting executing means, and check the setting result. The function information storing means is operative to store the function information of the electric device. The function information updating means is operative to update the function information stored in the function information storing means, based on the setting result checked by the setting result checking means. The electric device controlling means is operative to control the electric device, based on the function information updated by the function information updating means.

As mentioned above, the setting check data with respect to the each of the setting items is created based on the specifications information, in which the function information is predefined, the setting concerning the electric device is executed, using the created setting check data, and the function information is updated based on the setting result. This enables to automatically acquire the function information of the electric devices whose manufacturers, models, and model numbers are different one from another.

A computer-readable recording medium recorded with the device control program according to still another aspect of the invention is adapted for use in a control device communicatively connected with at least one electric device for controlling the electric device. The device control program causes a computer to function as: a specifications information storing means for storing specifications information, in which function information including at least setting items for controlling the electric device is predefined, in association with model information representing a model of the electric device; an identification information acquiring means for acquiring, from the electric device, identification information including the model information of the electric device; a setting check data creating means for reading, from the specifications information storing means, the specifications information corresponding to the model information matching with the model information included in the identification information acquired by the identification information acquiring means, and for creating setting check data for checking a setting concerning the electric device with respect to each of the setting items, based on the readout specifications information; a setting executing means for executing the setting concerning the electric device, using the setting check data created by the setting check data creating means; a setting result checking means for acquiring, from the electric device, a result on the setting executed by the setting executing means, and for checking the setting result; a function information storing means for storing the function information of the electric device; a function information updating means for updating the function information stored in the function information storing means, based on the setting result checked by the setting result checking means; and an electric device controlling means for controlling the electric device, based on the function information updated by the function information updating means.

In the above arrangement, the specifications information storing means is operative to store the specifications information, in which the function information including at least setting items for controlling the electric device is predefined, in association with the model information representing the model of the electric device. The identification information acquiring means is operative to acquire, from the electric device, the identification information including the model information of the electric device. Then, the setting check data creating means is operative to read, from the specifications information storing means, the specifications information corresponding to the model information matching with the model information included in the identification information acquired by the identification information acquiring means, and create the setting check data for checking the setting concerning the electric device with respect to the each of the setting items, based on the readout specifications information. Then, the setting executing means is operative to execute the setting concerning the electric device, using the setting check data created by the setting check data creating means. The setting result checking means is operative to acquire, from the electric device, the result on the setting executed by the setting executing means, and check the setting result. The function information storing means is operative to store the function information of the electric device. The function information updating means is operative to update the function information stored in the function information storing means, based on the setting result checked by the setting result checking means. The electric device controlling means is operative to control the electric device, based on the function information updated by the function information updating means.

As mentioned above, the setting check data with respect to the each of the setting items is created based on the specifications information, in which the function information is predefined, the setting concerning the electric device is executed, using the created setting check data, and the function information is updated based on the setting result. This enables to automatically acquire the function information of the electric devices whose manufacturers, models, and model numbers are different one from another.

### EXPLOITATION IN INDUSTRY

The control device, the device control system, the device control program, the computer-readable recording medium recorded with the device control program, and the setting check data creating method according to the invention are useful as a home network system in individual houses or housing complexes, and as a controller of the home network system. Also, they are applicable to business offices, business institutions, complex buildings, and the like. Further, they are applicable to failure diagnosis, inspection devices for inspecting home electric appliances operable on the network, and the like.

1-19. (canceled)

20. A control device communicatively connected with at least one electric device for controlling the electric device, the control device comprising:
a specifications information storing section for storing specifications information, in which function information including at least setting items for controlling the electric device is predefined, in association with model information representing a model of the electric device;
an identification information acquiring section for acquiring, from the electric device, identification information including the model information of the electric device;
a setting check data creating section for reading, from the specifications information storing section, the specifications information corresponding to the model information matching with the model information included in the identification information acquired by the identification information acquiring section, and for creating setting check data for checking a setting concerning the electric device with respect to each of the setting items, based on the readout specifications information;
a setting executing section for executing the setting concerning the electric device, using the setting check data created by the setting check data creating section;
a setting result checking section for acquiring, from the electric device, a result on the setting executed by the setting executing section, and for checking the setting result;
a function information storing section for storing the function information of the electric device;
a function information updating section for updating the function information stored in the function information storing section, based on the setting result checked by the setting result checking section; and
an electric device controlling section for controlling the electric device, based on the function information updated by the function information updating section.

21. The control device according to claim 20, further comprising:
a combination information storing section for storing combination information describing a dependency between the setting items included in the specifications information in association with the model information, wherein
the setting check data creating section is operative to read, from the specifications information storing section, the specifications information corresponding to the model information matching with the model information included in the identification information acquired by the identification information acquiring section, to read, from the combination information storing section, the combination information corresponding to the model information matching with the model information included in the identification information acquired by the identification information acquiring section, and to create the setting check data for checking the setting concerning the electric device with respect to the each of the setting items, based on the readout specifications information and the readout combination information.

22. The control device according to claim 21, wherein
the setting check data creating section is operative to acquire, from the electric device, a property map describing whether a value is settable with respect to the setting item in response to a request from the control device, and describing whether the value of the setting item is gettable in response to the request from the control device, and to create the setting check data based on the property map, the specifications information, and the combination information.

23. The control device according to claim 20, wherein
the setting check data creating section is operative to create the setting check data, if the function information matching with the identification information for identifying the electric device is not stored in the function information storing section.

24. The control device according to claim 20, further comprising:
a device status information creating section for creating device status information describing a status of the electric device before the setting execution by the setting executing section;
a reset data creating section for creating reset data for resetting the status of the electric device after the setting execution by the setting executing section to the status before the setting execution at a time before the setting execution or after the setting execution; and
a resetting section for resetting the status of the electric device to the status before the setting execution, using the reset data created by the reset data creating section after the setting execution by the setting executing section.

25. The control device according to claim 21, wherein
the setting check data creating section is operative to attach a setting check number for uniquely identifying the setting check data to apply the dependency between the setting items described in the combination information to the setting check data.

26. The control device according to claim 20, further comprising:
a protocol information storing section for storing protocol information for communicating with the electric device; and
a protocol converting section for converting the setting check data created by the setting check data creating section in accordance with the protocol information stored in the protocol information storing section.

27. The control device according to claim 20, further comprising:
a transmission judging section for judging whether the setting check data created by the setting check data creating section is to be sent to the electric device.

28. The control device according to claim 25, further comprising:
a transmission judging section for judging whether the setting check data created by the setting check data creating section is to be sent to the electric device, wherein
the setting check data creating section is operative to erase the setting check data having the dependency with the setting check data, if the transmission judging section judges that the setting check data is not to be sent to the electric device.

29. The control device according to claim 27, wherein
the electric device includes a plurality of the electric devices,
the control device further includes a judgment criteria storing section for storing in advance setting items whose manipulation via a network is disabled with respect to each of groups obtained by categorizing the electric devices according to the kinds thereof, as judgment criteria data, and
the transmission judging section is operative to judge whether the setting check data created by the setting check data creating section is to be sent to the electric device, by referring to the judgment criteria data stored in the judgment criteria storing section.

30. The control device according to claim 27, further comprising:
an installation site judging section for judging whether an installation site of the electric device to which the setting check data created by the setting check data creating section is to be sent, and an installation site of the control device are identical to each other, wherein
the transmission judging section is operative to judge whether the setting check data is to be sent to the electric device, if the installation site judging section judges that the installation site of the electric device is different from the installation site of the control device.

31. The control device according to claim 20, wherein
the specifications information storing section is operative to store the specifications information in association with version information representing a version of the electric device, and
the identification information acquiring section is operative to acquire, from the electric device, the identification information including the version information of the electric device,
the control device further includes:
a specifications information judging section for judging whether the specifications information corresponding to the version information matching with the version information included in the identification information is stored in the specifications information storing section; and
a specifications information acquiring section for acquiring the specifications information matching with the version information from a server communicatively connected with the control device, if the specifications information judging section judges that the specifications information matching with the version information is not stored in the specifications information storing section, and
the setting check data creating section is operative to create the setting check data for checking the setting concerning the electric device with respect to the each of the setting items, based on the specifications information acquired by the specifications information acquiring section.

32. The control device according to claim 22, further comprising:
a setting item acquiring section for acquiring the setting item from a server communicatively connected with the control device, if the property map acquired from the electric device includes the setting item which is not included in the specifications information, wherein
the setting check data creating section is operative to add the setting item acquired by the setting item acquiring section to the specifications information to store the specifications information in the specifications information storing section.

33. The control device according to claim 20, further comprising:
a status change notification receiving section for receiving a status change notification from the electric device when a status of the electric device is changed, and
a status change notification storing section for storing the status change notification received by the status change notification receiving section, wherein
the setting check data creating section is operative to create the setting check data for checking the setting with respect to the setting item corresponding to the status change notification stored in the status change notification storing section, if the predetermined status change notification is received by the status change notification receiving section.

34. A device control system provided with at least one electric device, and a control device communicatively connected with the electric device for controlling the electric device, wherein
the electric device includes
an identification information storing section for storing identification information for identifying the electric device, and
the control device includes:
a specifications information storing section for storing specifications information, in which function information including at least setting items for controlling the electric device is predefined, in association with model information representing a model of the electric device;
an identification information acquiring section for acquiring, from the electric device, the identification information including the model information of the electric device;
a setting check data creating section for reading, from the specifications information storing section, the specifications information corresponding to the model information matching with the model information included in the identification information acquired by the identification information acquiring section, and for creating setting check data for checking a setting concerning the electric device with respect to each of the setting items, based on the readout specifications information;
a setting executing section for executing the setting concerning the electric device, using the setting check data created by the setting check data creating section;
a setting result checking section for acquiring, from the electric device, a result on the setting executed by the setting executing section, and for checking the setting result;
a function information storing section for storing the function information of the electric device;
a function information updating section for updating the function information stored in the function information storing section, based on the setting result checked by the setting result checking section; and
an electric device controlling section for controlling the electric device, based on the function information updated by the function information updating section.

35. The device control system according to claim 34, wherein
the electric device further includes:
an execution judging section for judging whether the setting check data created by the setting check data creating section is to be executed; and
a transmitting section for sending, to the control device, reply information indicating that the setting check data is not executed, if the execution judging section judges that the setting check data is not executed, and
the control device further includes a receiving section for receiving the reply information sent by the transmitting section.

36. A setting check data creating method for use in a control device communicatively connected with at least one electric device stored with identification information for identifying the electric device, the control device being provided with: a specifications information storing section for storing specifications information, in which function information including at least setting items for controlling the electric device is predefined, in association with model information representing a model of the electric device; and a combination information storing section for storing combination information describing a dependency between the setting items included in the specifications information in association with the model information for controlling the electric device, the method comprising:
an identification information acquiring step of acquiring, from the electric device, the identification information including the model information of the electric device;
a specifications information reading step of reading, from the specifications information storing section, the specifications information corresponding to the model information matching with the model information included in the identification information acquired in the identification information acquiring step;
a combination information reading step of reading, from the combination information storing section, the combination information corresponding to the model information matching with the model information included in the identification information acquired in the identification information acquiring step;
an integration information creating step of creating integration information by integrating the specifications information read in the specifications information reading step, and the combination information read in the combination information reading step, using the combination information as core data; and
a setting check data creating step of creating setting check data for checking a setting concerning the electric device with respect to each of the setting items, based on the integration information created in the integration information creating step.

37. The setting check data creating method according to claim 36, wherein
the electric device is operative to store a property map describing whether a value is settable with respect to the setting item in response to a request from the control device, and describing whether the value of the setting item is gettable in response to the request from the control device,
the method further includes a property map acquiring step of acquiring the property map from the electric device,
the integration information creating step is a step of creating the integration information by integrating the specifications information read in the specifications information reading step, the combination information read in the combination information reading step, and the property map acquired in the property map acquiring step, using the combination information as the core data; and
the setting check data creating step is a step of creating the setting check data for checking the setting concerning the electric device with respect to the each of the setting items, based on the integration information created in the integration information creating step.

38. A computer-readable recording medium recorded with a device control program for use in a control device communicatively connected with at least one electric device for controlling the electric device, the device control program causing a computer to function as:
a specifications information storing section for storing specifications information, in which function information including at least setting items for controlling the electric device is predefined, in association with model information representing a model of the electric device;
an identification information acquiring section for acquiring, from the electric device, identification information including the model information of the electric device;
a setting check data creating section for reading, from the specifications information storing section, the specifications information corresponding to the model information matching with the model information included in the identification information acquired by the identification information acquiring section, and for creating setting check data for checking a setting concerning the electric device with respect to each of the setting items, based on the readout specifications information;
a setting executing section for executing the setting concerning the electric device, using the setting check data created by the setting check data creating section;
a setting result checking section for acquiring, from the electric device, a result on the setting executed by the setting executing section, and for checking the setting result;
a function information storing section for storing the function information of the electric device;
a function information updating section for updating the function information stored in the function information storing section, based on the setting result checked by the setting result checking section; and
an electric device controlling section for controlling the electric device, based on the function information updated by the function information updating section.
